(19) United States
(12) Patent Application Publication
(10) Pub. No.: US 2012/0251147 A1
(43) Pub. Date: Oct. 4, 2012

(54) IMAGE FORMING APPARATUS

(75) Inventors: Akihiro GOMI, Fujimi-machi (JP); Masashi OBA, Shiojiri (JP); Yuki OGUCHI, Okaya (JP); Hiroshi TANAKA, Matsumoto (JP); Kunihiro KAWADA, Shiojiri (JP); Mitsukazu KUROSE, Shiojiri (JP); Ken IKUMA, Suwa (JP)

(73) Assignee: SEIKO EPSON CORPORATION, Tokyo (JP)

(21) Appl. No.: 13/429,782

(22) Filed: Mar. 26, 2012

(30) Foreign Application Priority Data
Apr. 1, 2011 (JP) 2011-081558
Apr. 1, 2011 (JP) 2011-081559
Apr. 1, 2011 (JP) 2011-081560
Apr. 1, 2011 (JP) 2011-081679
Apr. 1, 2011 (JP) 2011-081680
Apr. 19, 2011 (JP) 2011-092747

(51) Int. Cl. G03G 15/08

(52) U.S. Cl. 399/58

(57) ABSTRACT

In order to provide a developer reservoir that allows the liquid level to be accurately detected and with which the device does not end up being bulkier, the developer reservoir of the present invention includes a holder for holding a liquid developer containing toner and a carrier, an electrostatic capacitance type of liquid level sensor that detects electrostatic capacitance and has a first sensor electrode provided to the holder and a second sensor electrode that is opposite the first sensor electrode with liquid developer in between, and a calculator for calculating the level of the liquid developer held in the holder on the basis of the electrostatic capacitance detected by the electrostatic capacitance type of liquid level sensor.

### CROSS-REFERENCES TO RELATED APPLICATIONS

This application claims priority to Japanese Patent Application Nos. 2011-81558, 2011-81559, 2011-81560, 2011-81679, 2011-81680, and No. 2011-92747. The entire disclosures of Japanese Patent Application No. 2011-81558 filed on Apr. 1, 2011, No. 2011-81559 filed on Apr. 1, 2011, No. 2011-81560 filed on Apr. 1, 2011, No. 2011-81679 filed on Apr. 1, 2011, No. 2011-81680 filed on Apr. 1, 2011 and No. 2011-92747 filed on Apr. 19, 2011 are expressly incorporated by reference herein.

### BACKGROUND OF THE INVENTION

1. Field of the Invention

The present invention relates to an image forming device with which a latent image formed on a photoreceptor is developed by a developer composed of toner and carrier, the developed image composed of toner and carrier is transferred to a recording medium, and the transferred toner image is fused and fixed to form an image.

2. Description of the Related Art

There have been various proposals for wet image forming devices with which a latent image is developed using a high-viscosity developer in which a toner composed of a solid component is dispersed in a liquid medium, thereby making the electrostatic latent image visible. The developer used in these wet image forming devices is obtained by suspending a solid (toner particles) in a high-viscosity organic solvent (carrier liquid) that is electrically insulating and is composed of a silicone oil, a mineral oil, an edible oil, or the like. These toner particles are extremely fine, having a particle size of around 1 μm. When such fine toner particles are used in a wet image forming device, image quality is higher than with a dry image forming device that makes use of powdered toner particles having a particle size of about 7 μm.

There have been various proposals of techniques for detecting the level of a developer in a holder that holds the developer in order to ascertain how much developer remains and so forth in the developing component of an image forming device in which a developer is used.

For instance, Patent Literature 1 (Japanese Laid-Open Patent Application 2009-75558) discloses a liquid measuring device including a floating member that moves along with the surface of a liquid; a first magnetic field generator that is disposed in the floating member and whose N pole faces a first direction; a second magnetic field generator that is disposed away from the first magnetic field generator in the floating member and whose S pole faces the first direction; and a plurality of proportional output Hall elements that detect the magnetic field generated by the first magnetic field generator and the magnetic field generated by the second magnetic field generator at positions facing in the first direction.

Also, for instance, Patent Literature 2 (Japanese Laid-Open Patent Application 2001-194208) discloses a water storage level detector including a substrate; an electrode component including a first electrode plate supported by the board so as to be separated at a specific gap and a second electrode plate that extends from the substrate about up to the height of the first electrode plate and that has an opening corresponding to the outer peripheral face of the first electrode plate, and which is provided at a specific detection position on one side of the vessel containing the solution to be detected; and a water storage level detection component for detecting the presence of the solution at the detection position from a change in electrostatic capacitance measured with the first electrode plate and the second electrode plate.

Also, Patent Literature 3 (Japanese Laid-Open Patent Application 2001-13795) discloses the use of an electrostatic capacitance type of proximity switch, for example, as a sensor for detecting the amount of a developer solution 8.

### SUMMARY

However, with a method in which the floating member discussed in Patent Literature 1 is used to detect the level of a developer, a floating member with a certain volume is required to provide the buoyancy of the floating member, and ends up accounting for a large portion of the holder that holds the developer, which is a problem in that this causes the device to be bulkier.

Another problem is that when a developer with a relatively high viscosity is used, the developer works its way between the floating member and the shaft that supports this member movably, which can impede the floating member from moving smoothly up and down with the liquid level, so the level cannot be accurately detected.

Also, as discussed in Patent Literature 2, an electrostatic capacitance type of water storage level detector and water storage level measurement device are provided on the outside of the vessel containing the liquid, and since this water storage level detector is disposed on the outside of the vessel, its sensitivity is so low that it can only determine whether or not a liquid is present. Accordingly, it cannot determine the proper amount in which the vessel is to be refilled with liquid, and if the liquid is added in the wrong amount, it will take a long time to attain the targeted concentration or liquid level, or the developer concentration will fluctuate greatly, and this leads to inferior image quality.

Also, when the liquid level is determined on the basis of the change in electrostatic capacitance measured with the first electrode plate and the second electrode plate as discussed in Patent Literature 2, a problem is that the floating capacitance of the lead wires that connect the two electrode plates that measure the electrostatic capacitance, and the data processing circuit that determines the liquid level and so forth on the basis of the measured electrostatic capacitance have the effect of making it difficult to determine the accurate liquid level with the data processing circuit.

Also, when a determination is made in relation to the level of a developer on the basis of a change in the electrostatic capacitance measured by the first electrode plate and the second electrode plate as discussed in Patent Literature 2, a problem is that it is also necessary to take into account the fact that the electrostatic capacitance varies with the concentration of the developer, but the effect that a change in electrostatic capacitance due to concentration has on the liquid level detection result is not considered, so accurate liquid level information cannot be acquired.

Also, the technique discussed in Patent Literature 2 involves detecting only the presence of a liquid, and to ascertain the exact liquid level it is necessary to provide sensors in a number corresponding to the desired precision, which makes the device more complicated and makes it more difficult to reduce the size and price of the device.

Also, the technology discussed in Patent Literature 3 is a level switch that senses the upper and lower limits of the liquid level, but this has poor resolution when fine concentration adjustment is required. That is, a problem is that the increase or decrease in the amount of liquid in a tank cannot be determined sufficiently for concentration control aimed at wasting as little developer as possible.

The invention is intended to solve the above problems, and the image forming device pertaining to the invention includes a latent image carrier on which a latent image is formed, an exposure component that exposes the latent image carrier to form the latent image on the latent image carrier, a developer reservoir which has a holder for holding a developer containing toner and a carrier and an electrostatic capacitance detector for detecting electrostatic capacitance and having a first electrode provided to the holder and a second electrode that is opposite the first electrode with the developer in between, a developing component for developing the latent image and having a developer carrier that supports the developer contained in the developer reservoir and a supply member that supplies developer to the developer carrier, and a calculator for calculating the level of the developer held in the holder on the basis of the electrostatic capacitance detected by the electrostatic capacitance detector.

The image forming device pertaining to the invention further includes a limiting member that comes into contact with the first electrode and the second electrode and limits the distance between the first electrode and the second electrode.

The image forming device pertaining to the invention further includes a processing circuit that performs data processing on the basis of the electrostatic capacitance detected by the electrostatic capacitance detector, and is provided above the limiting member in the vertical direction.

The image forming device pertaining to the invention further includes a temperature detector that detects the temperature of the developer held in the holder, wherein the processing circuit performs data processing on the basis of the temperature detected by the temperature detector.

The image forming device pertaining to the invention further includes a concentration detector that detects the toner concentration of the developer held in the holder, wherein the processing circuit performs data processing on the basis of the concentration detected by the concentration detector.

The image forming device pertaining to the invention further includes a concentration adjuster that is disposed below the first electrode of the electrostatic capacitance detector inside the holder in the vertical direction, has a concentration detector that detects the toner concentration of the developer, and adjusts the toner concentration of the developer.

The image forming device pertaining to the invention further includes a stirrer that stirs the developer held in the holder and is disposed below the first electrode of the electrostatic capacitance detector in the vertical direction and above the concentration detector in the vertical direction.

The image forming device pertaining to the invention further includes a developer supply pipe that has an intake opening disposed above the concentration adjuster inside the holder in the vertical direction and for drawing in developer, and sends developer from the holder to the developing vessel.

Also, the image forming device pertaining to the invention includes a latent image carrier on which a latent image is formed, an exposure component that exposes the latent image carrier to form the latent image, a developing component for developing the latent image formed on the latent image carrier and having a developer vessel that stores developer containing toner and a carrier liquid, and a developer carrier that supports the developer stored in the developer vessel, a developer supply pipe that sends developer to the developer vessel of the developing component, and a concentration adjuster that adjusts the toner concentration of the developer and has a holder for holding a developer, an electrostatic capacitance detector for detecting electrostatic capacitance and having a first electrode provided inside the holder and a second electrode provided inside the holder and opposite the first electrode with the developer in between, an intake opening of the developer supply pipe for drawing developer into the developer supply pipe, and a toner concentration detector that is disposed below the intake opening in the vertical direction and detects the toner concentration of the developer.

The image forming device pertaining to the invention further includes a stirrer that stirs the developer and is disposed inside the holder and below the intake opening in the vertical direction.

The image forming device pertaining to the invention further includes a calculator for calculating the level of the developer held in the holder on the basis of the electrostatic capacitance detected by the electrostatic capacitance detector and the toner concentration of the developer detected by the toner concentration detector.

The image forming device pertaining to the invention further includes a temperature detector that is disposed inside the holder and below the intake opening in the vertical direction, and detects the temperature of the developer held in the holder.

Also, the image forming device pertaining to the invention is such that the level of the developer calculated by the calculator is corrected on the basis of the temperature detected by the temperature detector.

Also, the image forming device pertaining to the invention includes a latent image carrier on which a latent image is formed, an exposure component that exposes the latent image carrier to form the latent image, a developer reservoir for storing developer and having a holding vessel for holding a developer containing toner and a carrier, an electrostatic capacitance detector for detecting electrostatic capacitance and having a first electrode provided inside the holder and a second electrode that is opposite the first electrode with the developer in between, and a concentration detector that is disposed inside the holder and detects the toner concentration of the developer, a developing component for developing the latent image formed on the latent image carrier and having a developer carrier that supports the developer supplied from the developer reservoir and a supply member that supplies developer to the developer carrier, and a level calculator for calculating the level of the developer held in the holder on the basis of the electrostatic capacitance detected by the electrostatic capacitance detector and the toner concentration detected by the concentration detector.

The image forming device pertaining to the invention further includes a temperature detector that detects the temperature of the developer held in the holder, wherein the level calculator calculates the level of the developer held in the holder on the basis of the temperature detected by the temperature detector.

Also, the image forming device pertaining to the invention is such that the level calculator corrects the toner concentration detected by the concentration detector on the basis of the temperature detected by the temperature detector.

The image forming device pertaining to the invention further includes a developer storage tank for storing developer of a first toner concentration, a carrier liquid storage tank for storing a carrier liquid, and a controller for supplying carrier liquid or developer of the first toner concentration stored in the developer storage tank so that the toner concentration of the developer held in the holder of the developer reservoir is controlled to a second toner concentration that is lower than the first toner concentration.

Also, the image forming device pertaining to the invention is such that a hollow part is provided to the first electrode, and the second electrode is provided in the hollow part of the first electrode.

The image forming device pertaining to the invention further includes a stirrer that rotates to stir the developer held in the holder, wherein the second electrode is a shaft that supports and rotates the stirrer.

Also, the image forming device pertaining to the invention is such that the first electrode has a liquid-passing hole that allows the developer to flow into the hollow part.

With the image forming device of the invention, since the level of the developer held in the holder is calculated on the basis of the electrostatic capacitance detected by the electrostatic capacitance detector, which has the first electrode provided to the holder and the second electrode that is opposite the first electrode, there is no need for a floating member or the like, and this keeps the device from becoming any larger.

Also, with the image forming device of the invention, since the level of the developer is calculated without using any moving parts, the liquid level can be detected accurately.

Also, with the image forming device of the invention, a sensor including of a first electrode and a second electrode is disposed with the electrodes opposite each other inside the holder and with the distance between the electrodes limited by a limiting member, and since electrostatic capacitance is detected by this sensor, there is an increase in sensing sensitivity, sensing resolution, and sensing accuracy, the amount of replenishing developer can be suitably decided, the replenishing developer is supplied in the appropriate amount, there is less fluctuation in toner concentration, fluctuation in image density is reduced, and a better image can be obtained.

Also, with the image forming device of the invention, since data processing is performed on the basis of the detected electrostatic capacitance by a processing circuit provided vertically above the limiting member that limits the distance between the first electrode and second electrode, there is almost no effect by floating capacitance of the lead wires, and the liquid level can be calculated accurately by the processing circuit.

Also, with the image forming device of the invention, since the concentration detector, which detects the concentration of the developer, is disposed vertically under the electrostatic capacitance detector inside the holder, and the detection result given by the electrostatic capacitance detector can be corrected on the basis of the change in electrostatic capacitance due to concentration, it is possible to acquire accurate liquid level information.

Also, with the image forming device of the invention, since the concentration detector, which detects the concentration of the developer, is disposed vertically under the opening to the developer supply pipe, and the detection result given by the electrostatic capacitance detector can be corrected on the basis of the change in electrostatic capacitance due to concentration, it is possible to acquire accurate liquid level information.

Also, with the image forming device of the invention, since the level calculator finds the level of developer held in the holder on the basis of the concentration detected by the concentration detector and the electrostatic capacitance detected by the electrostatic capacitance detector, it is possible to acquire accurate liquid level information.

Also, with the image forming device of the invention, since the liquid level can be ascertained by detecting the electrostatic capacitance between the first electrode and second electrode, there is no need to provide a plurality of sensors, so the device can be more compact and lower in price. Also, with the developing device and image forming device of the invention, since the liquid level can be accurately ascertained by detecting the electrostatic capacitance between the first electrode and second electrode, the concentration of the developer held in the holder can be properly controlled.

### BRIEF DESCRIPTION OF DRAWINGS

FIG. 1 shows the main constituent elements that make up the image forming device pertaining to an embodiment of the invention;

FIG. 2 is a cross section showing the main constituent elements of an image forming component and a developing device;

FIG. 3 is a cross section showing the simplified configuration of a concentration adjusting tank in the developing device;

FIG. 4 is a diagram illustrating the measurement principle behind an electrostatic capacitance type of liquid level sensor;

FIG. 5 is a graph of the relation between electrostatic capacitance and liquid level, found from the measurement principle behind an electrostatic capacitance type of liquid level sensor;

FIG. 6 is a graph of the temperature characteristics of electrostatic capacitance of a capacitor C formed by an electrostatic capacitance type of liquid level sensor;

FIG. 7 is a graph of the simplified relation between concentration and the dielectric constant ∈_{dev} of a developer;

FIG. 8 is a block diagram illustrating the calculation of the level of a developer in a concentration adjusting tank;

FIG. 9 is a cross section showing the simplified configuration of the concentration adjusting tank in a developing device;

FIG. 10 is a block diagram illustrating the calculation of the level of a developer in a concentration adjusting tank;

FIG. 11 is a block diagram of a data processing circuit;

FIG. 12 is a diagram illustrating how a data processing circuit 600Y is attached in the developing device pertaining to another embodiment of the invention;

FIG. 13 is a diagram illustrating how a data processing circuit 600Y is attached in the developing device pertaining to another embodiment of the invention;

FIG. 14 is a diagram illustrating how a data processing circuit 600Y is attached in the developing device pertaining to another embodiment of the invention;

FIG. 15 is a cross section showing the simplified configuration of the concentration adjusting tank in a developing device;

FIG. 16 is a diagram illustrating the measurement principle behind an electrostatic capacitance type of liquid level sensor;

FIG. 17 is a graph of the relation between electrostatic capacitance and liquid level, found from the measurement principle behind an electrostatic capacitance type of liquid level sensor;

FIG. 18 is a graph of the simplified relation between concentration and the dielectric constant ∈_{dev} of a developer;

FIG. 19 is a block diagram illustrating the calculation of the level of a developer in a concentration adjusting tank;

FIG. 20 is a block diagram illustrating the control of the liquid level in the image forming device pertaining to another embodiment of the invention;

FIG. 21 is a flowchart of an example of the control of the liquid level in the image forming device pertaining to another embodiment of the invention;

FIG. 22 is a cross section showing the simplified configuration of the concentration adjusting tank in the developing device pertaining to another embodiment of the invention;

FIG. 23 is a block diagram illustrating the control of the liquid level in the image forming device pertaining to another embodiment of the invention;

FIG. 24 is a flowchart of an example of the control of the liquid level in the image forming device pertaining to another embodiment of the invention;

FIG. 25 is a cross section showing the simplified configuration of the concentration adjusting tank in the developing device pertaining to another embodiment of the invention;

FIG. 26 is a graph of the temperature characteristics of electrostatic capacitance of a capacitor C formed by an electrostatic capacitance type of liquid level sensor;

FIG. 27 is a block diagram illustrating the calculation of the liquid level in the developing device pertaining to another embodiment of the invention;

FIG. 28 is a cross section showing the simplified configuration of the concentration adjusting tank in a developing device;

FIG. 29 is a diagram illustrating the measurement principle behind an electrostatic capacitance type of liquid level sensor;

FIG. 30 is a graph of the relation between electrostatic capacitance and liquid level, found from the measurement principle behind an electrostatic capacitance type of liquid level sensor;

FIG. 31 is a graph of the temperature characteristics of electrostatic capacitance of a capacitor C formed by an electrostatic capacitance type of liquid level sensor;

FIG. 32 is a graph of the simplified relation between concentration and the dielectric constant ∈_{dev} of a developer;

FIG. 33 is a block diagram illustrating the calculation of the level of a developer in a concentration adjusting tank;

FIG. 34 is a block diagram illustrating the control of the concentration and liquid level in the developing device pertaining to an embodiment of the invention;

FIG. 35 is a block diagram illustrating the control of the liquid level in the developing device pertaining to an embodiment of the invention;

FIG. 36 is a flowchart from the measurement of concentration and liquid level up to deciding on the replenishing amount in a first embodiment;

FIG. 37 is a flowchart of a subroutine in concentration and liquid level control;

FIG. 38 shows the switching of control according to the concentration and liquid level range;

FIG. 39 shows the switching of control based on states A to D;

FIG. 40 is a block diagram illustrating the control of the liquid level in the developing device pertaining to another embodiment of the invention;

FIG. 41 is a flowchart from the measurement of concentration and liquid level up to deciding on the replenishing amount in another embodiment;

FIG. 42 is a block diagram illustrating the control of the liquid level in the developing device pertaining to another embodiment of the invention;

FIG. 43 is a flowchart from the measurement of concentration and liquid level up to deciding on the replenishing amount in another embodiment;

FIG. 44 is a block diagram illustrating the control of the liquid level in the developing device pertaining to another embodiment of the invention;

FIG. 45 is a flowchart from the measurement of concentration and liquid level up to deciding on the replenishing amount in another embodiment;

FIG. 46 is a diagram of the simplified configuration of the concentration adjusting tank in a developing device;

FIG. 47 is an overall block diagram of the liquid level detection device used in the developing device pertaining to an embodiment of the invention;

FIG. 48 is a diagram illustrating the method for measuring the wiring capacity of a liquid level measurement harness;

FIG. 49 shows the configuration in which four-color (YMCK) liquid level detection devices share a liquid level measurement circuit;

FIG. 50 illustrates an electrostatic capacitance measurement method;

FIG. 51 illustrates the relation between liquid level and electrostatic capacitance;

FIG. 52 shows the simplified configuration of the concentration adjusting tank in the developing device pertaining to another embodiment;

FIG. 53 shows the simplified configuration of the concentration adjusting tank in the developing device pertaining to another embodiment;

FIG. 54 shows the simplified configuration of the concentration adjusting tank in the developing device pertaining to another embodiment; and

FIG. 55 shows the simplified configuration of the concentration adjusting tank in the developing device pertaining to another embodiment.

### DETAILED DESCRIPTION OF THE EXEMPLARY EMBODIMENTS

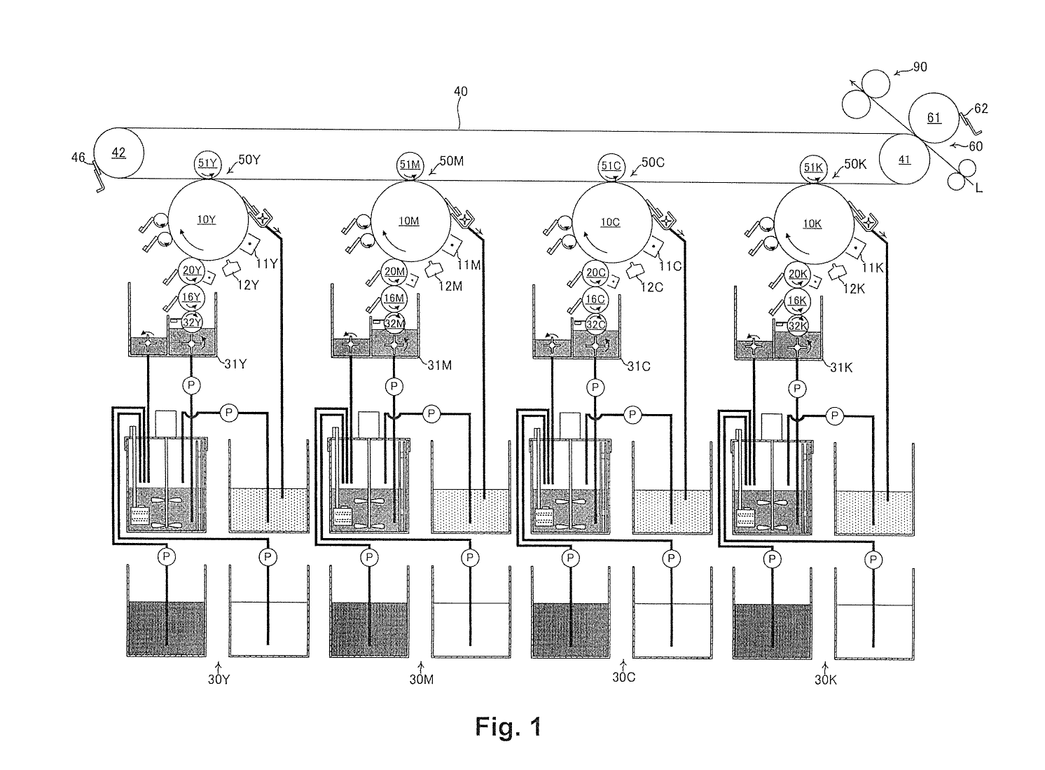

An embodiment of the invention will now be described through reference to the drawings. FIG. 1 shows the main constituent elements that make up the image forming device pertaining to an embodiment of the invention. Developing devices 30Y, 30M, 30C, and 30K are disposed at the lower part of the image forming device at the image forming components of the various colors disposed in the center part of the image forming device, and a transfer belt 40 and a secondary transfer component (secondary transfer unit) 60 are disposed at the upper part of the image forming device.

The image forming device includes photoreceptors 10Y, 10M, 10C, and 10K, corona charger 11Y, 11M, 11C, and 11K, exposure units 12Y, 12M, 12C, and 12K (not shown), and so forth. The corona chargers 11Y, 11M, 11C, and 11K uniformly charge the photoreceptors 10Y, 10M, 10C, and 10K, and the exposure heads installed in the exposure units 12Y, 12M, 12C, and 12K are driven on the basis of inputted image signals to form electrostatic latent images on the charged photoreceptors 10Y, 10M, 10C, and 10K.

The developing devices 30Y, 30M, 30C, and 30K basically include developing rollers 20Y, 20M, 20C, and 20K, developer containers (reservoirs) 31Y, 31M, 31C, and 31K that hold developers of colors including of yellow (Y), magenta (M), cyan (C), and black (K), anilox rollers 32Y, 32M, 32C, and 32K, which are coating rollers that coat the developing rollers 20Y, 20M, 20C, and 20K with developers of these colors from the developer containers 31Y, 31M, 31C, and 31K, and so forth, and develop the electrostatic latent images formed on the photoreceptors 10Y, 10M, 10C, and 10K by the developers of the various colors.

The transfer belt 40 is an endless belt, which is looped around a drive roller 41 and a tension roller 42 and rotatably driven by the drive roller 41 while in contact with the photoreceptors 10Y, 10M, 10C, and 10K at primary transfer components 50Y, 50M, 50C, and 50K. The primary transfer components 50Y, 50M, 50C, and 50K are such that the primary transfer rollers 51Y, 51M, 51C, and 51K are disposed opposite the photoreceptors 10Y, 10M, 10C, and 10K, with the transfer belt 40 in between them, and sequentially superpose and transfer the toner images of each color developed on the photoreceptors 10Y, 10M, 10C, and 10K to the transfer belt 40 by using the positions contact with the photoreceptors 10Y, 10M, 10C, and 10K as transfer positions, thereby forming a full-color toner image.

The secondary transfer unit 60 is such that a secondary transfer roller 61 is disposed opposite the belt drive roller 41, with the transfer belt 40 in between, and a cleaning device including a secondary transfer roller cleaning blade 62 is also provided. At the transfer position where the secondary transfer roller 61 is disposed, a monochrome or full-color toner image formed on the transfer belt 40 is transferred to a recording medium such as paper, film, or fabric that is conveyed along a sheeting conveyance path L.

A fixing unit 90 is disposed downstream of the sheeting conveyance path L, and a monochrome or full-color toner image transferred to paper or other recording medium is fused and fixed onto the paper or other recording medium.

The transfer belt 40 is looped around the tension roller 42 along with the belt drive roller 41. At the place where the transfer belt 40 is looped around the tension roller 42, a cleaning device including a transfer belt cleaning blade 46 is disposed in contact with the belt.

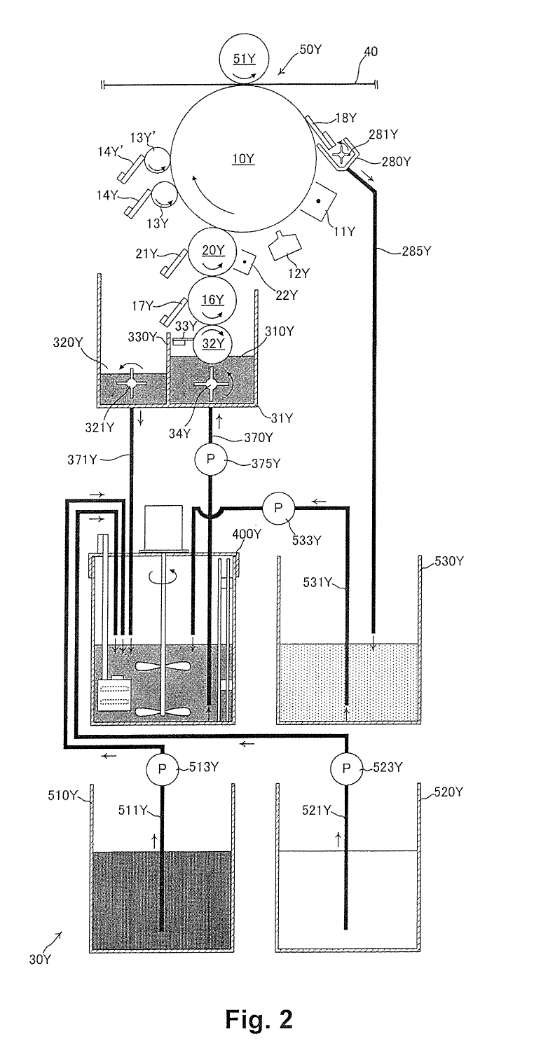

Next, the image forming component and developing device of the image forming device pertaining to an embodiment of the invention will be described. FIG. 2 is a cross section showing the main constituent elements of the image forming component and the developing device. Since the image forming components and developing devices of each color all have the same configuration, the following description will be of the yellow (Y) image forming component and developing device.

The image forming component is such that a photoreceptor cleaning blade 18Y, a corona charger 11Y, an exposure unit 12Y, a developing roller 20Y of a developing device 30Y, a photoreceptor squeeze roller 13Y, and a photoreceptor squeeze roller 13Y′ are disposed along the rotation direction of the outer periphery of the photoreceptor 10Y. Cleaning devices including photoreceptor squeeze roller cleaning blades 14Y and 14Y′ are disposed as accessories to the photoreceptor squeeze rollers 13Y and 13Y′.

A cleaning blade 21Y, an elastic roller 16Y, and a toner compacting corona generator 22Y are disposed around the outer periphery of the developing roller 20Y in the developing device 30Y. An anilox roller 32Y is in contact with the elastic roller 16Y, and a limiting blade 33Y that adjusts the amount of developer supplied to the developing roller 20Y is in contact with the anilox roller 32Y.

An elastic roller cleaning blade 17Y that wipes off any developer remaining on the elastic roller 16Y and not supplied to the developing roller 20Y is in contact with the elastic roller 16Y.

A developer vessel 31Y is divided by a divider 330Y into two spaces, namely, a supply reservoir 310Y and a recovery reservoir 320Y, an auger 34Y for supplying the developer is housed in the supply reservoir 310Y, and a recovery auger 321Y for recovering the developer is housed in the recovery reservoir 320Y.

A primary transfer roller 51Y of the primary transfer component is disposed at a position opposite the photoreceptor 10Y along the transfer belt 40.

The photoreceptor 10Y is a photoreceptor drum that is wider than the developing roller 20Y and includes a cylindrical member with a photosensitive layer formed around its outer peripheral face, and rotates in the clockwise direction as shown in FIG. 2, for example. The photosensitive layer of the photoreceptor 10Y is made up of an organic photoreceptor, an amorphous silicon photoreceptor, or the like. The corona charger 11Y is disposed upstream of the photoreceptor 10Y and the developing roller 20Y in the rotation direction of the photoreceptor 10Y, and subjects the photoreceptor 10Y to corona charging when voltage is applied from a power supply (not shown). The exposure unit 12Y is disposed downstream of the corona charger 11Y in the rotation direction of the photoreceptor 10Y, and directs light onto the photoreceptor 10Y charged by the corona charger 11Y to form a latent image on the photoreceptor 10Y.

From the start of the image forming process to the end, rollers and other such components disposed more to the front are defined as being upstream of rollers and other such components disposed more to the rear.

The supply reservoir 310Y of the developing device 30Y stores developer in a state in which toner is dispersed in a weight ratio of about 25% in a carrier. The recovery reservoir 320Y of the developing device 30Y, meanwhile, also includes the recovery auger 321Y for recovering developer not supplied to the anilox roller 32Y, developer wiped off with the photoreceptor squeeze roller cleaning blades 14Y and 14Y′, developer wiped off of the developing roller 20Y by the cleaning blade 21Y, developer wiped off of the elastic roller 16Y by the elastic roller cleaning blade 17Y, and so forth.

The developing device 30Y is also provided with the toner compacting corona generator 22Y, which has a compacting action. This toner compacting corona generator 22Y applies bias voltage to the developer on the developing roller 20Y, and puts the toner in the developer in a compacted state, in order to improve developing efficiency.

The developing device 30Y has the developing roller 20Y for carrying the developer, the elastic roller 16Y for supplying developer to the developing roller 20Y, the anilox roller 32Y for coating the elastic roller 16Y with developer, the limiting blade 33Y for limiting the amount of developer applied to the developing roller 20Y, the auger 34Y for stirring and supplying the developer to the anilox roller 32Y, the toner compacting corona generator 22Y for putting the developer carried on the developing roller 20Y in a compacted state, and the developing roller cleaning blade 21Y for cleaning the developing roller 20Y. The term “compacted state” here refers to putting the toner component in the developer into a compacted state on the surface side of the developing roller 20Y.

The developer held in the developer vessel 31Y is a nonvolatile developer that has a high viscosity and a high concentration and is nonvolatile at normal temperature, rather than being a volatile developer that has a low viscosity and a low concentration (about 1 to 3 wt %) when Isopar (trade name of Exxon), which is a commonly used product, serves as the carrier, and is volatile at normal temperature.

Specifically, the developer in the invention is produced by adding solid particles with an average size of 1 μm, and which are the product of dispersing a pigment or other such colorant in a thermoplastic resin, along with a dispersant to an organic solvent, a silicone oil, a mineral oil, an edible oil, or another such liquid medium, and has a high viscosity at a toner solids concentration of approximately 25% (a viscoelasticity of about 30 to 300 mPa·s when the shear velocity at 25° C. is 1000 (l/s) measured using a Haake Rheostress RS600).

To put this more precisely, the developer in the invention has a viscoelasticity of about 30 to 300 mPa·s when the shear velocity at 25° C. is 1000 (l/s) measured using a Haake Rheostress RS600, for the product of dispersing at least a binder resin in a liquid silicone oil having a viscosity of 0.5 to 1000 mPa·s (25° C.).

A liquid silicone oil is a low-volatility carrier liquid, and is selected from the group consisting of liquid silicones with a straight-chain structure, liquid silicones with a cyclic structure, liquid silicones with a branched-chain structure, and combinations of these.

Examples of liquid silicone oils include DC 200 Fluid (20 cSt), DC 200 Fluid (100 cSt), DC 200 Fluid (50 cSt), and DC 345 Fluid, made by Dow Corning USA.

Examples of pigments include nigrosine, phthalocyanine blue, quinacridone, and other such organic colorants, and carbon black, iron oxide, and other such inorganic colorants. Examples of binder resins include epoxy resins, polyacrylates, polyesters, copolymers of these, alkyd resins, rosins, rosin esters, modified epoxy resins, polyvinyl acetate resins, styrene-butadiene resins, cyclized rubbers, ethylene-vinyl acetate copolymers, and polyethylenes.

The pigments and binder resins may be dispersed directly in a liquid silicone oil, but it is photoreceptor to melt-knead a pigment and binder resin to produce a pigment that is covered with a binder resin.

Examples of resin-covered pigments include Araldite 6084 covered with an epoxy resin (C.I. Pigment Blue 15:3 made by Ciba Geigy), Tintacarb 435 (C.I. Pigment Black 7 made by Cabot Corporation), Irgalite Rubine KB4N (C.I. Pigment Red 57 made by Ciba Geigy), and Monolite Yellow (C.I. Pigment Yellow 1 made by ICI Australia). These covered pigments may be mixed in the desired proportions, then melt-kneaded and pulverized to create a master batch, and used in the manufacture of a developer (discussed below). In the melt-kneading of a pigment covered with an epoxy resin, an alkylated polyvinylpyrrolidone may be added and reacted with the epoxy resin to create a master batch in which the covered resin is a modified epoxy resin.

The dispersant is a polysiloxane having a functional group selected from among a vinyl group, a carboxyl group, a hydroxyl group, and an amine group, and is selected from among straight-chain polysiloxanes, cyclic polysiloxanes, branched-chain polysiloxanes, and combinations of these. Examples include Elastosil M4640A (a polysiloxane polymer having a vinyl functional group, made by Wacker Chemicals), and Finish WR1101 (a polysiloxane polymer having an amine functional group, made by Wacker Chemicals), with the viscosity being no more than 90,000 mPa·s. A polysiloxane having a functional group bonds or is adsorbed to the surface of the colorant resin particles via the functional groups, and thereby imparts to the colorant particles miscibility with a liquid silicone resin.

The developer of the invention can contain as needed a metallic soap, a fatty acid, lecithin, or another such charge control agent, an example of which is Nuxtra 6% Zirconium (zirconium octoate made by Creanova).

The developer of the invention is prepared by mixing and finely pulverizing the master batch obtained as above, a dispersant, and a liquid silicone oil, and has a viscosity of 30 to 300 mPa·s (25° C.). The toner solids concentration is no more than 40 wt %, and preferably 10 to 25 wt %. In this embodiment, the developer has a toner solids concentration of 25 wt %, and is housed in the developer vessel 31Y.

The developer of the invention may be the one discussed in WO/2003-508826. See this publication for details, but in the invention, the glass transition point (Tg) of the binder resin in this developer is preferably 40 to 70° C.

The anilox roller 32Y functions as a coating roller that supplies developer to coat the elastic roller 16Y. This anilox roller 32Y is a cylindrical member, and is a roller with a textured surface including grooves engraved in a uniform and fine spiral pattern on the surface, which makes it easier to carry the developer. developer is supplied by this anilox roller 32Y from the developer vessel 31Y to the developing roller 20Y. As shown in FIG. 2, during operation of the device, the auger 34Y rotates counter-clockwise to supply developer to the anilox roller 32Y, and the anilox roller 32Y rotates clockwise to coat the elastic roller 16Y, which rotates counter-clockwise, with developer. The developer applied by the anilox roller 32Y to the elastic roller 16Y is supplied to the developing roller 20Y, which rotates counter-clockwise.

The limiting blade 33Y is a metal blade with a thickness of about 200 μm, comes into contact with the surface of the anilox roller 32Y, limits the film thickness and amount of developer carried and conveyed by the anilox roller 32Y, and adjusts the amount of developer supplied to the elastic roller 16Y.

The developing roller 20Y is a cylindrical member, and rotates counter-clockwise around the rotational axis as shown in FIG. 2. An elastic layer of polyurethane rubber, silicone rubber, NBR, or the like is provided to the outer peripheral part of the iron or other such metal core of the developing roller 20Y, and a covering of PFA or a urethane coating is provided to this elastic layer. The developing roller cleaning blade 21Y is made of rubber or the like in contact with the surface of the developing roller 20Y, is disposed downstream (in the rotational direction of the developing roller 20Y) of a developing nip where the developing roller 20Y comes into contact with the photoreceptor 10Y, and wipes off any developer remaining on the developing roller 20Y. The developer that is wiped off here falls into the recovery reservoir 320Y of the developing device 30Y.

With the elastic roller 16Y, an elastic layer of polyurethane rubber, silicone rubber, NBR, or the like is provided to the outer peripheral part of the iron or other such metal core, and a covering of PFA or a urethane coating is provided to this elastic layer. The elastic roller cleaning blade 17Y wipes off any developer remaining on the elastic roller 16Y. The developer that is wiped off here falls into the recovery reservoir 320Y of the developing device 30Y.

The toner compacting corona generator 22Y is an electric field generating unit for increasing the charging bias on the surface of the developing roller 20Y. An electric field is applied to the developer conveyed by the developing roller 20Y, by the toner compacting corona generator 22Y, from the toner compacting corona generator 22Y side toward the developing roller 20Y, at the toner compacting location, as shown in FIG. 2.

The developer that is carried by the developing roller 20Y and has undergone toner compaction is moved by the desired field application corresponding to the latent image on the photoreceptor 10Y at the developing nip where the developing roller 20Y comes into contact with the photoreceptor 10Y, and this is developed. Any developer remaining after developing is wiped off by the developing roller cleaning blade 21Y, falls into the recovery reservoir 320Y of the developer vessel 31Y, and is reused.

A photoreceptor squeeze device disposed upstream of primary transfer is disposed downstream of the developing roller 20Y and opposite the photoreceptor 10Y, and recovers the excess developer from the toner image developed on the photoreceptor 10Y. As shown in FIG. 2, this device is made up of photoreceptor squeeze rollers 13Y and 13Y′, whose surfaces are covered with an elastomer, and each of which includes a elastic roller member that rotates and rubs against the photoreceptor 10Y, and cleaning blades 14Y and 14Y′ that are pressed against and clean the surfaces of the photoreceptor squeeze rollers 13Y and 13Y′ through rubbing. The function of this device is to recover excess carrier and unnecessary fog toner from the developer developed on the photoreceptor 10Y, and thereby increase the ratio of toner particles in the visualized image. In this embodiment a plurality of photoreceptor squeeze rollers 13Y and 13Y′ are provided as photoreceptor squeeze devices before primary transfer, but this may instead be constituted by a single photoreceptor squeeze roller. Also, the configuration may be such that one of the plurality of photoreceptor squeeze rollers 13Y and 13Y′ moves in and out of contact according to the condition of the developer and so forth.

At the primary transfer component 50Y, the developer image developed on the photoreceptor 10Y is transferred by the primary transfer roller 51Y to the transfer belt 40. The photoreceptor 10Y and the transfer belt 40 here move at the same speed, which lightens the rotational and movement drive load and also reduces turbulence in the visualized image on the photoreceptor 10Y.

Downstream of the primary transfer, the photoreceptor cleaning blade 18Y in contact with the photoreceptor 10Y cleans off any remaining developer that has not been transferred on the photoreceptor 10Y. The developer that is wiped away by the photoreceptor cleaning blade 18Y falls into a developer holding base 280. A rotating recovery auger 281 is provided to the developer holding base 280, and the developer held in the developer holding base 280 is guided by the rotation of the recovery auger 281 to a recycled developer recovery pipe 285, and goes through the recycled developer recovery pipe 285 to reach a buffer tank 530Y.

The developing device 30Y is provided with a concentration adjustment tank 400Y that supplies developer, in which carrier toner has been dispersed in a weight ratio of approximately 25%, to the supply reservoir 310Y of the developer vessel 31Y. A developer supply pipe 370Y is provided between the concentration adjustment tank 400Y and the supply reservoir 310Y, and developer, whose concentration in the concentration adjustment tank 400Y has been adjusted by drive of a developer supply pump 375Y located along this developer supply pipe 370Y, is supplied to the supply reservoir 310Y.

A developer recovery pipe 371Y is provided between the concentration adjustment tank 400Y and the recovery reservoir 320Y, and when the recovery auger 321Y rotates in the recovery reservoir 320Y that holds the developer wiped off by the cleaning blades, the developer is guided by the developer recovery pipe 371Y and falls into the concentration adjustment tank 400Y.

A high-concentration developer tank 510 stores a high-concentration developer with a toner solids concentration of at least approximately 35%, and a carrier liquid tank 520Y stores carrier raw liquid.

A high-concentration developer supply pipe 511Y is provided between the high-concentration developer tank 510 and the concentration adjustment tank 400Y, and high-concentration developer can be supplied from the high-concentration developer tank 510 to the concentration adjustment tank 400Y by driving a high-concentration developer supply pump 513Y in the high-concentration developer supply pipe 511Y. If the toner solids concentration of the developer in the concentration adjustment tank 400Y falls below 25%, high-concentration developer is supplied to the concentration adjustment tank 400Y by driving the high-concentration developer supply pump 513Y, so as to raise the concentration.

A carrier liquid supply pipe 521Y is provided between the carrier liquid tank 520Y and the concentration adjustment tank 400Y, and raw carrier liquid can be supplied from the carrier liquid tank 520Y to the concentration adjustment tank 400Y by driving a carrier liquid supply pump 523Y in the carrier liquid supply pipe 521Y. If the toner solids concentration of the developer in the concentration adjustment tank 400Y rises over 25%, raw carrier liquid is supplied to the concentration adjustment tank 400Y by driving the carrier liquid supply pump 523Y, so as to lower the concentration.

Also, a recycled developer supply pipe 531Y is provided between the concentration adjustment tank 400Y and the buffer tank 530Y holding the developer recovered from the developer holding base 280, and recycled developer can be supplied from the buffer tank 530Y to the concentration adjustment tank 400Y by driving a recycled developer supply pump 533Y in the recycled developer supply pipe 531Y.

The developer held in the buffer tank 530Y is developer that has been wiped off of the photoreceptor 10Y after secondary transfer has been performed, so it is carrier-rich, having an extremely low toner solids concentration (a toner solids concentration of approximately 3%). Therefore, if the toner solids concentration of the developer in the concentration adjustment tank 400Y rises over 25%, it will sometimes be possible to converse the raw carrier liquid in the carrier liquid tank 520Y if developer is supplied from the buffer tank 530Y to the concentration adjustment tank 400Y, instead of carrier liquid being supplied from the carrier liquid tank 520Y to the concentration adjustment tank 400Y.

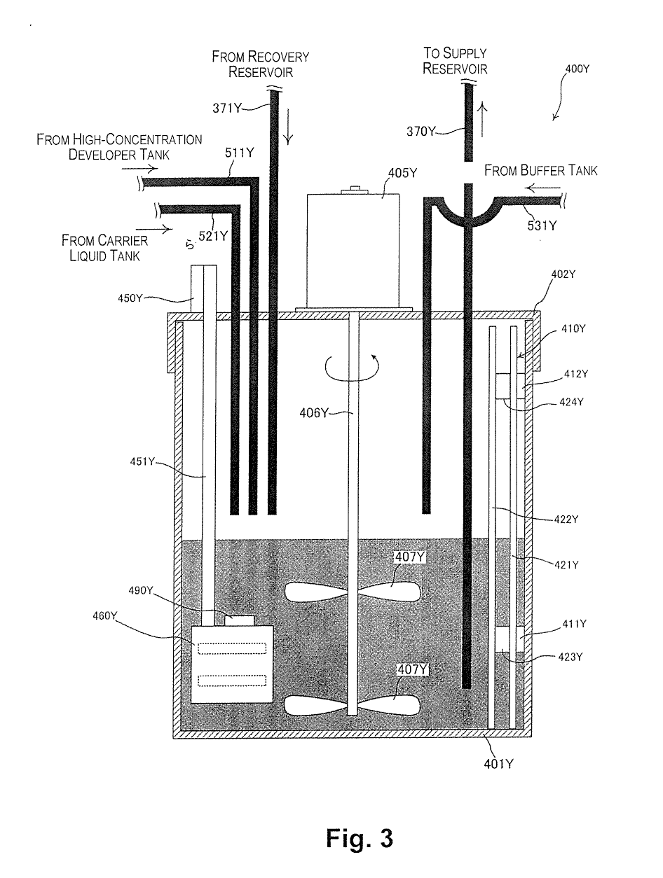

Next, the configuration of the concentration adjustment tank 400Y will be described in further detail. FIG. 3 is a cross section showing the simplified configuration of the concentration adjusting tank in the developing device. The concentration adjustment tank 400Y is used to adjust the developer used in the developing process in the developing device 30.

This concentration adjustment tank 400Y has a holder 401Y that holds developer, and a lid 402Y that covers this holder 401Y and into which are inserted various pipes, a shaft 406Y, a support member 451Y, and so forth.

A motor 405Y is attached to this lid 402Y. The shaft 406Y, which is the rotational shaft of the motor 405Y, is inserted from the lid 402Y into the holder 401Y. The stirring blades 407Y are attached to the shaft 406Y at positions where it is assumed they will be submerged in the developer. When the motor 405Y is operated, the stirring blades 407Y rotate and stir the developer in the holder 401Y.

An electrostatic capacitance-type liquid level sensor 410Y, which is used to detect the level of the developer inside the concentration adjustment tank 400Y, is provided on the side face of the holder 401Y of the concentration adjustment tank 400Y. This electrostatic capacitance-type liquid level sensor 410Y forms a capacitor by a first sensor electrode 421Y and an opposing second sensor electrode 422Y, and detects the level of the developer from the electrostatic capacitance of this capacitor. A first spacer 423Y and a second spacer 424Y are disposed between the opposing electrodes as distance limiting members for keeping a constant distance between the first sensor electrode 421Y and the second sensor electrode 422Y. Also, the first sensor electrode 421Y is attached to the holder 401Y via an attachment base 411Y and an attachment base 412Y.

Stainless steel (SUS 304, SUS 430), iron, aluminum (A5052, A6063), or another such material is used for the first sensor electrode 421Y and the second sensor electrode 422Y. The surfaces of the first sensor electrode 421Y and the second sensor electrode 422Y are given a coating of polytetrafluoroethylene (trade name Teflon) or the like.

Examples of the material used for the first spacer 423Y and the second spacer 424Y, which are members that determine the gap between the electrodes, include polyethylene, polyethylene terephthalate, polystyrene, polypropylene, AS resin, ABS resin, polyamide, polycarbonate, polyacetal resin, and other such electrical insulators.

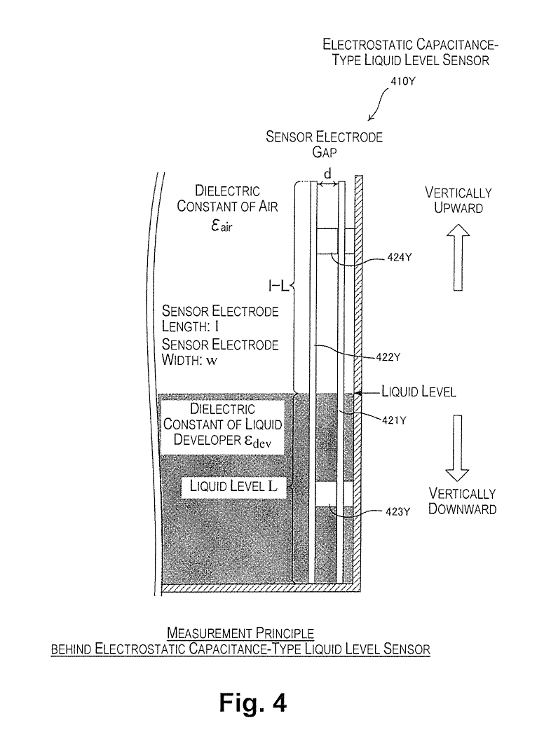

FIG. 4 is a diagram illustrating the measurement principle behind an electrostatic capacitance type of liquid level sensor. Electrodes of the same shape are used for the first sensor electrode 421Y and the second sensor electrode 422Y, and these electrodes have a width w and a length d. The first sensor electrode 421Y and the second sensor electrode 422Y are disposed opposite each other with a gap d in between. If L is the liquid level, and if we let ∈ₐᵢᵣ be the dielectric constant of air, and ∈_{dev} be the dielectric constant of the developer, then a capacitor Cₐᵢᵣ having air as a dielectric can be expressed by the following formula (1).

$$\begin{matrix}[ First Mathematical Formula ] & \\ {C}_{air} = {ɛ}_{air} \frac{w ( l - L )}{d} & ( 1 )\end{matrix}$$

A capacitor C_{dev} having a developer as a dielectric can be expressed by the following formula (2).

$$\begin{matrix}[ Second Mathematical Formula ] & \\ {C}_{dev} = {ɛ}_{dev} \frac{wL}{d} & ( 2 )\end{matrix}$$

Therefore, it can be seen that the value of a capacitor C formed by the first sensor electrode 421Y and the second sensor electrode 422Y varies with the liquid level L according to the following formula (3).

$$\begin{matrix}[ Third Mathematical Formula ] & \\ C = {ɛ}_{dev} \frac{wL}{d} + {ɛ}_{air} \frac{w ( l - L )}{d} = \frac{w ( {ɛ}_{dev} - {ɛ}_{air} )}{d} L + \frac{{ɛ}_{air} wl}{d} & ( 3 )\end{matrix}$$

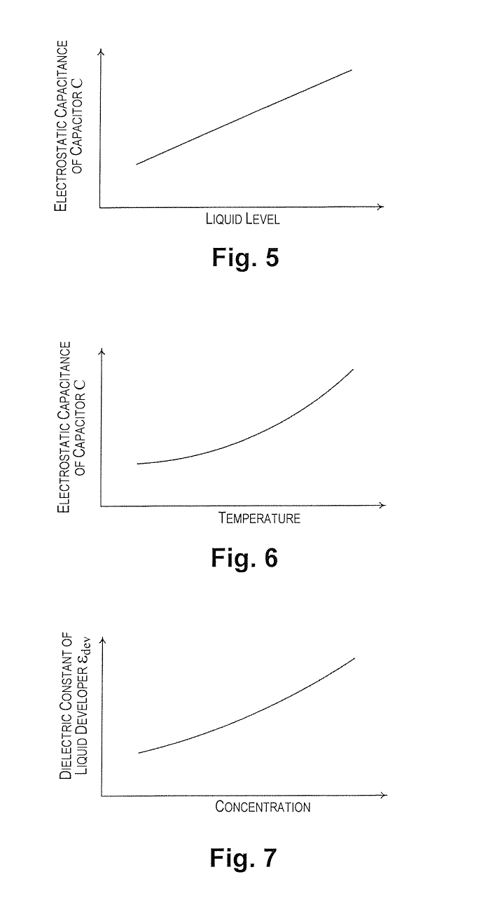

FIG. 5 is a graph of the relation between electrostatic capacitance and liquid level, found from the measurement principle behind the electrostatic capacitance-type liquid level sensor 410Y. It can be seen from the measurement principle indicated by Formula 3 above that there is a linear expression relation, as shown in the drawing, between the liquid level in the concentration adjustment tank 400Y and the electrostatic capacitance of the capacitor C formed by the first sensor electrode 421Y and the second sensor electrode 422Y.

It was found that the dielectric constant ∈_{dev} of the developer used in this embodiment varies with temperature. Therefore, on the basis of this change, the electrostatic capacitance of the capacitor C formed by the first sensor electrode 421Y and the second sensor electrode 422Y varies as shown in FIG. 6 according to the change in temperature. The relational formula between temperature and electrostatic capacitance in FIG. 6 can be approximated by a quadratic expression.

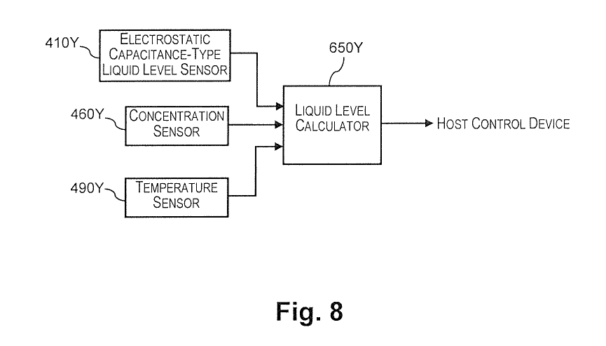

Also, the dielectric constant ∈_{dev} of the developer used in this embodiment varies according to the solids concentration in which the toner is dispersed in the carrier liquid. FIG. 7 is a graph of the simplified relation between concentration and the dielectric constant ∈_{dev} of the developer. As shown in FIG. 7, when the concentration of the developer rises, it can be seen that the dielectric constant ∈_{dev} of the developer also tends to rise.

As mentioned above, since the electrostatic capacitance of the capacitor C varies with the concentration and temperature of the developer in the electrostatic capacitance-type liquid level sensor 410Y, in calculating the liquid level L, corrections for temperature and concentration are made on the basis of the electrostatic capacitance of the capacitor C.

Returning to FIG. 3, a fixed member 450Y is provided to the lid 402Y, and a concentration sensor 460Y and a temperature sensor 490Y are provided to the support member 451Y, which extends from the fixed member 450Y so as to pass through the lid 402Y.

The concentration sensor 460Y can be, for example, one that sends and receives ultrasonic waves with two piezoelectric elements disposed opposite each other, and measures concentration from the propagation time of these waves. The temperature sensor 490Y is a platinum sensor or another such temperature detecting unit.

Detection signals from the electrostatic capacitance-type liquid level sensor 410Y, the concentration sensor 460Y, and the temperature sensor 490Y are taken off to the outside of the concentration adjustment tank 400Y through lead wires or the like (not shown).

Next, the method for calculating the level of the developer in the concentration adjustment tank 400 of the developing device 30 pertaining to this embodiment constituted as above will be described. FIG. 8 is a block diagram illustrating the calculation of the level of a developer in the concentration adjustment tank 400.

In FIG. 8, a liquid level calculator 650Y is a multipurpose information processor including a CPU, a ROM for holding programs that operate in the CPU, a RAM serving as a work area for the CPU, and so forth. To this liquid level calculator 650Y are inputted data about the electrostatic capacitance between electrodes detected by the electrostatic capacitance-type liquid level sensor 410Y constituted by the first sensor electrode 421Y and the second sensor electrode 422Y, data related to the concentration of the developer detected by the concentration sensor 460Y, and data related to the temperature of the developer detected by the temperature sensor 490Y.

The liquid level calculator 650 calculates the level of the developer held in the holder 401Y, and sends out liquid level data calculated by a host control device that controls the high-concentration developer supply pump 513Y, the carrier liquid supply pump 523Y, the recycled developer supply pump 533Y, and so forth.

In the liquid level calculator 650, in calculating the level of the developer in the holder 401Y, since data about the electrostatic capacitance between electrodes detected by the electrostatic capacitance-type liquid level sensor 410Y is the most basic data, it is also possible to calculate the liquid level data using just this data.

Also, as needed, in addition to using electrostatic capacitance data acquired by the electrostatic capacitance-type liquid level sensor 410Y, it is also possible to calculate the liquid level data on the basis of data related to the concentration of the developer detected by the concentration sensor 460Y, and data related to the temperature of the developer detected by the temperature sensor 490Y. In this case, the characteristics shown in FIGS. 6 and 7 are taken into account.

Also, as needed, in addition to using electrostatic capacitance data acquired by the electrostatic capacitance-type liquid level sensor 410Y, it is also possible to calculate the liquid level data on the basis of data related to the temperature of the developer detected by the temperature sensor 490Y. In this case, the characteristics shown in FIG. 6 are taken into account.

Also, as needed, in addition to using electrostatic capacitance data acquired by the electrostatic capacitance-type liquid level sensor 410Y, it is also possible to calculate the liquid level data on the basis of data related to the concentration of the developer detected by the concentration sensor 460Y. In this case, the characteristics shown in FIG. 7 are taken into account.

The developing device and image forming device pertaining to the invention include the holder 401Y for holding a developer containing a toner and a carrier, the electrostatic capacitance-type liquid level sensor 410Y having the first sensor electrode 421Y provided to the holder 401Y and the second sensor electrode 422Y opposite the first sensor electrode 421Y with the developer in between them, the concentration sensor 460Y disposed inside the holder 401Y and for detecting the concentration of the developer, and the liquid level calculator 650Y for calculating the level of the developer held in the holder 401Y on the basis of the concentration detected by the concentration sensor 460Y and the electrostatic capacitance detected by the electrostatic capacitance-type liquid level sensor 410Y.

With the invention as described above, the level of the developer held in the holder 401Y is calculated on the basis of the electrostatic capacitance detected by the electrostatic capacitance-type liquid level sensor 410Y having the first sensor electrode 421Y provided to the holder 401Y and the opposing second sensor electrode 422Y, so there is no need for a float or the like, and this prevents the device from becoming bulkier.

Also, with the invention, since the level of the liquid level is calculated without using any moving parts, the liquid level can be detected more accurately.

Next, another embodiment of the invention will be described. This embodiment solves the following problem. Specifically, in Patent Literature 2, the structure had an electrostatic capacitance type of water storage level detector and a water storage level measurement device on the outside of a vessel that contained a liquid, and this water storage level detector had low sensitivity because it was disposed outside the vessel, so all it could do was to determine whether or not a liquid was. Accordingly, it could not determine the proper replenishing amount, so the wrong amount of replenishing liquid was added and it took a long time to reach the targeted concentration or liquid level, or the developer concentration fluctuated greatly, and image quality suffered. The following embodiment solves this problem.

Also, when the liquid level is determined on the basis of a change in the electrostatic capacitance measured by a first electrode plate and a second electrode plate as discussed in Patent Literature 2, it can be difficult to determine the liquid level accurately with a data processing circuit that determines the liquid level on the basis of the measured electrostatic capacitance, due to the effect of floating capacitance in the lead wires that connect this data processing circuit with the two electrode plates used to measure the electrostatic capacitance. The following embodiment also solves this problem.

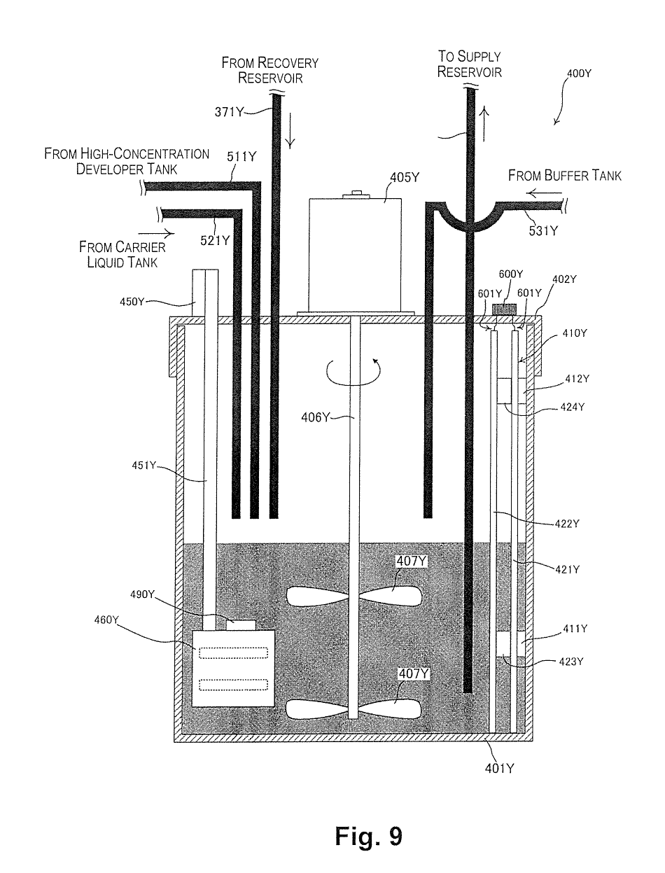

Next, the configuration of the concentration adjustment tank 400Y will be described in further detail. FIG. 9 is a cross section showing the simplified configuration of the concentration adjusting tank in a developing device. The concentration adjustment tank 400Y is used to adjust the developer used in the developing process in the developing device 30.

This concentration adjustment tank 400 has a holder 401Y that holds developer, and a lid 402Y that covers this holder 401Y and into which are inserted various pipes, the shaft 406Y, the support member 451Y, and so forth.

The motor 405Y is attached to this lid 402Y. The shaft 406Y, which is the rotational shaft of the motor 405Y, is inserted from the lid 402Y into the holder 401Y. The stirring blades 407Y are attached to the shaft 406Y at positions where it is assumed they will be submerged in the developer. When the motor 405Y is operated, the stirring blades 407Y rotate and stir the developer in the holder 401Y.

An electrostatic capacitance-type liquid level sensor 410Y, which is used to detect the level of the developer inside the concentration adjustment tank 400Y, is provided on the side face of the holder 401Y of the concentration adjustment tank 400Y. This electrostatic capacitance-type liquid level sensor 410Y forms a capacitor by a first sensor electrode 421Y and an opposing second sensor electrode 422Y, and detects the level of the developer from the electrostatic capacitance of this capacitor. A first spacer 423Y and a second spacer 424Y are disposed between the opposing electrodes as distance limiting members for keeping a constant distance between the first sensor electrode 421Y and the second sensor electrode 422Y. Also, the first sensor electrode 421Y is attached to the holder 401Y via an attachment base 411Y and an attachment base 412Y.

Stainless steel (SUS 304, SUS 430), iron, aluminum (A5052, A6063), or another such material is used for the first sensor electrode 421Y and the second sensor electrode 422Y. The surfaces of the first sensor electrode 421Y and the second sensor electrode 422Y are given a coating of polytetrafluoroethylene (trade name Teflon) or the like.

Examples of the material used for the first spacer 423Y and the second spacer 424Y, which are members that determine the gap between the electrodes, include polyethylene, polyethylene terephthalate, polystyrene, polypropylene, AS resin, ABS resin, polyamide, polycarbonate, polyacetal resin, and other such electrical insulators.

The first sensor electrode 421Y and the second sensor electrode 422Y in the electrostatic capacitance-type liquid level sensor 410Y is electrically connected to a data processing circuit 600Y by two lead wires 601Y. With the invention, this data processing circuit 600Y is at least disposed vertically above the second spacer 424Y. In this embodiment, more specifically, it is attached to the lid 402 vertically above the second spacer 424Y. Accordingly, the routing of the lead wires 601Y can be shorter, and the measurement value measured by the electrostatic capacitance-type liquid level sensor 410Y can be inputted to the data processing circuit 600Y in a state of being almost completely unaffected by floating capacitance of the lead wires 601Y.

With the developing device and image forming device of the invention thus described, since data processing is performed on the basis of the electrostatic capacitance detected by the data processing circuit 600Y provided vertically above a limiting member (the second spacer 424Y) that limits the distance between the first sensor electrode 421Y and the second sensor electrode 422Y, there is almost no effect by floating capacitance of the lead wires 601Y, and the liquid level can be accurately calculated by the data processing circuit 600Y.

The measurement principle of the electrostatic capacitance-type liquid level sensor can be the same as that in the previous embodiment.

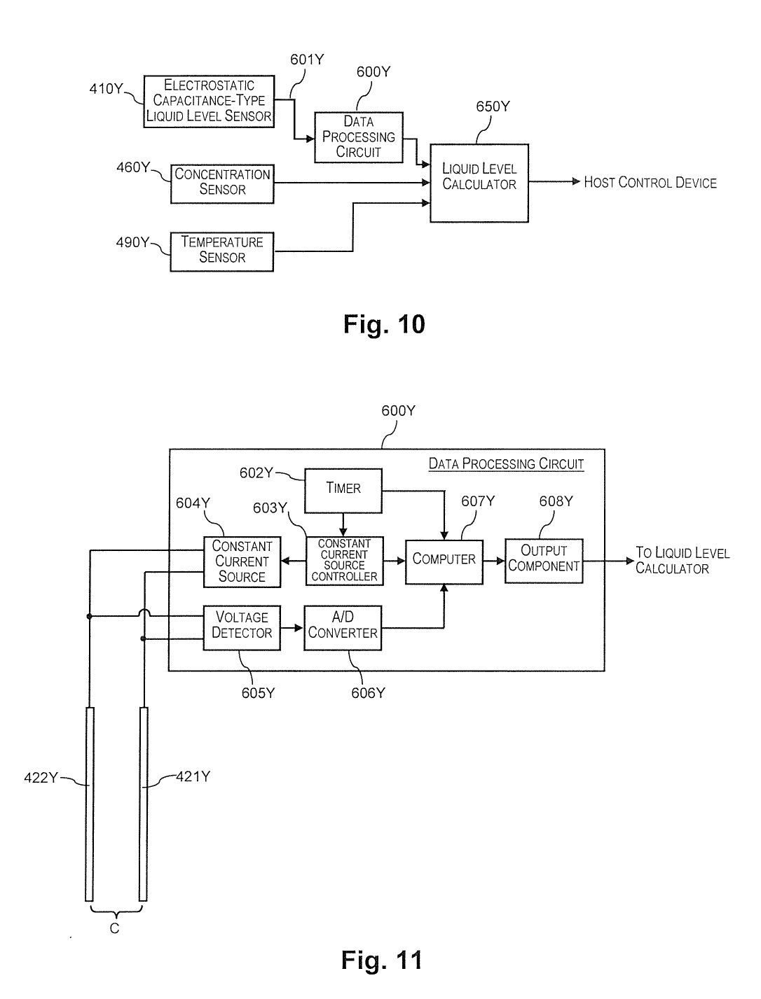

Next, the method for calculating the level of the liquid level in the concentration adjustment tank 400 of the developing device 30 pertaining to this embodiment constituted as above will be described. FIG. 10 is a block diagram illustrating the calculation of the level of a developer in the concentration adjustment tank 400.

In FIG. 10, the data processing circuit 600Y is a processing circuit that acquires data about the electrostatic capacitance between the electrodes (the first sensor electrode 421Y and the second sensor electrode 422Y) detected by the electrostatic capacitance-type liquid level sensor 410Y, and converts the acquired electrostatic capacitance data into a digital output value.

FIG. 11 is a block diagram of the data processing circuit 600Y. The flow of processing in this data processing circuit 600Y will be described.

When counting of a specific time T is begun at a timer 602Y (clock unit), a constant current source controller 603Y receives this count, and the first sensor electrode 421Y and the second sensor electrode 422Y are charted for the time T at a constant current I by a constant current source 604Y.

A voltage detector 605Y detects voltage between the first sensor electrode 421Y and the second sensor electrode 422Y. The value detected by the voltage detector 605Y is subjected to A/D conversion by an A/D converter 606Y and made into digital voltage data, which is inputted to a computer 607Y. The computer 607Y acquires voltage data V after the specific time T has elapsed from the count by the timer 602Y. The computer 607Y computes (1×T)/V to calculate data about the electrostatic capacitance of the electrostatic capacitance-type liquid level sensor 410Y formed by the first sensor electrode 421Y and the second sensor electrode 422Y. The computer 607Y sends this from an output component 608Y to a liquid level calculator 650 (a host computing device).

The above-mentioned input to the data processing circuit 600Y is analog electrostatic capacitance data, and in this embodiment, floating capacitance of the lead wires 601Y can be prevented from intruding on the analog electrostatic capacitance data by using extremely short lead wires 601Y. Meanwhile, the output from the data processing circuit 600Y is digital electrostatic capacitance data, and this data can be sent to the liquid level calculator 650Y regardless of any floating capacitance of transmission lines or the like.

In FIG. 10, the liquid level calculator 650Y is a multipurpose information processor including a CPU, a ROM for holding programs that operate in the CPU, a RAM serving as a work area for the CPU, and so forth. To this liquid level calculator 650Y are inputted the electrostatic capacitance data outputted from the data processing circuit 600Y, data related to the concentration of the developer detected by the concentration sensor 460Y, and data related to the temperature of the developer detected by the temperature sensor 490Y.

The liquid level calculator 650 calculates the level of the developer held in the holder 401Y on the basis of the above-mentioned input data, and sends the calculated level data to a host control device that controls the high-concentration developer supply pump 513Y, the carrier liquid supply pump 523Y, the recycled developer supply pump 533Y, and so forth.

In the liquid level calculator 650, in calculating the level of the developer in the holder 401Y, since data about the electrostatic capacitance between electrodes detected by the electrostatic capacitance-type liquid level sensor 410Y is the most basic data, it is also possible to calculate the liquid level data using just this data.

Also, as needed, in addition to using electrostatic capacitance data inputted from the data processing circuit 600Y, it is also possible to calculate the liquid level data on the basis of data related to the concentration of the developer detected by the concentration sensor 460Y, and data related to the temperature of the developer detected by the temperature sensor 490Y. In this case, the characteristics shown in FIGS. 6 and 7 are taken into account.

Also, as needed, in addition to using electrostatic capacitance data inputted from the data processing circuit 600Y, it is also possible to calculate the liquid level data on the basis of data related to the temperature of the developer detected by the temperature sensor 490Y. In this case, the characteristics shown in FIG. 6 are taken into account.

Also, as needed, in addition to using electrostatic capacitance data inputted from the data processing circuit 600Y, it is also possible to calculate the liquid level data on the basis of data related to the concentration of the developer detected by the concentration sensor 460Y. In this case, the characteristics shown in FIG. 7 are taken into account.

With the developing device and image forming device of the invention thus described, since data processing is performed on the basis of the electrostatic capacitance detected by the data processing circuit 600Y provided vertically above a limiting member (the second spacer 424Y) that limits the distance between the first sensor electrode 421Y and the second sensor electrode 422Y, there is almost no effect by floating capacitance of the lead wires 601Y, and the liquid level can be accurately calculated by the data processing circuit 600Y.

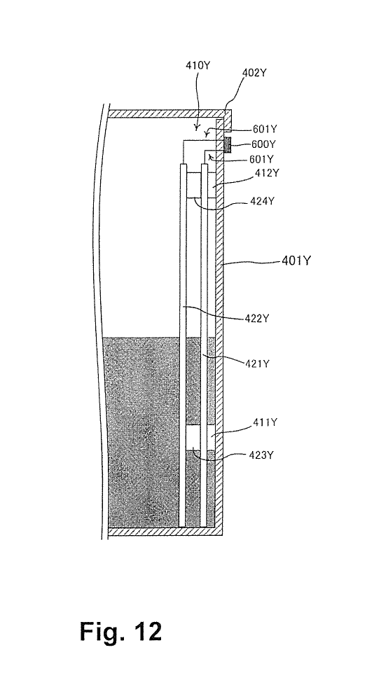

Another embodiment of the invention will now be described. This embodiment differs from the previous embodiments only in that the data processing circuit 600Y is attached at a different location, and this will be described below. FIG. 12 is a diagram illustrating how the data processing circuit 600Y is attached in the developing device pertaining to another embodiment of the invention.

In this embodiment, the data processing circuit 600Y is attached to the outer peripheral wall of the holder 401Y, vertically above the second spacer 424Y. This allows the routing of the lead wires 601Y to be shortened, and allows the measurement value measured by the electrostatic capacitance-type liquid level sensor 410Y to be inputted to the data processing circuit 600Y in a state of being almost completely unaffected by floating capacitance of the lead wires 601Y.

Again with the data processing circuit 600Y attached as discussed above, there is almost no effect by floating capacitance of the lead wires 601Y, and the liquid level can be accurately calculated by the data processing circuit 600Y.

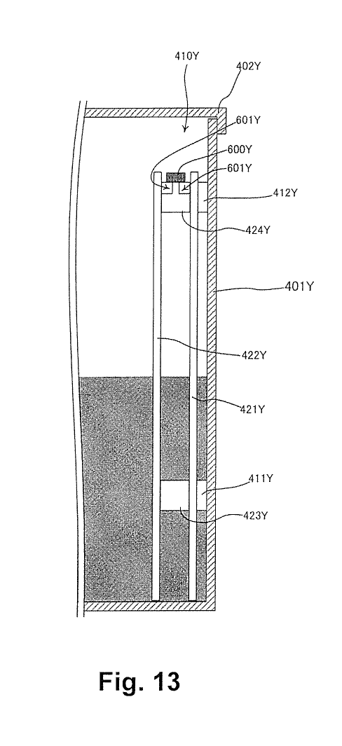

Another embodiment of the invention will now be described. This embodiment differs from the embodiments described so far only in that the data processing circuit 600Y is attached at a different location, and this will be described below. FIG. 13 is a diagram illustrating how the data processing circuit 600Y is attached in the developing device pertaining to another embodiment of the invention.

In this embodiment, the data processing circuit 600Y is attached vertically above the second spacer 424Y. This allows the routing of the lead wires 601Y to be shortened, and allows the measurement value measured by the electrostatic capacitance-type liquid level sensor 410Y to be inputted to the data processing circuit 600Y in a state of being almost completely unaffected by floating capacitance of the lead wires 601Y.

Again with the data processing circuit 600Y attached as discussed above, there is almost no effect by floating capacitance of the lead wires 601Y, and the liquid level can be accurately calculated by the data processing circuit 600Y.

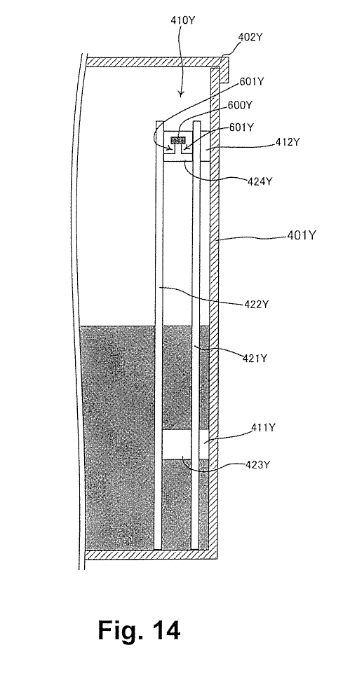

Another embodiment of the invention will now be described. This embodiment differs from the embodiments described so far only in that the data processing circuit 600Y is attached at a different location, and this will be described below. FIG. 14 is a diagram illustrating how the data processing circuit 600Y is attached in the developing device pertaining to another embodiment of the invention.

In this embodiment, the data processing circuit 600Y is embedded in the second spacer 424Y. This allows the routing of the lead wires 601Y to be shortened, and allows the measurement value measured by the electrostatic capacitance-type liquid level sensor 410Y to be inputted to the data processing circuit 600Y in a state of being almost completely unaffected by floating capacitance of the lead wires 601Y.

Again with the data processing circuit 600Y attached as discussed above, there is almost no effect by floating capacitance of the lead wires 601Y, and the liquid level can be accurately calculated by the data processing circuit 600Y.

With the developer holding vessel, developing device, and image forming device of the invention, sensors including of the first sensor electrode 421Y and the second sensor electrode 422Y are disposed opposite each other in the holder 401Y and the distance between the electrodes limited by the second spacer 424Y, and the electrostatic capacitance is detected by these sensors, so there is an increase in sensing sensitivity, sensing resolution, and sensing accuracy, the amount of replenishing developer can be suitably decided, the replenishing developer is supplied in the appropriate amount, there is less fluctuation in toner concentration, fluctuation in image density is reduced, and a better image can be obtained.

Next, another embodiment of the invention will be described. This embodiment solves the following problem. When a determination related to the level of a developer is performed on the basis of the change in electrostatic capacitance measured by the first electrode and the second electrode as discussed in Patent Literature 2, the fact that the electrostatic capacitance varies with the concentration of the developer must also be taken into account, but no consideration is given to the effect that a change in electrostatic capacitance due to concentration has on the level detection result, and accurate level information cannot be acquired. This embodiment solves this problem.

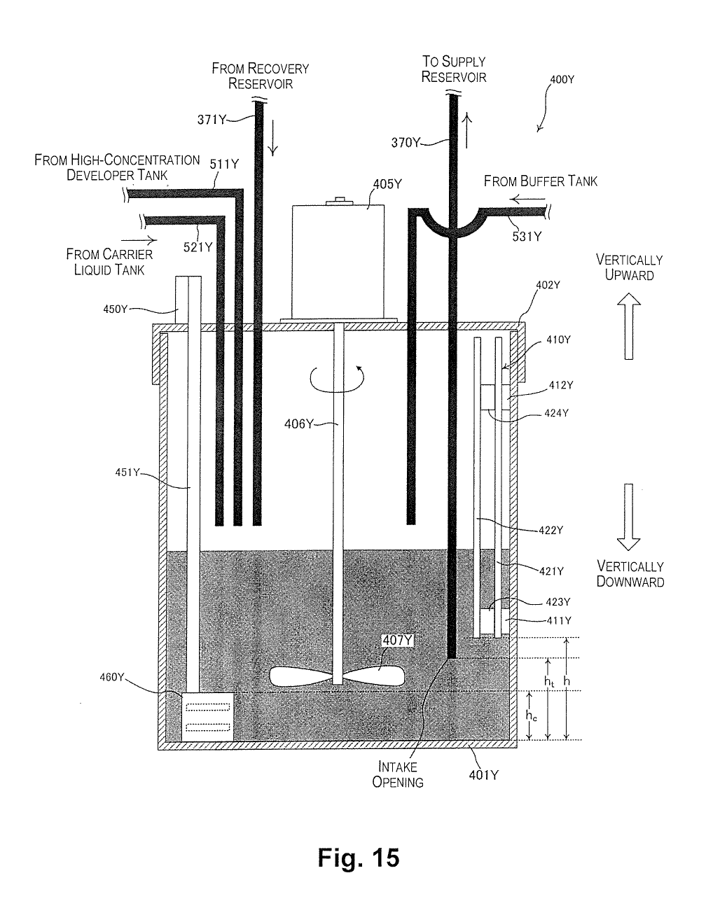

The configuration of the concentration adjustment tank 400Y pertaining to another embodiment will now be described in further detail. FIG. 15 is a cross section showing the simplified configuration of the concentration adjusting tank in a developing device. The concentration adjustment tank 400Y is used to adjust the developer used in the developing process in the developing device 30.

This concentration adjustment tank 400Y has a holder 401Y that holds developer, and a lid 402Y that covers this holder 401Y and into which are inserted various pipes, a shaft 406Y, a support member 451Y, and so forth.

A motor 405Y is attached to this lid 402Y. The shaft 406Y, which is the rotational shaft of the motor 405Y, is inserted from the lid 402Y into the holder 401Y. The stirring blades 407Y are attached to the shaft 406Y at positions where it is assumed they will be submerged in the developer. When the motor 405Y is operated, the stirring blades 407Y rotate and stir the developer in the holder 401Y.

The electrostatic capacitance-type liquid level sensor 410Y, which is used to detect the level of the developer inside the concentration adjustment tank 400Y, is provided on the side face of the holder 401Y of the concentration adjustment tank 400Y. This electrostatic capacitance-type liquid level sensor 410Y forms a capacitor by a first sensor electrode 421Y and an opposing second sensor electrode 422Y, and detects the level of the developer from the electrostatic capacitance of this capacitor. A first spacer 423Y and a second spacer 424Y are disposed between the opposing electrodes as distance limiting members for keeping a constant distance between the first sensor electrode 421Y and the second sensor electrode 422Y. Also, the first sensor electrode 421Y is attached to the holder 401Y via the attachment base 411Y and the attachment base 412Y.

Stainless steel (SUS 304, SUS 430), iron, aluminum (A5052, A6063), or another such material is used for the first sensor electrode 421Y and the second sensor electrode 422Y. The surfaces of the first sensor electrode 421Y and the second sensor electrode 422Y are given a coating of polytetrafluoroethylene (trade name Teflon) or the like.

Examples of the material used for the first spacer 423Y and the second spacer 424Y, which are members that determine the gap between the electrodes, include polyethylene, polyethylene terephthalate, polystyrene, polypropylene, AS resin, ABS resin, polyamide, polycarbonate, polyacetal resin, and other such electrical insulators.

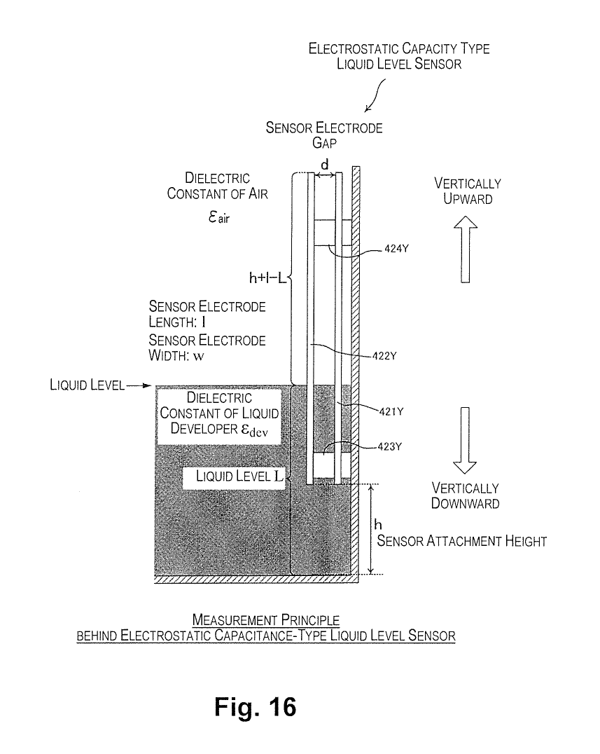

FIG. 16 is a diagram illustrating the measurement principle behind the electrostatic capacitance-type liquid level sensor 410Y. Electrodes of the same shape are used for the first sensor electrode 421Y and the second sensor electrode 422Y, and these electrodes have a width w and a length d. The first sensor electrode 421Y and the second sensor electrode 422Y are disposed opposite each other with a gap d in between. If h is the attachment height of the first sensor electrode 421Y and the second sensor electrode 422Y and L is the liquid level, and if we let ∈ₐᵢᵣ be the dielectric constant of air, and ∈_{dev} be the dielectric constant of the developer, then a capacitor Cₐᵢᵣ having air as a dielectric can be expressed by the following formula (4).

$$\begin{matrix}[ Fourth Mathematical Formula ] & \\ {C}_{air} = {ɛ}_{air} \frac{w ( h + l - L )}{d} & ( 4 )\end{matrix}$$

A capacitor C_{dev} having a developer as a dielectric can be expressed by the following formula (5).

$$\begin{matrix}[ Fifth Mathematical Formula ] & \\ {C}_{dev} = {ɛ}_{dev} \frac{w ( L - h )}{d} & ( 5 )\end{matrix}$$

Therefore, it can be seen that the value of a capacitor C formed by the first sensor electrode 421Y and the second sensor electrode 422Y varies with the liquid level L according to the following formula (6).

$$\begin{matrix}[ Sixth Mathematical Formula ] & \\ \begin{matrix}C = {ɛ}_{dev} \frac{w ( L - h )}{d} + {ɛ}_{air} \frac{w ( h + l - L )}{d} \\ = \frac{w ( {ɛ}_{dev} - {ɛ}_{air} )}{d} L + \frac{{ɛ}_{air} w ( l + h ) - {ɛ}_{dev} wh}{d}\end{matrix} & ( 6 )\end{matrix}$$

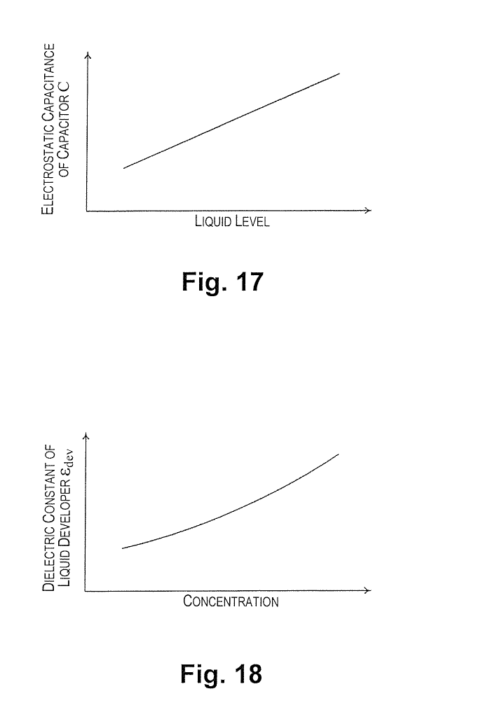

FIG. 17 is a graph of the relation between electrostatic capacitance and liquid level, found from the measurement principle behind the electrostatic capacitance-type liquid level sensor 410Y. It can be seen from the measurement principle depicted in FIG. 6 that there is a linear expression relation, as shown in the drawing, between the liquid level in the concentration adjustment tank 400Y and the electrostatic capacitance of the capacitor C formed by the first sensor electrode 421Y and the second sensor electrode 422Y.

Also, the dielectric constant ∈_{dev} of the developer used in this embodiment varies with the solids concentration of the toner dispersed in the carrier liquid. FIG. 18 is a graph of the simplified relation between concentration and the dielectric constant ∈_{dev} of a developer. As shown in FIG. 18, when the concentration of the developer rises, the dielectric constant ∈_{dev} of the developer also tends to rise.

As mentioned above, since the electrostatic capacitance of the capacitor C varies with the concentration of the developer in the electrostatic capacitance-type liquid level sensor 410Y, in calculating the liquid level L, correction for concentration is made on the basis of the electrostatic capacitance of the capacitor C.

Returning to FIG. 15, a fixed member 450Y is provided to the lid 402Y, and a concentration sensor 460Y and a temperature sensor 490Y are provided to the support member 451Y, which extends from the fixed member 450Y so as to pass through the lid 402Y.

The concentration sensor 460Y can be, for example, one that sends and receives ultrasonic waves with two piezoelectric elements disposed opposite each other, and measures concentration from the propagation time of these waves. The temperature sensor 490Y is a platinum sensor or another such temperature detecting unit.

Detection signals from the electrostatic capacitance-type liquid level sensor 410Y and the concentration sensor 460Y are taken off to the outside of the concentration adjustment tank 400Y through lead wires or the like (not shown).

The dimensional relations in the concentration adjustment tank 400Y discussed above will now be described. As shown in FIG. 15, we will let h be the height from the bottom face of the holder 401Y to the lower end of the electrostatic capacitance-type liquid level sensor 410Y. We will also let hₜ be the height from the bottom face of the holder 401Y to the inlet to the developer supply pipe 370Y that draws developer up from the holder 401Y and supplies it to the developer vessel 31Y. We will let h_{c} be the height from the bottom face of the holder 401Y to the upper face of the concentration sensor 460Y.

The image forming device pertaining to this embodiment has the following features. First, the concentration sensor 460Y that detects the concentration of developer is disposed vertically under the electrostatic capacitance-type liquid level sensor 410Y. Expressed as a dimensional relation, this corresponds to having the relation of h_{c}<h.

Because the electrostatic capacitance of the electrostatic capacitance-type liquid level sensor 410Y varies with the concentration of the developer, in calculating the liquid level L, it is necessary to make a correction according to concentration on the basis of the electrostatic capacitance of the capacitor C. Therefore, if the layout is such that the relation h_{c}<h is satisfied, then when the electrostatic capacitance-type liquid level sensor 410Y detects the electrostatic capacitance, the concentration sensor 460Y will be in a state of being thoroughly immersed in the developer, so the liquid level can be accurately detected.

Also, with the image forming device pertaining to this embodiment, the stirring blades 407Y that stir the developer are disposed vertically below the electrostatic capacitance-type liquid level sensor 410Y and vertically above the concentration sensor 460Y. Expressed as a dimensional relation, this means that the stirring blades 407Y is below the height h and is above the height h_{c}. With this layout relation, the developer whose concentration has been detected by the concentration sensor 460Y will be stirred by the stirring blades 407Y at all times, which results in more uniform concentration and increases the measurement accuracy of the concentration sensor 460Y.

Also, with the image forming device pertaining to this embodiment, the inlet to the developer supply pipe 370Y that draws developer up from the holder 401Y and supplies it to the developer vessel 31Y is disposed vertically above the concentration sensor 460Y. Expressed as a dimensional relation, this corresponds to having the relation of <h_{c}<hₜ. Since the concentration sensor 460Y measures the concentration of the developer, a state of being immersed in the developer must always be maintained, and if the concentration sensor 460Y is located vertically above the inlet to the developer supply pipe 370Y that draws the developer up from the holder 401Y, an advantage to this is that the above-mentioned state can always be ensured.

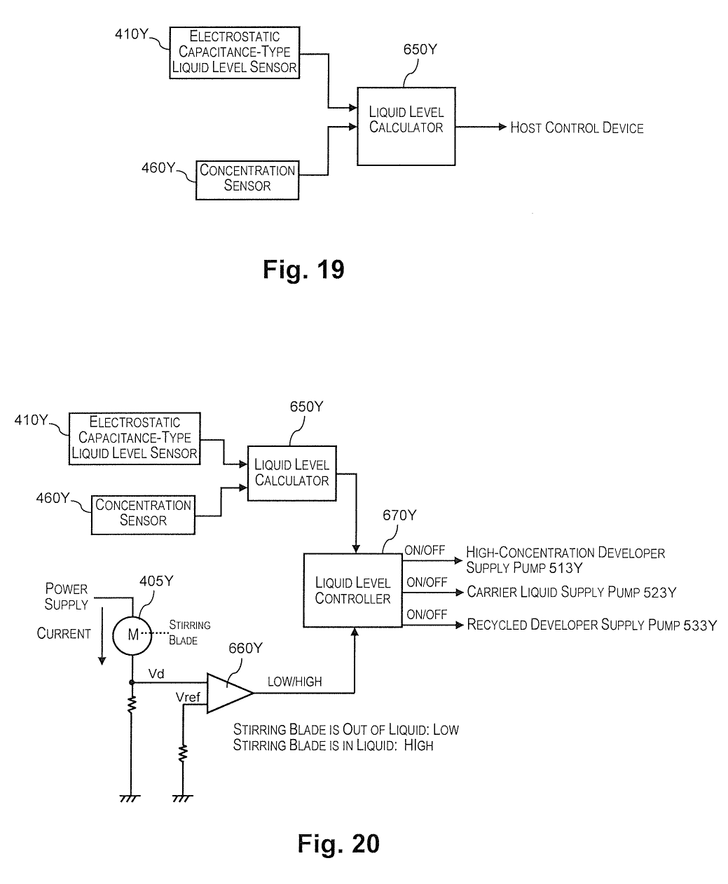

Next, the method for calculating the level of the developer in the concentration adjustment tank 400Y of the developing device 30 pertaining to this embodiment constituted as above will be described. FIG. 19 is a block diagram illustrating the calculation of the level of the developer in the concentration adjustment tank 400Y.

In FIG. 19, a liquid level calculator 650Y is a multipurpose information processor including a CPU, a ROM for holding programs that operate in the CPU, a RAM serving as a work area for the CPU, and so forth. To this liquid level calculator 650 are inputted data about the electrostatic capacitance between electrodes detected by the electrostatic capacitance-type liquid level sensor 410Y constituted by the first sensor electrode 421Y and the second sensor electrode 422Y, and data related to the concentration of the developer detected by the concentration sensor 460Y.

The liquid level calculator 650Y calculates the level of the developer held in the holder 401Y on the basis of the above-mentioned input data, and sends out liquid level data calculated by a host control device that controls the high-concentration developer supply pump 513Y, the carrier liquid supply pump 523Y, the recycled developer supply pump 533Y, and so forth.

In the liquid level calculator 650, in calculating the level of the developer in the holder 401Y, since data about the electrostatic capacitance between electrodes detected by the electrostatic capacitance-type liquid level sensor 410Y is the most basic data, it is also possible to calculate the liquid level data using just this data.

However, it is also possible to calculate the liquid level data on the basis of data pertaining to the concentration of the developer detected by the concentration sensor 460Y, in addition to the electrostatic capacitance data acquired by the electrostatic capacitance-type liquid level sensor 410Y. Data that is more reliable can be obtained by calculating the liquid level data by including concentration data detected by the concentration sensor 460Y. In this case, the characteristics shown in FIG. 19 are taken into account.

With the developing device and image forming device of the invention, the concentration sensor 460Y that detects the concentration of the developer is disposed vertically below the electrostatic capacitance-type liquid level sensor 410Y in the holder 401Y, and the detection result by the electrostatic capacitance-type liquid level sensor 410Y can be corrected on the basis of the change in electrostatic capacitance due to concentration, so accurate liquid level information can be acquired.

Next, another embodiment of the invention will be described. This embodiment differs from the previous embodiments in that the liquid level in the concentration adjustment tank 400Y is controlled on the basis of information obtained from the current operating the motor 405Y and the liquid level acquired by the liquid level calculator 650Y. This change will now be described.

FIG. 20 is a block diagram illustrating the control of the liquid level in the image forming device pertaining to another embodiment of the invention.

In FIG. 20, a liquid level controller 670Y is a microprocessor or other such information processing device for controlling the level of the developer in the concentration adjustment tank 400Y. The output of the liquid level calculator 650Y and the output of a comparator 660Y are inputted to this liquid level controller 670Y. Also, the liquid level controller 670Y outputs signals controlling the on/off switching of the high-concentration developer supply pump 513Y, the on/off switching of the carrier liquid supply pump 523Y, and the on/off switching of the recycled developer supply pump 533Y.

With the configuration in FIG. 20, when the motor 405Y is driven to rotate the stirring blades 407Y, current flows to a current detecting resistor Rd. The current value can be measured by measuring the voltage at both ends of the current detecting resistor Rd. As shown in the drawing, the comparator 660Y is connected to the current detecting resistor Rd here. The comparator 660Y has a binary output of either “low” or “high,” using a specific voltage Vref as the boundary. If the stirring blades 407Y are outside the liquid (a state in which the vessel is not filled with liquid up to the stirring blades 407Y), the load on the motor 405Y during rotation of the stirring blades 407Y is only that of the stirring blades 407Y themselves and air, so the load is light, and the torque and drive current of the motor 405Y are also low. In this case the comparator 660Y outputs “low,” for example.

On the other hand, if the stirring blades 407Y are in the liquid (a state in which the vessel is filled with liquid up to the stirring blades 407Y), the load on the motor 405Y during rotation of the stirring blades 407Y is that of the stirring blades 407Y themselves and the developer liquid, so the load is heavy, and the torque and drive current of the motor 405Y are also high. In this case the comparator 660Y outputs “high,” for example.

That is, whether the stirring blades 407Y are in or out of the developer can be determined by using the detecting resistor and the comparator 660Y to determine the amount of current. This output from the comparator 660Y is inputted to the liquid level controller 670Y.

Also, if the stirring blades 407Y are disposed at a height in between the concentration sensor 460Y and the electrostatic capacitance-type liquid level sensor 410Y, then the concentration sensor 460Y will always be in the liquid as long as the stirring blades 407Y are in the liquid.

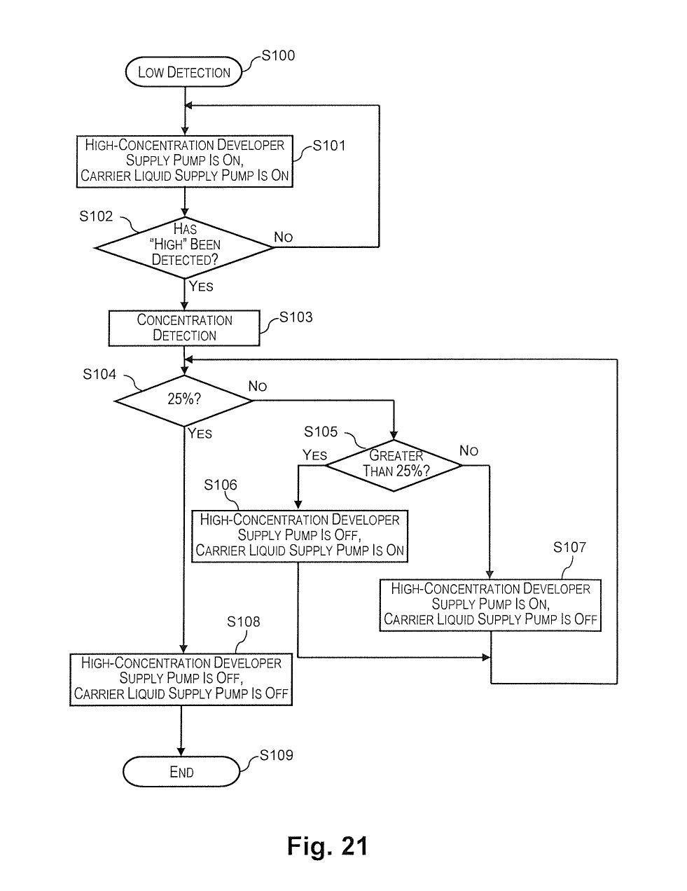

Next, the processing involved in the block configuration for liquid level control configured as above will be described. FIG. 21 is a flowchart of an example of the control of the liquid level in the image forming device pertaining to another embodiment of the invention. The flowchart shown in FIG. 21 is executed by the liquid level controller 670Y. The liquid level control shown in FIG. 21 is nothing but an example, however.

In step S100, if “low” is detected as the output from the comparator 660Y, then in the subsequent step S101 control is performed such that the high-concentration developer supply pump 513Y is switched on and the carrier liquid supply pump 523Y is also switched on, so as to raise the level of the developer in the concentration adjustment tank 400Y.

In step S102, it is determined whether or not an output of “high” has been detected from the comparator 660Y. If “yes” is the result of this determination, the flow proceeds to step S103, and concentration detection is performed by the concentration sensor 460Y.

In step S104, it is determined whether or not the result of concentration detection is 25%. If the determination is Yes in step S104, the flow proceeds to step S108, both the high-concentration developer supply pump 513Y and the carrier liquid supply pump 523Y are switched off, and the flow proceeds to step S109 and ends there.

On the other hand, if the determination is No in step S104, the flow proceeds to step S105, and it is determined whether or not the result of concentration detection is greater than 25%. If the determination is Yes in step S105, the flow proceeds to step S106, the high-concentration developer supply pump 513Y is switched off, and the carrier liquid supply pump 523Y is switched on, in order to lower the concentration of the developer.

If the determination is No in step S105, the flow proceeds to step S106, the high-concentration developer supply pump 513Y is switched on, and the carrier liquid supply pump 523Y is switched off, in order to raise the concentration of the developer.

The same action and effect can be obtained with this embodiment as in the previous embodiments.

Next, another embodiment of the invention will be described. In this embodiment, what is different from the previous embodiments is that a liquid detecting sensor 630Y for detecting the presence of a developer is provided to the concentration adjustment tank 400Y, and the liquid level controller 670Y performs liquid level control with information from this liquid detecting sensor 630Y also included.

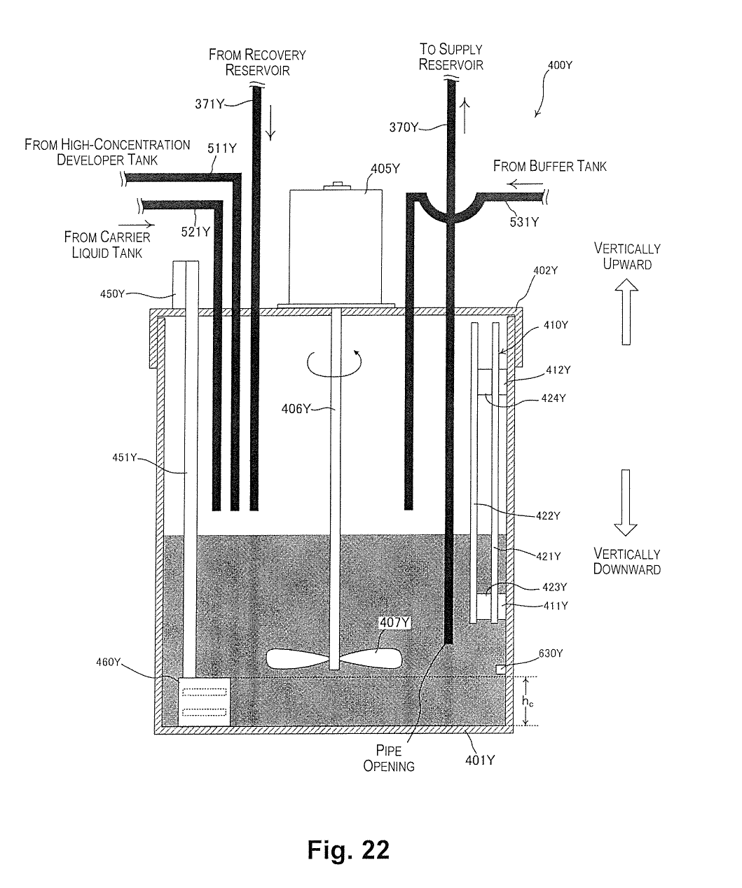

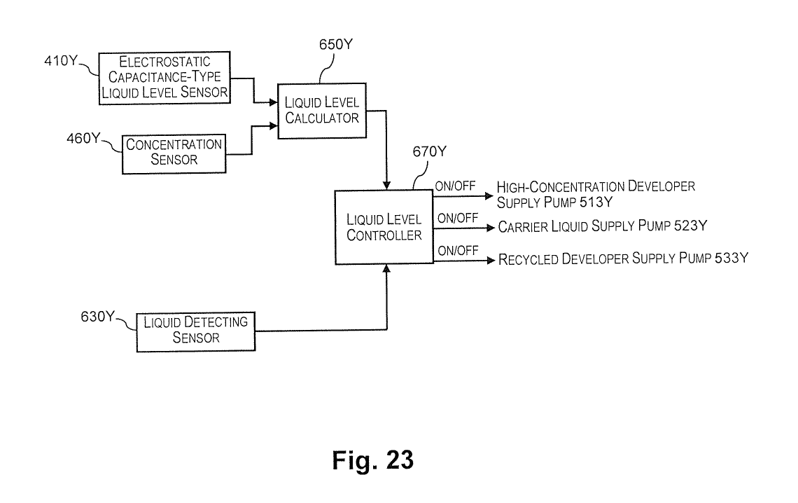

FIG. 22 is a cross section showing the simplified configuration of the concentration adjusting tank in the developing device pertaining to another embodiment of the invention. FIG. 23 is a block diagram illustrating the control of the liquid level in the image forming device pertaining to another embodiment of the invention.

The developing device pertaining to this embodiment has the liquid detecting sensor 630Y located inside the holder 401Y. The liquid detecting sensor 630Y is disposed at a specific height, and can determine whether or not there is any liquid at this position. For example, an optical type of liquid detecting sensor 630Y can be used. This liquid detecting sensor 630Y is disposed between the height h_{c} at the upper end of the concentration sensor 460Y and the height h at the lower end of the electrostatic capacitance-type liquid level sensor 410Y.

As shown in FIG. 23, information detected by the liquid detecting sensor 630Y is inputted to the liquid level controller 670Y and used for liquid level control. Also, the output of the liquid level calculator 650Y is inputted to the liquid level controller 670Y, and control signals that control the on/off switching of the high-concentration developer supply pump 513Y, the on/off switching of the carrier liquid supply pump 523Y, and the on/off switching of the recycled developer supply pump 533Y are outputted from the liquid level controller 670Y.

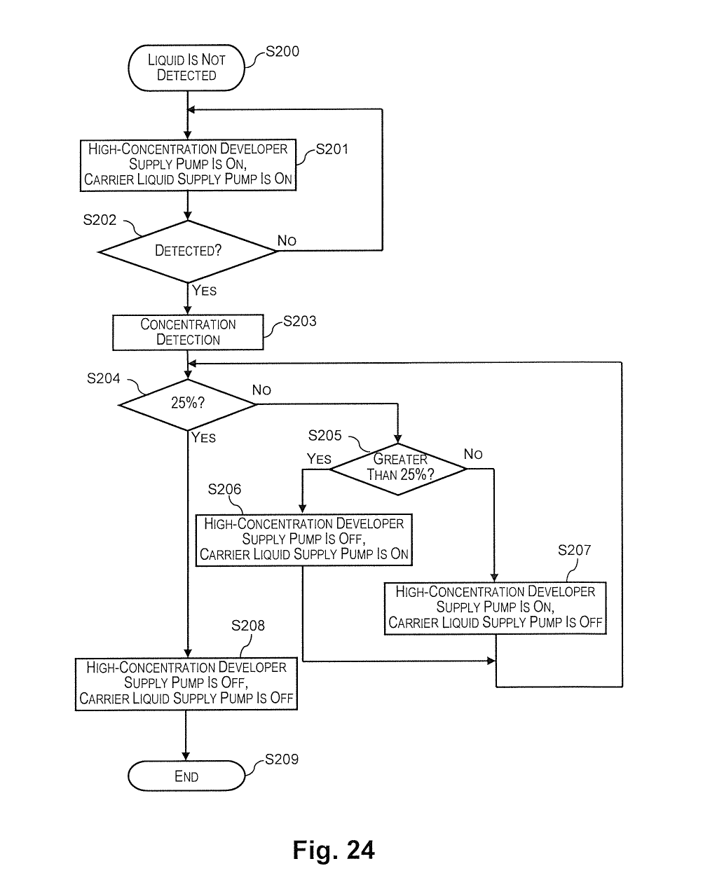

Next, the processing involved in the block configuration for liquid level control configured as above will be described. FIG. 24 is a flowchart of an example of the control of the liquid level in the image forming device pertaining to another embodiment of the invention. The flowchart shown in FIG. 24 is executed by the liquid level controller 670Y. The liquid level control shown in FIG. 24 is nothing but an example, however.

If it is detected in step S200 that no liquid developer is present, as the output information from the liquid detecting sensor 630Y, then in the subsequent step S201 control is performed such that the high-concentration developer supply pump 513Y is switched on and the carrier liquid supply pump 523Y is also switched on, so as to raise the level of the developer in the concentration adjustment tank 400Y.

In step S202, it is determined whether or not a developer is present, as the output information from the liquid detecting sensor 630Y. If the determination is Yes here, the flow proceeds to step S203, and concentration detection is performed by the concentration sensor 460Y.

In step S204 it is determined whether or not the result of concentration detection is 25%. If the determination is Yes in step S204, the flow proceeds to step S208, both the high-concentration developer supply pump 513Y and the carrier liquid supply pump 523Y are switched off, and the flow proceeds to step S209 and ends there.

On the other hand, if the determination is No in step S204, the flow proceeds to step S205, and it is determined whether or not the result of concentration detection is greater than 25%. If the determination is Yes in step S205, the flow proceeds to step S206, the high-concentration developer supply pump 513Y is switched off, and the carrier liquid supply pump 523Y is switched on, in order to lower the concentration of the developer.

If the determination is No in step S205, the flow proceeds to step S206, the high-concentration developer supply pump 513Y is switched on, and the carrier liquid supply pump 523Y is switched off, in order to raise the concentration of the developer.

The same action and effect can be obtained with this embodiment as in the previous embodiments.

Next, another embodiment of the invention will be described. In this embodiment, what is different from the previous embodiments is that the temperature sensor 490Y for detecting the temperature of a developer is provided to the concentration adjustment tank 400Y, and liquid level control is performed with information from this temperature sensor 490Y also included.

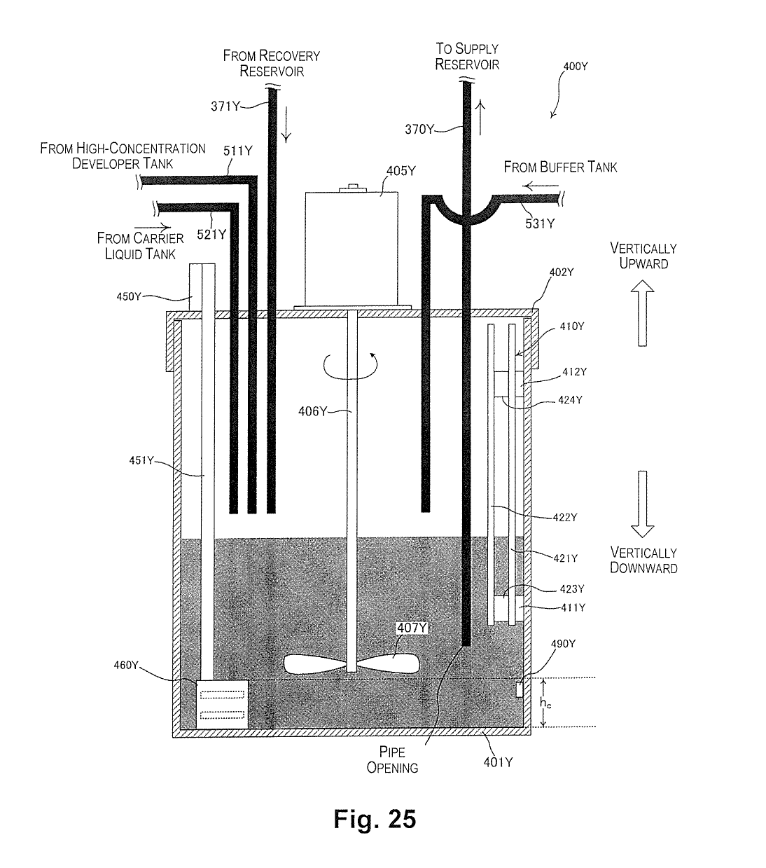

FIG. 25 is a cross section showing the simplified configuration of the concentration adjusting tank in the developing device pertaining to another embodiment of the invention. FIG. 27 is a block diagram illustrating the calculation of the liquid level in the developing device pertaining to another embodiment of the invention.

The developing device pertaining to this embodiment has the temperature sensor 490Y (used for measuring the developer temperature) located inside the holder 401Y. The temperature sensor 490Y is disposed at a height that is no more than the height h_{c} of the concentration sensor 460Y. If the temperature sensor 490Y is disposed at a height equal to or lower than the concentration sensor 460Y, the temperature sensor 490Y will always be in the liquid as long as the concentration sensor 460Y is in the liquid. Thus, the temperature of the developer liquid can be measured accurately, and temperature correction of the concentration data and temperature correction of the liquid level data can be performed more accurately.

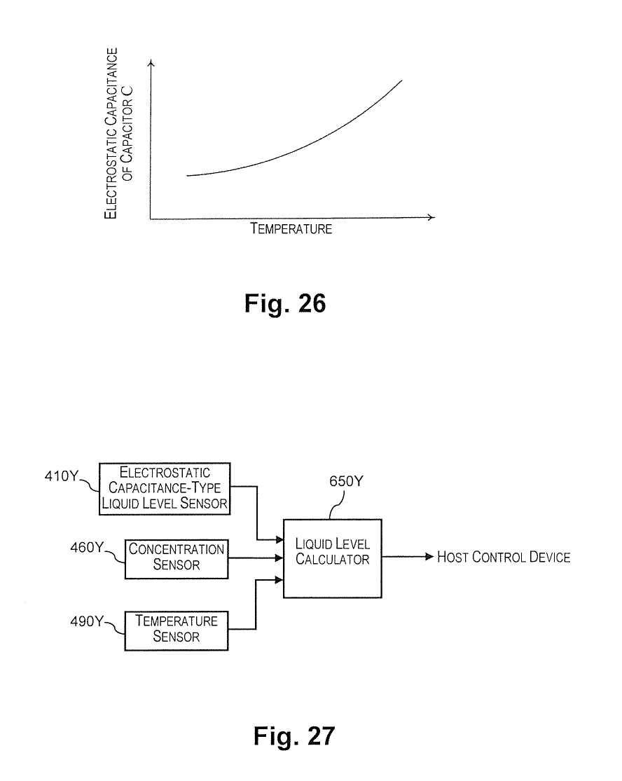

Regarding the dielectric constant ∈_{dev} of the developer used in this embodiment, it was found that the electrostatic capacitance varies with temperature. Therefore, on the basis of this change, the electrostatic capacitance of the capacitor C formed by the first sensor electrode 421Y and the second sensor electrode 422Y varies as shown in FIG. 26 according to the change in temperature. The relational formula between temperature and electrostatic capacitance in FIG. 26 can be approximated by a quadratic expression.

In view of this, in addition to using electrostatic capacitance data acquired by the electrostatic capacitance-type liquid level sensor 410Y, it is also possible to calculate the liquid level data on the basis of data related to the concentration of the developer detected by the concentration sensor 460Y, and data related to the temperature of the developer detected by the temperature sensor 490Y. In this case, the characteristics shown in FIGS. 26 and 19 are taken into account.

Also, as needed, in addition to using electrostatic capacitance data acquired by the electrostatic capacitance-type liquid level sensor 410Y, it is also possible to calculate the liquid level data on the basis of data related to the temperature of the developer detected by the temperature sensor 490Y. In this case, the characteristics shown in FIG. 26 are taken into account.

As discussed above, with the developing device and image forming device of the invention, a concentration detector for detecting the concentration of the developer is disposed vertically under the electrostatic capacitance detector in the holder, and the detection result by the electrostatic capacitance detector can be corrected on the basis of the change in electrostatic capacitance due to concentration, so accurate liquid level information can be acquired.

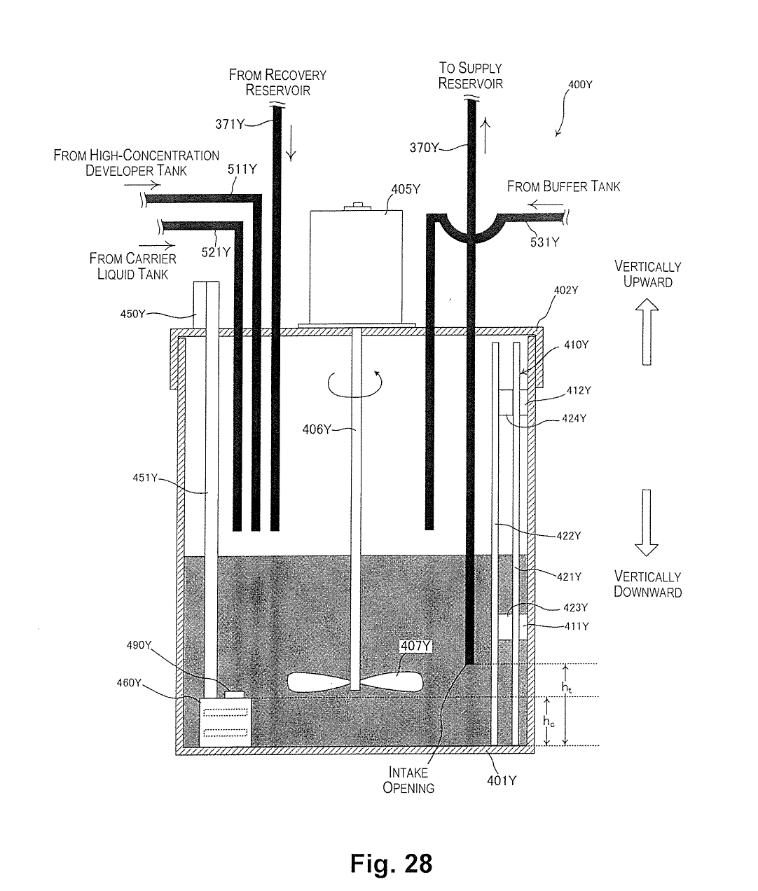

Next, the configuration of the concentration adjustment tank 400Y pertaining to another embodiment will be described in detail. FIG. 28 is a cross section showing the simplified configuration of the concentration adjusting tank in a developing device. The concentration adjustment tank 400Y is used to adjust the developer used in the developing process in the developing device 30Y.

This concentration adjustment tank 400Y has a holder 401Y that holds developer, and a lid 402Y that covers this holder 401Y and into which are inserted various pipes, the shaft 406Y, the support member 451Y, and so forth.

The motor 405Y is attached to this lid 402Y. The shaft 406Y, which is the rotational shaft of the motor 405Y, is inserted from the lid 402Y into the holder 401Y. The stirring blades 407Y are attached to the shaft 406Y at positions where it is assumed they will be submerged in the developer. When the motor 405Y is operated, the stirring blades 407Y rotate and stir the developer in the holder 401Y.

An electrostatic capacitance-type liquid level sensor 410Y, which is used to detect the level of the developer inside the concentration adjustment tank 400Y, is provided on the side face of the holder 401Y of the concentration adjustment tank 400Y. This electrostatic capacitance-type liquid level sensor 410Y forms a capacitor by a first sensor electrode 421Y and an opposing second sensor electrode 422Y, and detects the level of the developer from the electrostatic capacitance of this capacitor. A first spacer 423Y and a second spacer 424Y are disposed between the opposing electrodes as distance limiting members for keeping a constant distance between the first sensor electrode 421Y and the second sensor electrode 422Y. Also, the first sensor electrode 421Y is attached to the holder 401Y via an attachment base 411Y and an attachment base 412Y.

Stainless steel (SUS 304, SUS 430), iron, aluminum (A5052, A6063), or another such material is used for the first sensor electrode 421Y and the second sensor electrode 422Y. The surfaces of the first sensor electrode 421Y and the second sensor electrode 422Y are given a coating of polytetrafluoroethylene (trade name Teflon) or the like.

Examples of the material used for the first spacer 423Y and the second spacer 424Y, which are members that determine the gap between the electrodes, include polyethylene, polyethylene terephthalate, polystyrene, polypropylene, AS resin, ABS resin, polyamide, polycarbonate, polyacetal resin, and other such electrical insulators.

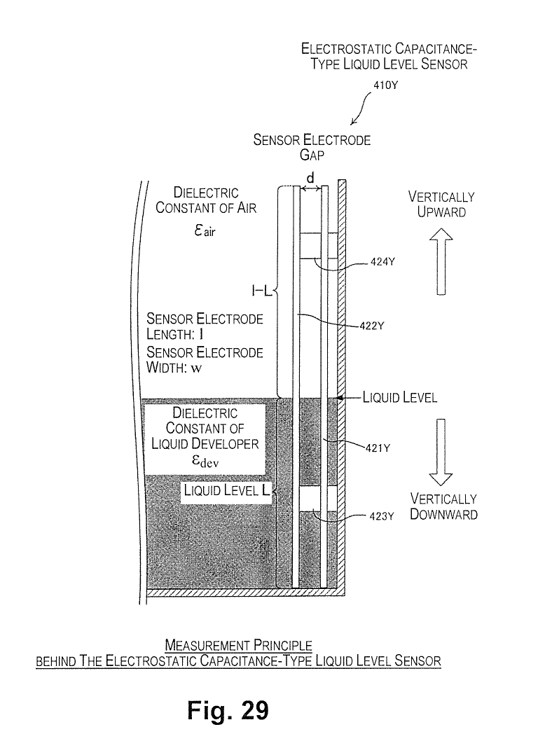

FIG. 29 is a diagram illustrating the measurement principle behind an electrostatic capacitance type of liquid level sensor. Electrodes of the same shape are used for the first sensor electrode 421Y and the second sensor electrode 422Y, and these electrodes have a width w and a length d. The first sensor electrode 421Y and the second sensor electrode 422Y are disposed opposite each other with a gap d in between. If L is the liquid level, and if we let ∈ₐᵢᵣ be the dielectric constant of air, and ∈_{dev} be the dielectric constant of the developer, then a capacitor Cₐᵢᵣ having air as a dielectric can be expressed by the following formula (1).

$$\begin{matrix}[ First Mathematical Formula ] & \\ {C}_{air} = {ɛ}_{air} \frac{w ( l - L )}{d} & ( 1 )\end{matrix}$$

A capacitor C_{dev} having a developer as a dielectric can be expressed by the following formula (2).

$$\begin{matrix}[ Second Mathematical Formula ] & \\ {C}_{dev} = {ɛ}_{dev} \frac{wL}{d} & ( 2 )\end{matrix}$$

Therefore, it can be seen that the value of a capacitor C formed by the first sensor electrode 421Y and the second sensor electrode 422Y varies with the liquid level L according to the following formula (3).

$$\begin{matrix}[ Third Mathematical Formula ] & \\ C = {ɛ}_{dev} \frac{wL}{d} + {ɛ}_{air} \frac{w ( l - L )}{d} = \frac{w ( {ɛ}_{dev} - {ɛ}_{air} )}{d} L + \frac{{ɛ}_{air} wl}{d} & ( 3 )\end{matrix}$$

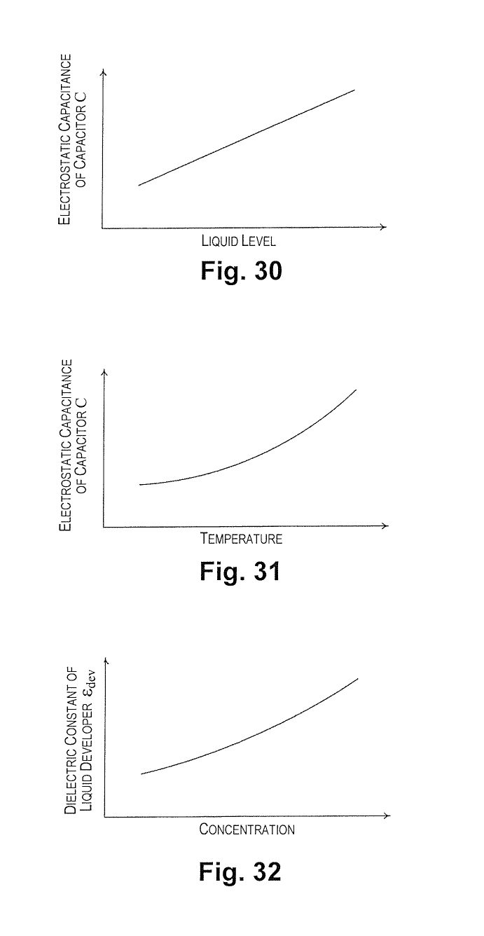

FIG. 30 is a graph of the relation between electrostatic capacitance and liquid level, found from the measurement principle behind the electrostatic capacitance type of liquid level sensor 410Y. It can be seen from the measurement principle indicated by Formula 3 above that there is a linear expression relation, as shown in the drawing, between the liquid level in the concentration adjustment tank 400Y and the electrostatic capacitance of the capacitor C formed by the first sensor electrode 421Y and the second sensor electrode 422Y.

In regard to the dielectric constant ∈_{dev} of the developer used in this embodiment, it was found that electrostatic capacitance varies with temperature. Therefore, on the basis of this change, the electrostatic capacitance of the capacitor C formed by the first sensor electrode 421Y and the second sensor electrode 422Y varies as shown in FIG. 31 according to the change in temperature. The relational formula between temperature and electrostatic capacitance in FIG. 31 can be approximated by a quadratic expression.

Also, the dielectric constant ∈_{dev} of the developer used in this embodiment varies according to the solids concentration in which the toner is dispersed in the carrier liquid. FIG. 32 is a graph of the simplified relation between concentration and the dielectric constant ∈_{dev} of the developer. As shown in FIG. 32, when the concentration of the developer rises, it can be seen that the dielectric constant ∈_{dev} of the developer also tends to rise.

As mentioned above, since the electrostatic capacitance of the capacitor C varies with the concentration and temperature of the developer in the electrostatic capacitance-type liquid level sensor 410Y, in calculating the liquid level L, corrections for temperature and concentration are made on the basis of the electrostatic capacitance of the capacitor C.

Returning to FIG. 28, a fixed member 450Y is provided to the lid 402Y, and a concentration sensor 460Y and a temperature sensor 490Y are provided to the support member 451Y, which extends from the fixed member 450Y so as to pass through the lid 402Y.

The concentration sensor 460Y can be, for example, one that sends and receives ultrasonic waves with two piezoelectric elements disposed opposite each other, and measures concentration from the propagation time of these waves. The temperature sensor 490Y is a platinum sensor or another such temperature detecting unit.

Detection signals from the electrostatic capacitance-type liquid level sensor 410Y, the concentration sensor 460Y, and the temperature sensor 490Y are taken off to the outside of the concentration adjustment tank 400Y through lead wires or the like (not shown).

The dimensional relations in the concentration adjustment tank 400Y discussed above will now be described. As shown in FIG. 28, we will let hₜ be the height from the bottom face of the holder 401Y to the inlet to the developer supply pipe 370Y that draws developer up from the holder 401Y and supplies it to the developer vessel 31Y. We will let h_{c} be the height from the bottom face of the holder 401Y to the upper face of the concentration sensor 460Y.

The image forming device pertaining to this embodiment has the following features. With the image forming device pertaining to this embodiment, the inlet to the developer supply pipe 370Y that draws developer up from the holder 401Y and supplies it to the developer vessel 31Y is disposed vertically above the concentration sensor 460Y. Expressed as a dimensional relation, this corresponds to having the relation of h_{c}<hₜ. Since the concentration sensor 460Y measures the concentration of the developer, a state of being immersed in the developer must always be maintained, and if the concentration sensor 460Y is located vertically above the inlet to the developer supply pipe 370Y that draws the developer up from the holder 401Y, an advantage to this is that the above-mentioned state can always be ensured.

Thus, with the invention, the concentration sensor 460Y that detects the concentration of developer is disposed vertically under the inlet to the developer supply pipe 370Y, and the detection result by the electrostatic capacitance-type liquid level sensor 410Y can be corrected on the basis of the change in electrostatic capacitance due to concentration, so accurate liquid level information can be acquired.

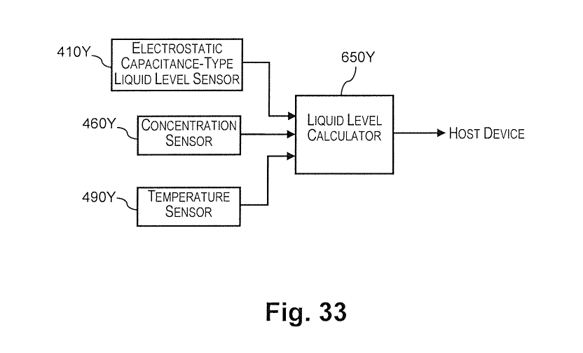

Next, the method for calculating the level of the developer in the concentration adjustment tank 400Y of the developing device 30Y pertaining to this embodiment constituted as above will be described. FIG. 33 is a block diagram illustrating the calculation of the level of the developer in the concentration adjustment tank 400.

In FIG. 33, the liquid level calculator 650Y is a multipurpose information processor including a CPU, a ROM for holding programs that operate in the CPU, a RAM serving as a work area for the CPU, and so forth. To this liquid level calculator 650Y are inputted data about the electrostatic capacitance between electrodes detected by the electrostatic capacitance-type liquid level sensor 410Y constituted by the first sensor electrode 421Y and the second sensor electrode 422Y, data related to the concentration of the developer detected by the concentration sensor 460Y, and data related to the temperature of the developer detected by the temperature sensor 490Y.

The liquid level calculator 650Y calculates the level of the developer held in the holder 401Y on the basis of the above-mentioned input data, and sends out liquid level data calculated by a host control device that controls the high-concentration developer supply pump 513Y, the carrier liquid supply pump 523Y, the recycled developer supply pump 533Y, and so forth.

In the liquid level calculator 650Y, in calculating the level of the developer in the holder 401Y, since data about the electrostatic capacitance between electrodes detected by the electrostatic capacitance-type liquid level sensor 410Y is the most basic data, it is also possible to calculate the liquid level data using just this data.

Also, as needed, in addition to using electrostatic capacitance data acquired by the electrostatic capacitance-type liquid level sensor 410Y, it is also possible to calculate the liquid level data on the basis of data related to the concentration of the developer detected by the concentration sensor 460Y, and data related to the temperature of the developer detected by the temperature sensor 490Y. In this case, the characteristics shown in FIGS. 31 and 32 are taken into account.

Also, as needed, in addition to using electrostatic capacitance data acquired by the electrostatic capacitance-type liquid level sensor 410Y, it is also possible to calculate the liquid level data on the basis of data related to the temperature of the developer detected by the temperature sensor 490Y. In this case, the characteristics shown in FIG. 31 are taken into account.

Also, as needed, in addition to using electrostatic capacitance data acquired by the electrostatic capacitance-type liquid level sensor 410Y, it is also possible to calculate the liquid level data on the basis of data related to the concentration of the developer detected by the concentration sensor 460Y. In this case, the characteristics shown in FIG. 32 are taken into account.

With the developing device and image forming device of the invention thus described, since a concentration detector that detects the concentration of the developer is provided vertically under the inlet to the developer supply pipe, and the detection result by the electrostatic capacitance detector can be corrected on the basis of the change in electrostatic capacitance due to concentration, accurate liquid level information can be acquired.

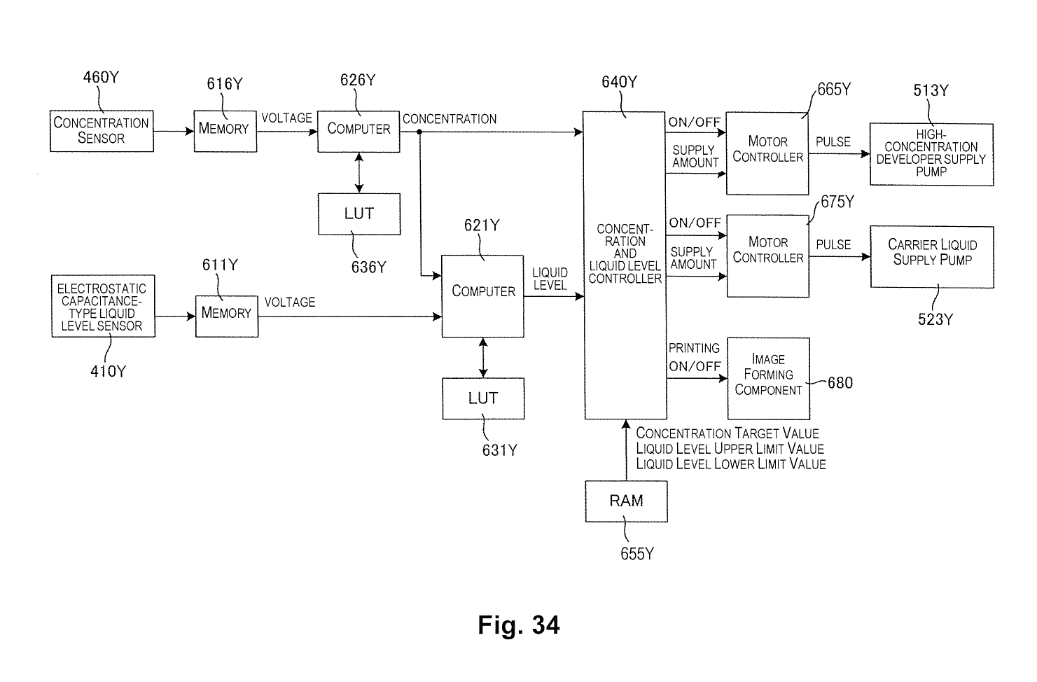

Next, the method for controlling the high-concentration developer supply pump 513Y and the carrier liquid supply pump 523Y pertaining to another embodiment will be described in further detail. FIG. 34 is a block diagram illustrating the control of the liquid level in the developing device pertaining to an embodiment of the invention.

The output value from the concentration sensor 460Y is temporarily stored in the memory 616Y. The output from the memory 616Y is inputted to the computer 626Y. The computer 626Y calculates the concentration on the basis of a look-up table listing the relation between voltage and concentration.

The output value from the electrostatic capacitance-type liquid level sensor 410Y is temporarily stored in a memory 611Y. The output from the memory 611Y is inputted to a computer 621Y. The computer 621Y calculates the liquid level on the basis of a look-up table listing how voltage and concentration data are related to liquid level. This liquid level data is inputted to a concentration and liquid level controller 640Y.

The concentration and liquid level controller 640Y inputs various data from the computer 621Y and the computer 626Y. The concentration and liquid level controller 640Y refers to a RAM 655Y and sends control commands to a motor controller 665Y that actuates the high-concentration developer supply pump 513Y, to a motor controller 675Y that actuates the carrier liquid supply pump 523Y, and to an image forming component 680 that handles image formation, according to this data.

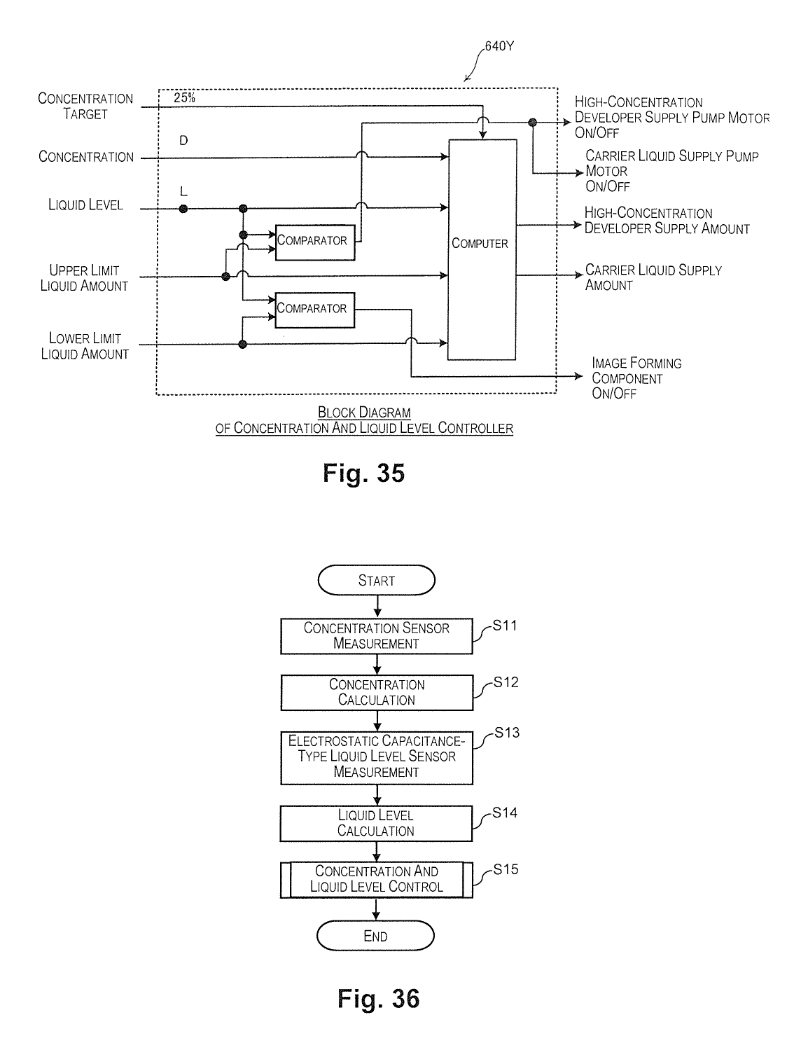

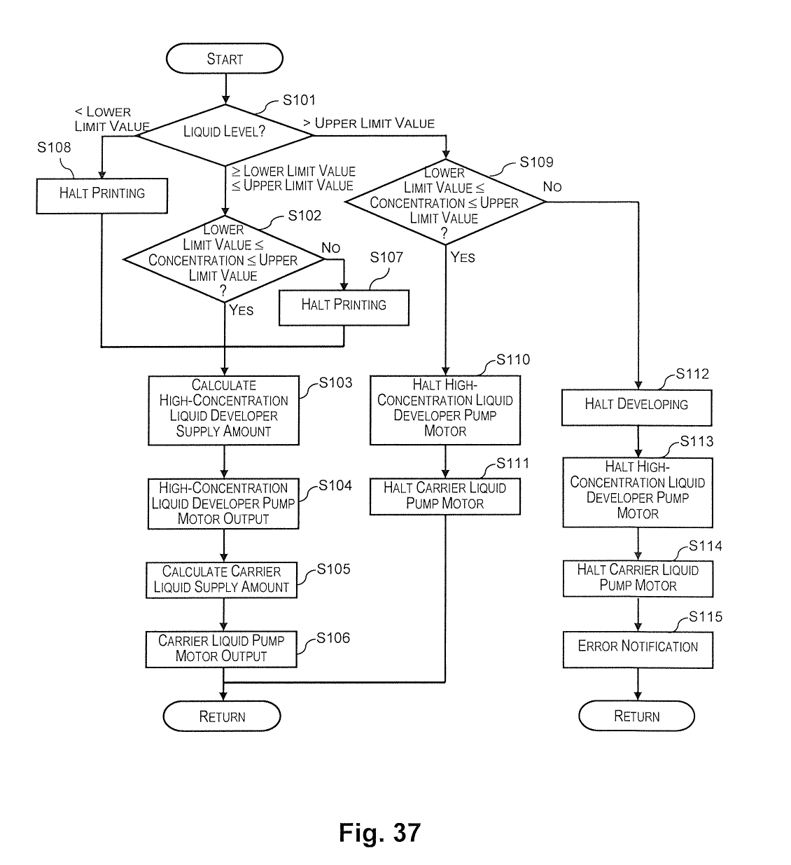

The configuration of the concentration and liquid level controller 640Y will now be described in further detail. FIG. 35 is a block diagram of the concentration and liquid level controller 640Y in the developing device pertaining to an embodiment of the invention.

The concentration and liquid level controller 640Y inputs concentration target data, concentration data, liquid level data, upper limit liquid quantity data, and lower limit liquid quantity data. For the liquid level data, two comparators compare the upper limit liquid quantity data and lower limit liquid quantity data. A computer in the concentration and liquid level controller 640Y performs processing on the basis of the flow discussed below, and sends control commands to the various components.

FIG. 36 is a flowchart from the measurement of concentration and liquid level up to deciding on the replenishing amount in an embodiment. First, the concentration sensor 460Y performs measurement (step S11), and the concentration is calculated on the basis of a look-up table (LUT) listing the relation between voltage and concentration, from the output voltage of the concentration sensor 460Y (step S12). Then, the electrostatic capacitance-type liquid level sensor 410Y performs measurement (step S13), and the liquid level is calculated on the basis of a look-up table listing how liquid level is related to voltage and concentration, from the output voltage obtained in step S13 and the concentration value obtained in step S12 (step S14). Finally, the required amount of replenishing liquid is calculated by the concentration and liquid level controller 640Y from the liquid level value obtained in step S14 and the concentration value obtained in step S12, and a decision is made to input to a motor controller (step S15).

Next, the sub-routines in concentration and liquid level control in step S15 will be described in further detail.

In concentration and liquid level control with the invention, a high-concentration developer with a concentration of 35% and a carrier liquid inside the concentration adjustment tank 400Y are added in suitable amounts from the high-concentration developer tank 510 and the carrier liquid tank 520Y, respectively, for the purpose of keeping the concentration and liquid level within a constant range inside the concentration adjustment tank 400Y.

The concentration of the developer has a target value (25%) and a permissible range (±1%) in order to maintain good image quality, and the liquid level has a set lower limit value (70 mm) and upper limit value (130 mm) in order for the developer liquid to be supplied in the amount required for developing, without overflowing from the concentration adjustment tank 400Y. Control is performed so that the target value for liquid level is set in between the upper and lower limit values (100 mm) and so that the concentration and liquid level both meet their target values.

In concentration and liquid level control, the amounts in which the carrier liquid and high-concentration developer are supplied is decided from the difference between the target values and the liquid level and the current concentration measured by the concentration sensor 460Y. However, if the liquid level is greater than the target value, the liquid level cannot meet its target value. Also, since the concentration of the high-concentration developer has a small difference from the concentration target value (25%), it will sometimes be impossible for the concentration and liquid level both to meet their target values. In this case, the supplied amounts of carrier liquid and high-concentration developer are decided so that the concentration is matched to its target value within a range in which the liquid level does not exceed its upper limit value, and the difference between the sheeting conveyance path L and the target value is at its smallest. If the current liquid level is high and will exceed its upper limit value if an attempt is made to match the concentration to its target value, then the supplied amount of high-concentration developer is decided so that the liquid level will not exceed its upper limit and the difference between the concentration and its target value will be small.

As discussed above, control is performed to keep the concentration and liquid level within a constant range, but under certain printing conditions and with certain image data, it is conceivable that the concentration and liquid level may end up deviating from their target ranges.

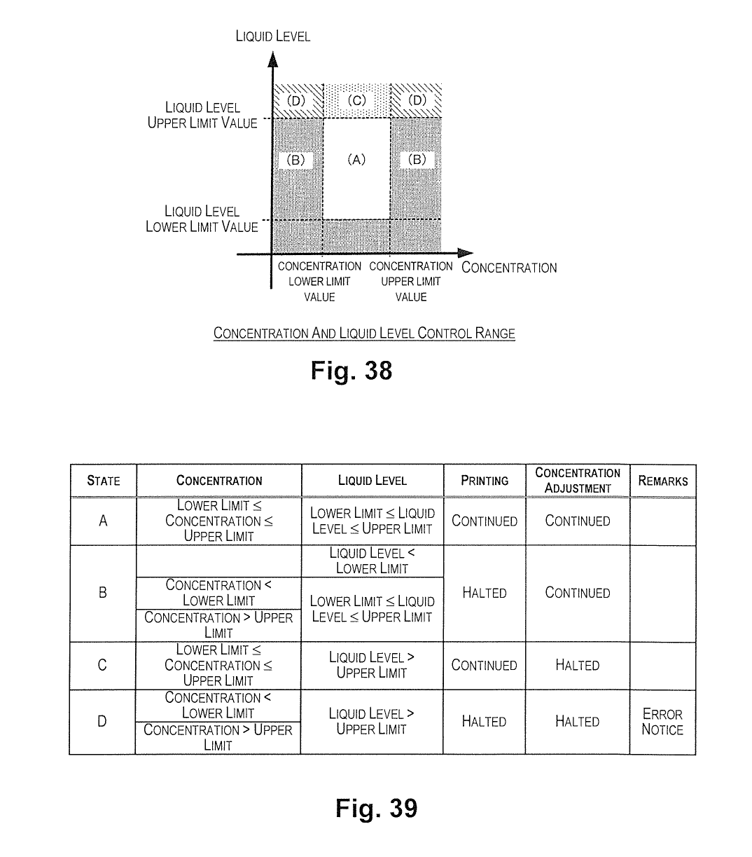

In view of this, overflow from the concentration adjustment tank 400Y, and printing that does not satisfy image quality requirements can be prevented by using the values for concentration and liquid level to determine whether or not to adjust concentration or to print. As shown in FIG. 38, we can classify this into four states, A through D, depending on the values for concentration and liquid level, and the operation is switched as follows in each state.

(A) When the concentration and liquid level are both within their target ranges, ordinary concentration and liquid level control is performed (step S103 to step S106).

(B) When the liquid level drops under its lower limit value step (S108), or when the concentration is outside its target range and the liquid level has not reached its upper limit value (step S107), only control of concentration and liquid level is performed with printing halted, and printing is resumed once the concentration and liquid level return to their target ranges.

(C) When the concentration is within its target range, but the liquid level has exceeded its upper limit value, concentration adjustment is halted and only printing is continued until the concentration is back within its target range (step S110 to step S111).

(D) When the concentration is outside its target range and the liquid level has exceeded its upper limit value, it will be impossible to return the concentration inside the concentration adjusting tank to the desired range, so the entire operation is halted, including printing and concentration adjustment (step S112 to step S115).

The above is compiled in FIG. 39.

With the developing device and image forming device of the invention described above, the liquid level calculator calculates the level of the developer held in the holder 401Y on the basis of the concentration detected by the concentration sensor 460Y and the electrostatic capacitance detected by the electrostatic capacitance-type liquid level sensor 410Y, so accurate liquid level information can be acquired.

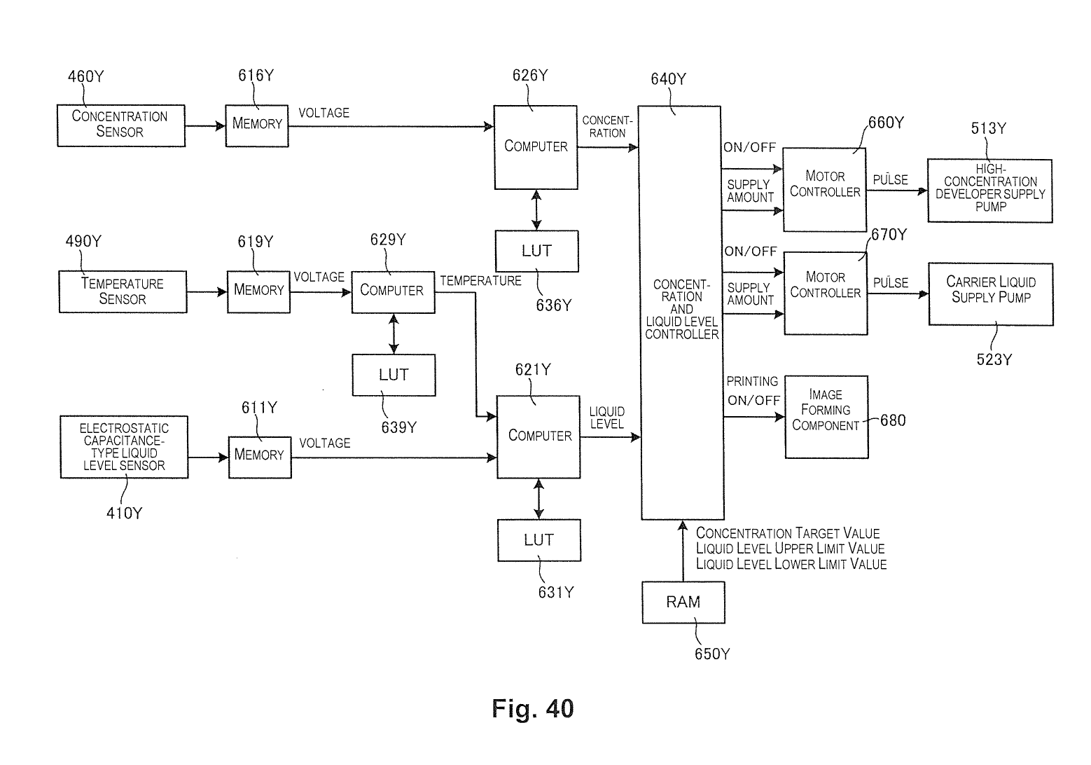

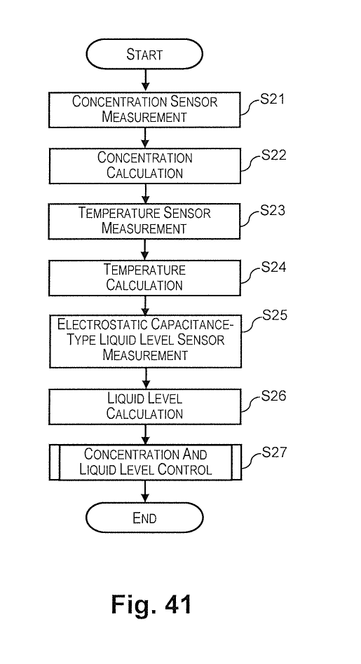

Next, another embodiment of the invention will be described. FIG. 40 is a block diagram illustrating the control of the liquid level in the developing device pertaining to another embodiment of the invention. FIG. 41 is a flowchart from the measurement of concentration and liquid level up to deciding on the replenishing amount in another embodiment.

The output value from the concentration sensor 460Y is temporarily stored in the memory 616Y. The output from the memory 616Y is inputted to the computer 626Y. The computer 626Y calculates the concentration on the basis of a look-up table listing the relation between voltage and concentration. This concentration data is inputted to the concentration and liquid level controller 640Y.

The output value from the temperature sensor 490Y is temporarily stored in a memory 619Y. The output from the memory 619Y is inputted to a computer 629Y. The computer 629Y calculates the temperature on the basis of a look-up table listing the relation between voltage and temperature. This temperature data is inputted to the computer 621Y.

The output value from the electrostatic capacitance-type liquid level sensor 410Y is temporarily stored in the memory 611Y. The output from the memory 611Y is inputted to the computer 621Y. The computer 621Y calculates the liquid level on the basis of a look-up table listing how liquid level is related to voltage and temperature data. This liquid level data is inputted to the concentration and liquid level controller 640Y.

The concentration and liquid level controller 640Y inputs various data from the computer 621Y and the computer 626Y. The concentration and liquid level controller 640Y refers to the RAM 655Y and sends control commands to the motor controller 665Y that actuates the high-concentration developer supply pump 513Y, to the motor controller 675Y that actuates the carrier liquid supply pump 523Y, and to the image forming component 680 that handles image formation, according to this data.

In FIG. 41, first measurement is performed by the concentration sensor 460Y (step S21), and the developer concentration is calculated from the sensor output voltage, on the basis of a look-up table listing the relation between voltage and concentration (step S22). Next, the temperature sensor 490Y performs measurement (step S23), and the developer temperature is calculated from the sensor output voltage, on the basis of a look-up table listing the relation between voltage and temperature (step S24).

Then, the electrostatic capacitance-type liquid level sensor 410Y performs measurement (step S25), and the liquid level is calculated on the basis of a look-up table listing how liquid level is related to voltage and temperature, from the output voltage obtained in step S25 and the temperature obtained in step S24 (step S26). Finally, the required amount of replenishing liquid is calculated by the concentration and liquid level controller from the liquid level value obtained in step S26 and the concentration value obtained in step S22, and a decision is made to input to a motor controller (step S27). Processing by the concentration and liquid level controller is the same as in the previous embodiment.

In the other embodiment discussed above, the level of the developer held in the holder 401Y is determined on the basis of the electrostatic capacitance detected by the electrostatic capacitance-type liquid level sensor 410Y and the temperature detected by the temperature sensor 490Y, so it is possible to acquire accurate liquid level information without the result being affected by temperature changes.

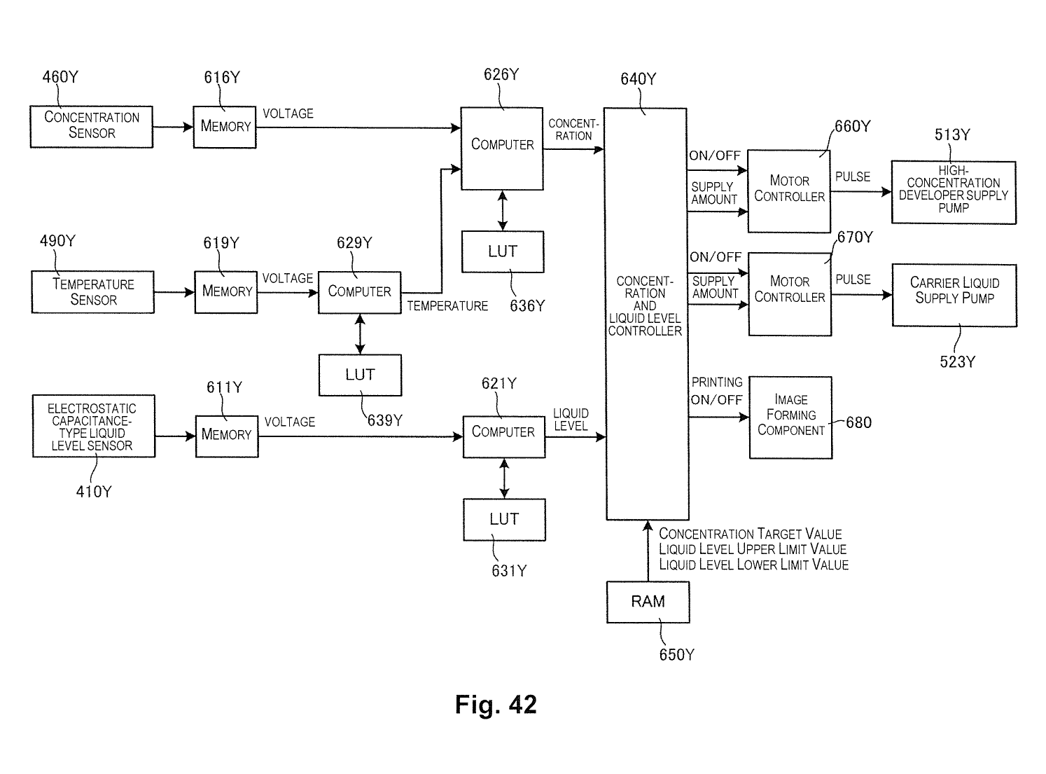

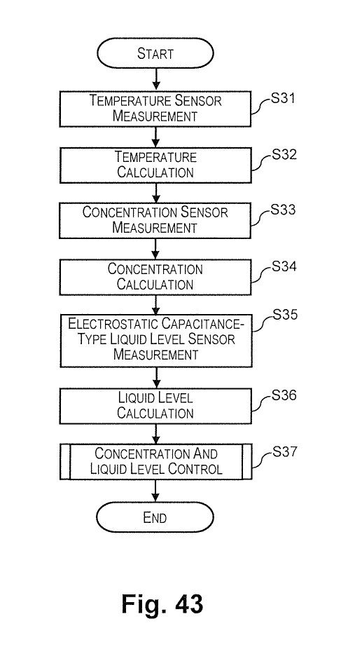

Next, another embodiment of the invention will be described. FIG. 42 is a block diagram illustrating the control of the liquid level in the developing device pertaining to another embodiment of the invention. FIG. 43 is a flowchart from the measurement of concentration and liquid level up to deciding on the replenishing amount in another embodiment.

The output value from the concentration sensor 460Y is temporarily stored in the memory 616Y. The output from the memory 616Y is inputted to the computer 626Y. The computer 626Y calculates the concentration on the basis of a look-up table listing how concentration is related to voltage and temperature. This concentration data is inputted to the concentration and liquid level controller 640Y.

The output value from the temperature sensor 490Y is temporarily stored in the memory 619Y. The output from the memory 619Y is inputted to the computer 629Y. The computer 629Y calculates the temperature on the basis of a look-up table listing the relation between voltage and temperature. This temperature data is inputted to the computer 626Y.

The output value from the electrostatic capacitance-type liquid level sensor 410Y is temporarily stored in the memory 611Y. The output from the memory 611Y is inputted to the computer 621Y. The computer 621Y calculates the liquid level on the basis of a look-up table listing the relation between voltage and liquid level. This liquid level data is inputted to the concentration and liquid level controller 640Y.

The concentration and liquid level controller 640Y inputs various data from the computer 621Y and the computer 626Y. The concentration and liquid level controller 640Y refers to the RAM 655Y and sends control commands to the motor controller 665Y that actuates the high-concentration developer supply pump 513Y, to the motor controller 675Y that actuates the carrier liquid supply pump 523Y, and to the image forming component 680 that handles image formation, according to this data.

In FIG. 43, first measurement is performed by the temperature sensor 490Y (step S31), and the developer temperature is calculated from the sensor output voltage, on the basis of a look-up table listing the relation between voltage and temperature (step S32). Next, the concentration sensor 460Y performs measurement (step S33), and the developer concentration is calculated from the temperature obtained in step S32 and the sensor output voltage obtained in step S33, on the basis of a look-up table listing how concentration is related to voltage and temperature (step S34). Then, the electrostatic capacitance-type liquid level sensor 410Y performs measurement (step S35), and the liquid level is calculated from the sensor output voltage on the basis of a look-up table listing the relation between voltage and liquid level (step S36). Finally, the required amount of replenishing liquid is calculated by the concentration and liquid level controller from the liquid level value obtained in step S36 and the concentration value obtained in step S34, and a decision is made to input to a motor controller (step S37). Processing by the concentration and liquid level controller is the same as in the previous embodiment.

In the other embodiment discussed above, the concentration of the developer held in the holder 401Y is determined by the concentration computer on the basis of the voltage detected by the concentration sensor 460Y and the temperature detected by the temperature sensor 490Y, so it is possible to acquire accurate liquid level information without the result being affected by concentration changes.

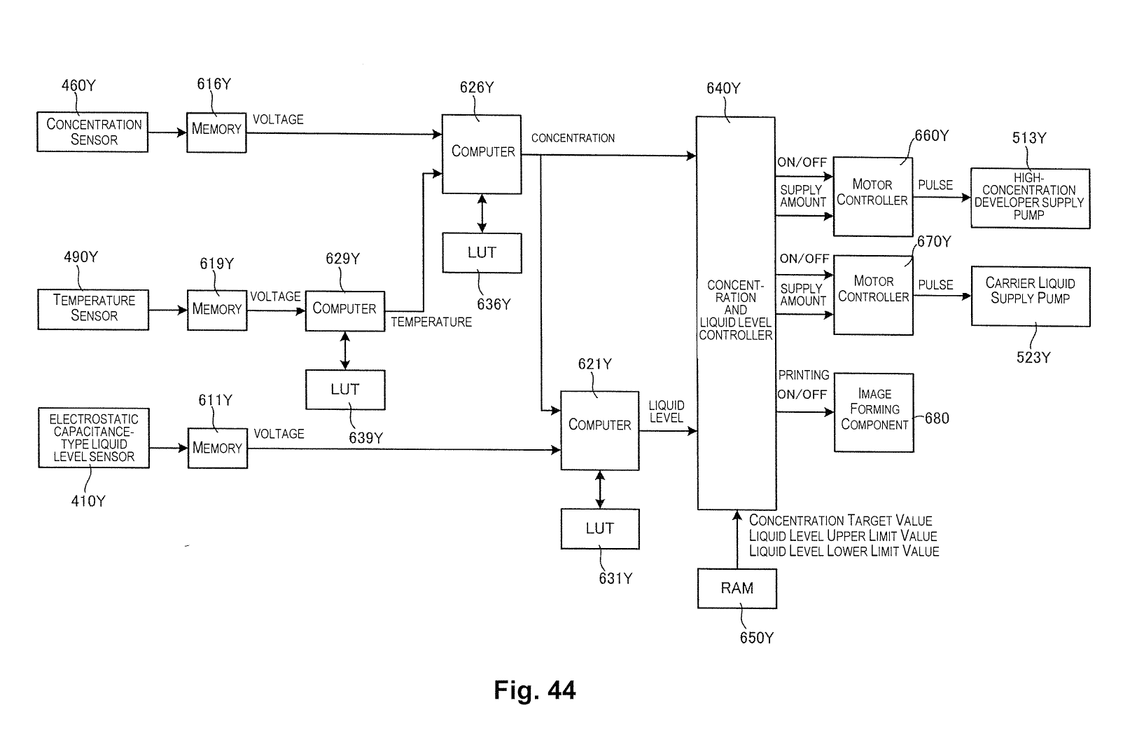

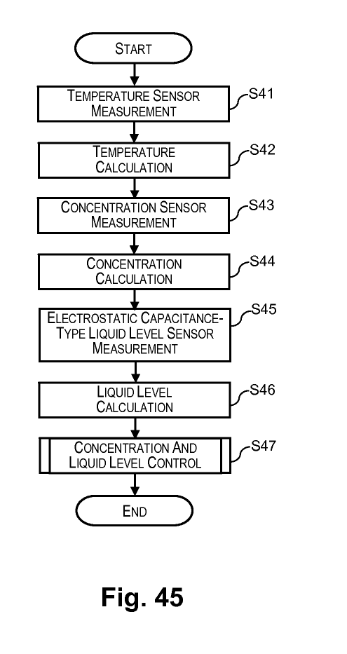

Next, another embodiment of the invention will be described. FIG. 44 is a block diagram illustrating the control of the liquid level in the developing device pertaining to another embodiment of the invention. FIG. 45 is a flowchart from the measurement of concentration and liquid level up to deciding on the replenishing amount in another embodiment.

The output value from the concentration sensor 460Y is temporarily stored in the memory 616Y. The output from the memory 616Y is inputted to the computer 626Y. The computer 626Y calculates the concentration on the basis of a look-up table listing how concentration is related to voltage and temperature data. This concentration data is inputted to the concentration and liquid level controller 640Y.

The output value from the temperature sensor 490Y is temporarily stored in the memory 619Y. The output from the memory 619Y is inputted to the computer 629Y. The computer 629Y calculates the temperature on the basis of a look-up table listing the relation between voltage and temperature. This temperature data is inputted to the computer 626Y.

The output value from the electrostatic capacitance-type liquid level sensor 410Y is temporarily stored in the memory 611Y. The output from the memory 611Y is inputted to the computer 621Y. The computer 621Y calculates the liquid level on the basis of a look-up table listing how liquid level is related to concentration data and voltage. This liquid level data is inputted to the concentration and liquid level controller 640Y.

The concentration and liquid level controller 640Y inputs various data from the computer 621Y and the computer 626Y. The concentration and liquid level controller 640Y refers to the RAM 655Y and sends control commands to the motor controller 665Y that actuates the high-concentration developer supply pump 513Y, to the motor controller 675Y that actuates the carrier liquid supply pump 523Y, and to the image forming component 680 that handles image formation, according to this data.

In FIG. 45, first measurement is performed by the temperature sensor 490Y (step S41), and the developer temperature is calculated from the sensor output voltage, on the basis of a look-up table listing the relation between voltage and temperature (step S42). Next, the concentration sensor 460Y performs measurement (step S43), and the developer concentration is calculated from the temperature obtained in step S42 and the sensor output voltage obtained in step S43, on the basis of a look-up table listing how concentration is related to voltage and temperature (step S44). Then, the electrostatic capacitance-type liquid level sensor 410Y performs measurement (step S45), and the liquid level is calculated from the concentration value obtained in step S44 and the output voltage obtained in step S45, on the basis of a look-up table listing how liquid level is related to voltage and concentration (step S46). Finally, the required amount of replenishing liquid is calculated by the concentration and liquid level controller from the liquid level value obtained in step S46 and the concentration value obtained in step S44, and a decision is made to input to a motor controller (step S47). Processing by the concentration and liquid level controller is the same as in the previous embodiment.

In the embodiment discussed above, the level of the developer held in the holder 401Y is determined by the liquid level calculator on the basis of the electrostatic capacitance detected by the electrostatic capacitance-type liquid level sensor 410Y and the concentration calculate on the basis of the voltage detected by the concentration sensor 460Y and the temperature detected by the temperature sensor 490Y, so it is possible to acquire accurate liquid level information without the result being affected by concentration or temperature changes.

Next, another embodiment of the invention will be described. The following problems are solved in the following embodiment. Since only the presence of a liquid is detected with the technique discussed in Patent Literature 2, sensors have to be provided in a number corresponding to the desired precision in order to ascertain the exact liquid level, which makes the device more complicated, so it is difficult to make the device smaller and lower its price.

With the technique discussed in Patent Literature 3, a level switch senses the upper and lower limits of the liquid surface, and there is not enough resolution when fine concentration adjustment is required. In other words, the problem is that not enough information about the amount of liquid in the tank is obtained for concentration control that minimizes developer waste.

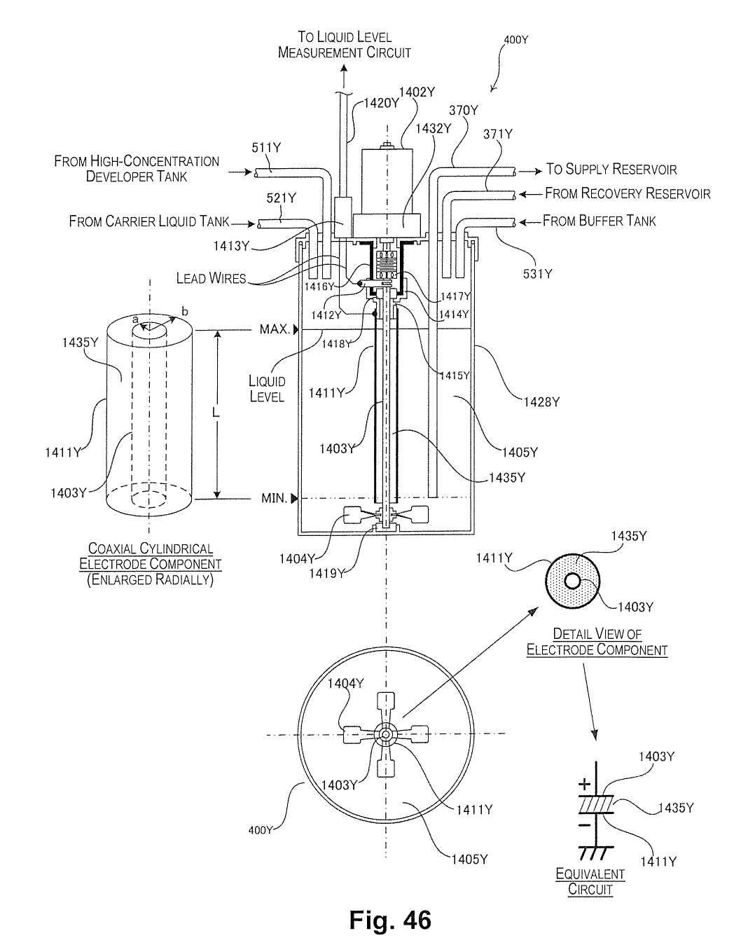

The configuration of the concentration adjustment tank 400Y in this embodiment will now be described in further detail. FIG. 46 is a diagram of the simplified configuration of the concentration adjusting tank in a developing device. The concentration adjustment tank 400Y is used to adjust the developer used in the developing process in the developing device 30Y.

FIG. 46 shows a first example of the concentration adjustment tank 400Y including a liquid level detector according to the invention. A developer recycling system in a printing device for a liquid developing type of electronic photography has a liquid developer recycling device for each of the four developers used for YMCK colors. FIG. 46 shows the configuration of the concentration adjustment tank 400Y that performs toner concentration adjustment and is the main component of one of these recycling devices (yellow). The configuration is simplified by disposing an electrostatic capacitance sensor at the center of the developer stirring shaft. For example, the diameter of the tank can be reduced from 80 mm to about 50 mm.

A developer stirring motor 1402Y is attached to the upper part of the concentration adjustment tank 400Y, and a developer stirring shaft/internal electrode 1403Y and a developer stirring blade 1404Y are linked to this. A step-down gearbox 1432Y is attached to the developer stirring motor 1402Y.

In this drawing, the concentration adjustment tank 400Y is filled with developer 1405Y up to the “MAX.” position indicating the liquid level. A state in which this liquid level has decreased to the “MIN.” position is indicated by a two-dot chain line.

At the upper part of the concentration adjustment tank 400Y, high-concentration developer is introduced as needed from the high-concentration developer tank 510 through the high-concentration developer supply pipe 511Y in order to adjust the level of the developer and the toner concentration of the developer. Similarly, carrier liquid is introduced as needed from the carrier liquid tank 520Y through the carrier liquid supply pipe 521Y in order to adjust the level of the liquid level and the toner concentration of the developer.

Although not depicted in this drawing, toner whose concentration has been adjusted in the concentration adjustment tank 400Y goes through the developer supply pipe 370Y and is sent to the supply reservoir 310Y in FIG. 2. The developing toner liquid that is not used is returned from the recovery reservoir 320Y, through the developer recovery pipe 371Y, to the concentration adjustment tank 400Y.

Next, the sensor component for detecting the developer level pertaining to the invention forms a capacitor including the developer stirring shaft/internal electrode 1403Y, liquid-level-measurement-area developer 1435Y, and an external electrode (ground electrode) 1411Y. That is, the developer stirring shaft/internal electrode 1403Y serves as the positive electrode, the liquid-level-measurement-area developer 1435Y serves as the electrolytic solution, and the external electrode (ground electrode) 1411Y serves as the negative electrode. The liquid-level-measurement-area developer 1435Y is such that the developer 1405Y is the developer in the area partitioned off by the external electrode (ground electrode) 1411Y, and the partitioned liquid levels are maintained in equilibrium by a vent hole 1415Y. The external electrode (ground electrode) 1411Y is supported by an external electrode insulated support 1414Y, and the external electrode insulated support 1414Y is supported by a developer stirring shaft support 1416Y.

The Claims are expressed by calling the cylindrical external electrode (ground electrode) 1411Y the “first electrode,” and calling the developer stirring shaft/internal electrode 1403Y that is disposed around the inside of the cylindrical external electrode (ground electrode) 1411Y the “second electrode.”

A universal joint 1417Y serves to electrically insulate the stirring shaft from the output driveshaft of the step-down gearbox 1432Y, and is made from plastic or another such insulating material. Another insulation method is to use plastic for the gears and bearings inside the step-down gearbox. A developer stirring shaft upper bearing 1418Y and a developer stirring shaft lower bearing 1419Y are rotary bearings for the developer stirring shaft/internal electrode 1403Y.

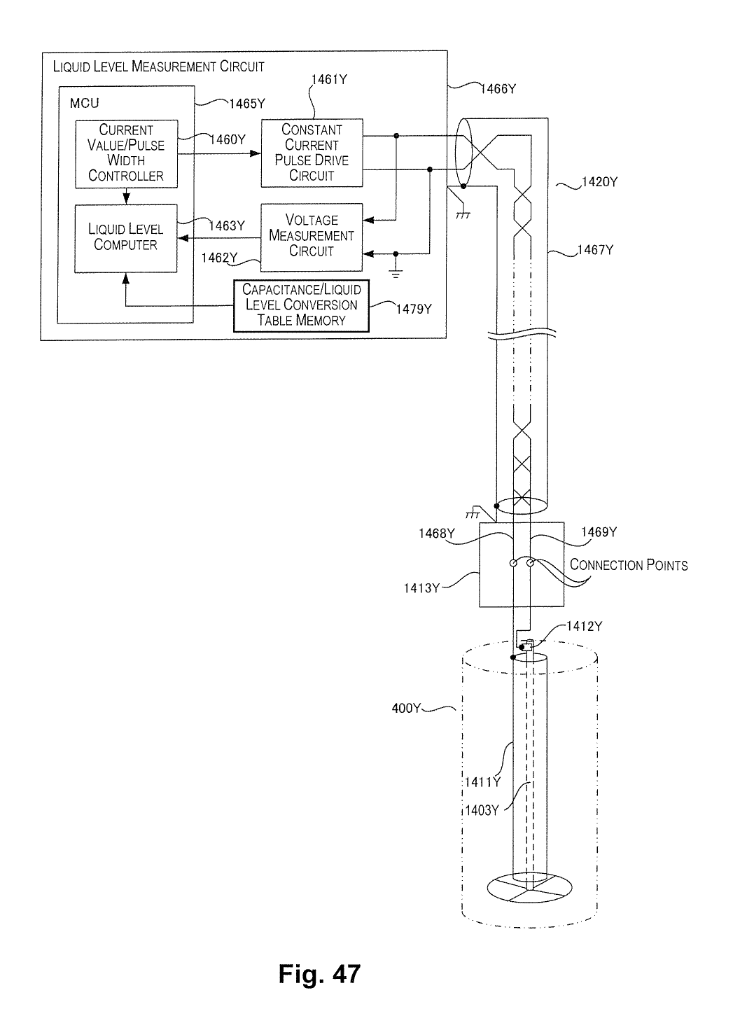

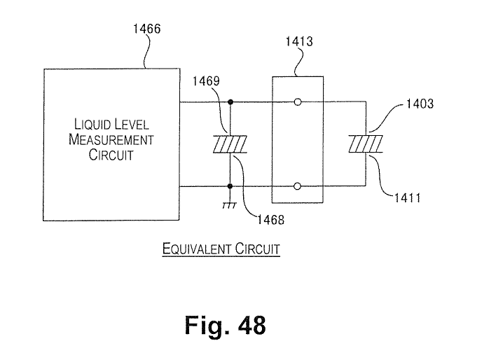

An external electrode contact 1412Y maintains contact with the rotating developer stirring shaft/internal electrode 1403Y, and is part of the wiring path that links the developer stirring shaft/internal electrode 1403Y to a liquid level sensor connector 1413Y. The external electrode (ground electrode) 1411Y, which is the other electrode, is also linked to the liquid level sensor connector 1413Y by electrical wiring (a lead wire). The liquid level sensor connector 1413Y is connected to the liquid level measurement component 1466Y shown in FIGS. 47 and 48 by a liquid level measurement harness 1420Y.

The coaxial cylindrical electrode component shown on the middle left in FIG. 46 is drawn so as to facilitate an understanding of the configuration of the developer stirring shaft/internal electrode 1403Y, the liquid-level-measurement-area toner 1435Y, and the external electrode (ground electrode) 1411Y, which serve as a capacitor that is a liquid level sensor in the concentration adjustment tank 400Y. The electrostatic capacitance between these coaxial cylindrical electrodes is expressed by the following formula (7).

C=2π∈L/log(b/a)[F] (7)

Where:

C is the capacitance within the liquid level measurement area [F],

∈ is the dielectric constant [F/m],

L is the liquid level height [m],

a is the internal radius [m],

b is the external radius [m], and

log is a natural logarithm.

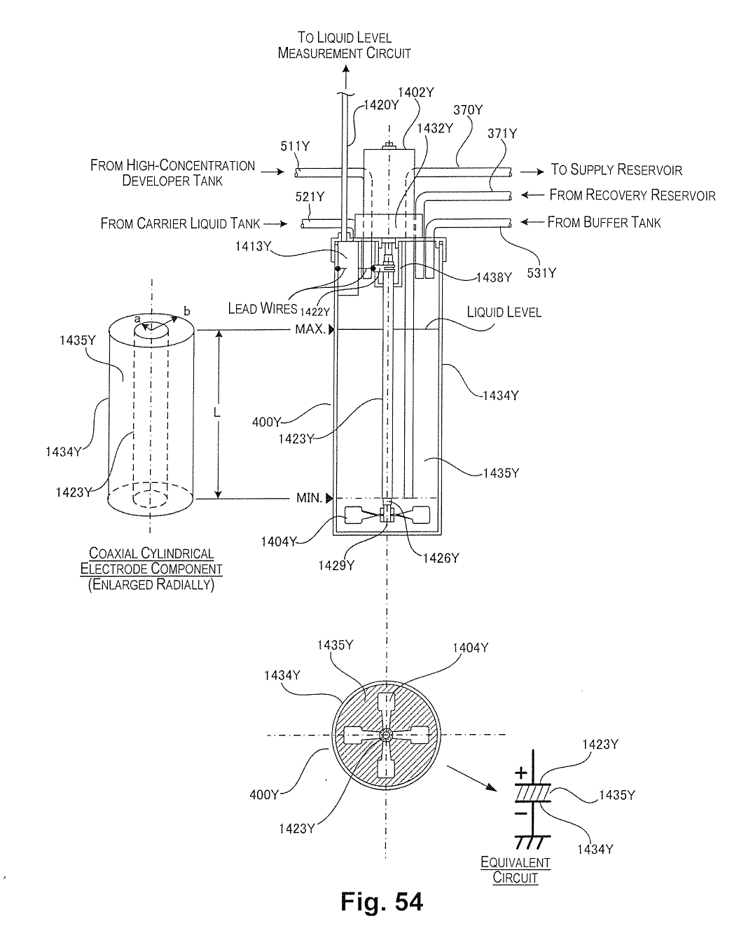

Let us touch upon the configuration of the electrodes. If there is no need to make the device more lightweight and to provide a way to see how much capacitance remains, then the external electrode (ground electrode) 1411Y may be such that the concentration adjustment tank 400Y is made of stainless steel or another such conductive material, and this is used as an external electrode. This will be discussed in detail through reference to FIG. 54.

Also, with the invention, a case in which the developer is non-conductive is discussed, but if the developer is conductive, there will be a state close to short-circuiting between the electrodes, so the electrode surface must be coated with Teflon or another such insulating substance.

FIG. 47 is an overall block diagram of the liquid level detection device used in the developing device pertaining to an embodiment of the invention.

FIG. 47 is a rendering of the overall liquid level detection device, based on the configuration around the concentration adjustment tank 400Y, and this can be broadly broken down into the liquid level measurement circuit 1466, the concentration adjustment tank 400Y (liquid level sensor), a liquid level sensor connector 1413Y, and the liquid level measurement harness 1420Y.

A liquid level detecting sensor takes a change in toner liquid level as a change in electrostatic capacitance, using the developer stirring shaft/internal electrode 1403Y and the external electrode (ground electrode) 1411Y. The liquid level sensor connector 1413Y is used to connect the external electrode (ground electrode) 1411Y to the developer stirring shaft/internal electrode 1403Y constituting a cylindrical electrostatic capacitance sensor.

A shield cover 1467Y prevents an external electrode cable 1468Y and an internal electrode cable 1469Y from being affected by surrounding noise.

Next, the function and operation of the liquid level measurement circuit 1466Y will be described. A constant current pulse drive circuit 1461Y imparts an indicated pulse width and current value from a current value/pulse width controller 1460Y of the liquid level measurement circuit 1466Y to the constant current pulse drive circuit 1461Y, and the constant current pulse drive circuit 1461Y outputs a specific constant current pulse to the liquid level sensor. A voltage measurement circuit 1462Y measures the voltage generated at the liquid level sensor at this point, and passes it on to a liquid level computer 1463Y. The calculated electrostatic capacitance is converted into a liquid level value by referring to table values in a capacitance/liquid level conversion table memory 1479Y and calculating a liquid level value.

FIG. 48 is a diagram illustrating the method for measuring the wiring capacity of a liquid level measurement harness.

The electrostatic capacitance value for the liquid level sensor described through reference to FIG. 47 includes the line capacitance between the external electrode cable 1468Y and the internal electrode cable 1469Y, so this line capacitance must be subtracted. The method for doing this is illustrated in FIG. 48.

First, let us establish the following definitions.

CA=(line capacitance between the external electrode cable 1468Y and the internal electrode cable 1469Y from the liquid level measurement circuit 1466Y to the liquid level sensor connector 1413Y)

CB=(line capacitance between the external electrode cable 1468Y and the internal electrode cable 1469Y+electrostatic capacitance value of a liquid level sensor including the developer stirring shaft/internal electrode 1403Y and the external electrode 1411Y)

CC=(electrostatic capacitance value of a liquid level sensor including the developer stirring shaft/internal electrode 1403Y and the external electrode 1411Y)

For CA, a previously measured value shall be used. CB is electrostatic capacitance values measured successively in the adjustment of the concentration of the developer. Therefore, the following equation is used to find the electrostatic capacitance CC of the liquid level sensor.

CC=CA−CB

Since this line capacitance can be ignored if the external electrode cable 1468Y and the internal electrode cable 1469Y are made as short as possible, this problem is solved if the liquid level measurement circuit 1466Y is disposed very near the liquid level sensor, so this is another solution. More specifically, the liquid level measurement circuit 1466Y ends up being put inside the liquid level sensor connector 1413Y.

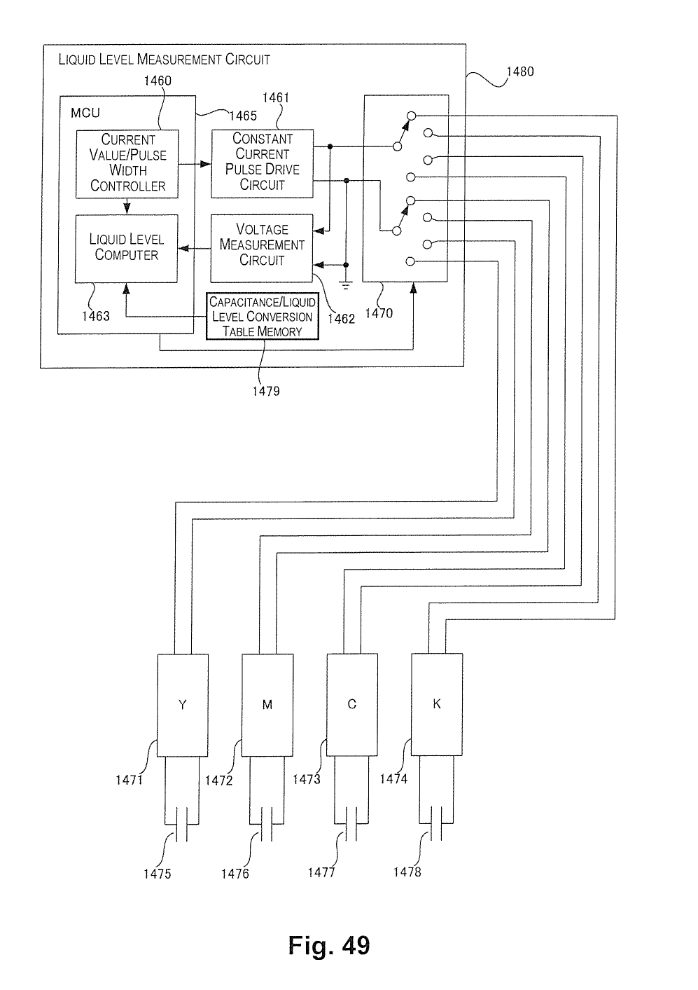

As shown in FIG. 49, when the developer system involves multiple colors, liquid level sensors are needed for the four colors of YMCK. Because of the need to make the device smaller, reduce its cost, and so forth, the above-mentioned processing can be performed premised on device configuration shown in FIG. 49 and described below, using the liquid level measurement circuit 1466Y as one of these.

FIG. 49 shows the configuration in which four-color (YMCK) liquid level detection devices share a liquid level measurement circuit. As mentioned regarding FIG. 48, FIG. 49 shows the overall configuration of a liquid level measurement device when there are four colors (YMCK), a liquid level measurement circuit 1480 is one of these, and liquid level sensors of four colors (YMCK) are disposed.

The function and operation of the liquid level measurement circuit 1480 illustrated in FIG. 49 will not be described. The liquid level measurement circuit 1480 measures the electrostatic capacitance for each of a yellow liquid level sensor 1475, a magenta liquid level sensor 1476, a cyan liquid level sensor 1477, and a black liquid level sensor 1478, while controlling a liquid level sensor switching circuit 1470 from a micro-control unit 1465 and thereby switching the measurement point. Values measured in advance at the part level as discussed above are used for the line capacitance between a yellow joint box 1471, a magenta joint box 1472, a cyan joint box 1473, and a black joint box 1474 from the liquid level measurement circuit 1480 in order to find the true electrostatic capacitance values for the liquid level sensors. This allows the capacitance values for the liquid level sensors of the four colors (YMCK) and of different wiring lengths to be measured accurately.

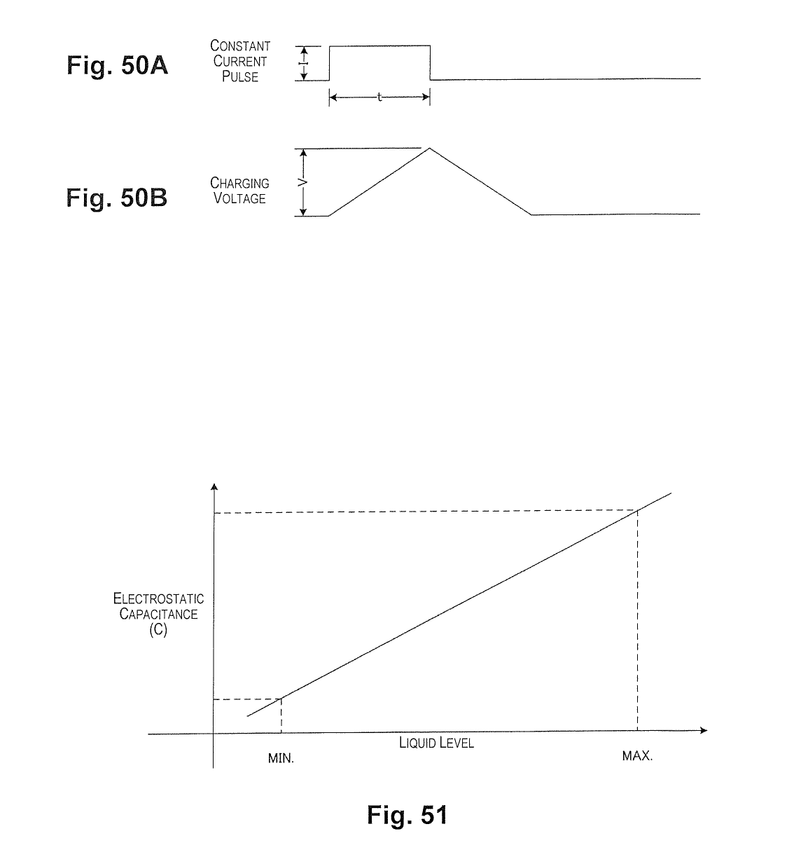

Next, the method for measuring the electrostatic capacitance of the liquid level sensors used in the developing device pertaining to this embodiment will be described. FIG. 50 illustrates an electrostatic capacitance measurement method.

With the liquid level sensors used in the developing device pertaining to this embodiment, the electrostatic capacitance between electrodes is found using the following formula (8) by measuring the voltage (FIG. 50B) when the constant current pulse shown in FIG. 50A is imparted for a specific length of time between the capacitor electrodes shown in FIGS. 47, 48, and 49.

C=It/V (8)

The relation between electrostatic capacitance and liquid level is found by making a table of pre-measured relations between capacitance and liquid level, storing this data in a memory inside the liquid level measurement circuit, and using the data during liquid level computation.

A method involving the voltage and the charging time of a capacitor using a constant current as discussed above was used in the invention as the method for finding the electrostatic capacitance, but it is also possible to use a method in which frequency characteristics are used to find the electrostatic capacitance.

FIG. 51 illustrates the relation between liquid level and electrostatic capacitance. FIG. 51 is a graph of the relation between electrostatic capacitance and liquid level between electrodes, found by the liquid level measurement method illustrated in FIG. 50.

With the developing device and image forming device of the invention as discussed above, it is possible to ascertain the liquid level by detecting the electrostatic capacitance between the external electrode (ground electrode, first electrode) 1411Y and the developer stirring shaft/internal electrode (second electrode) 1403Y, so there is no need to provide a plurality of sensors, and the device can be more compact and lower in price. Also, with the developing device and image forming device of the invention, since the liquid level can be accurately ascertained by detecting the electrostatic capacitance between the external electrode (ground electrode, first electrode) 1411Y and the developer stirring shaft/internal electrode (second electrode) 1403Y, the concentration of the developer held in the holder can be properly controlled.

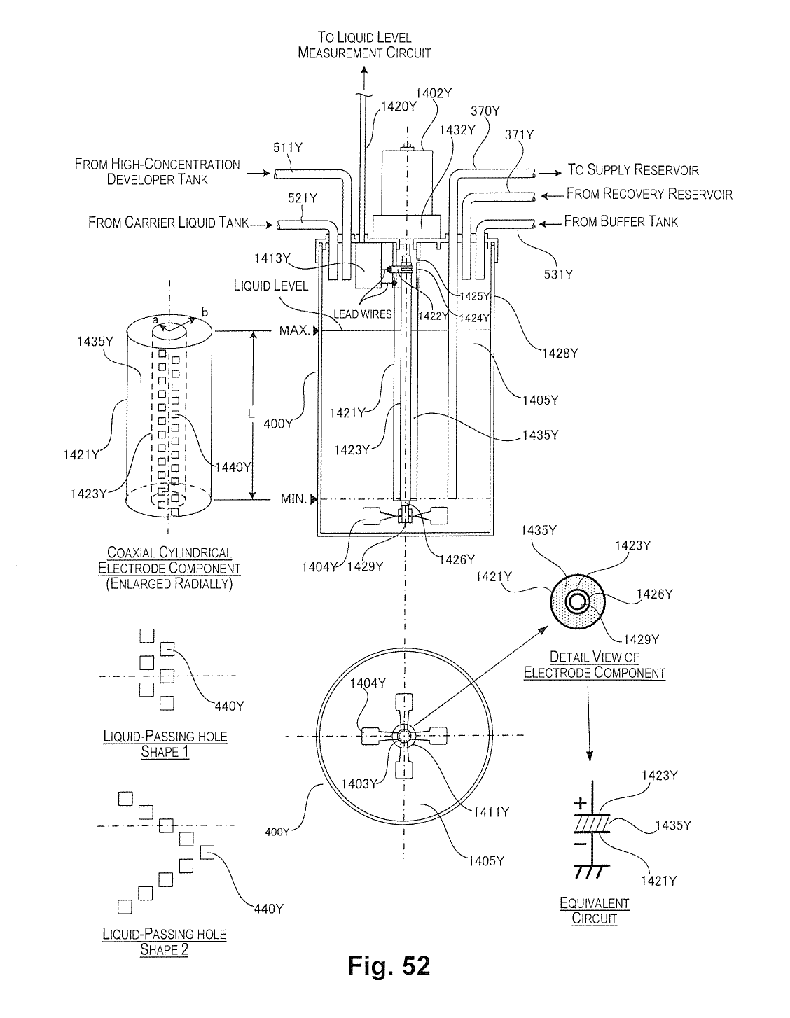

Next, another embodiment of the invention will be described. This other embodiment differs from the previous embodiment only in the configuration of the concentration adjustment tank 400Y, so just this point will be described below. FIG. 52 shows the simplified configuration of the concentration adjusting tank 400Y in the developing device pertaining to another embodiment

FIG. 52 shows a configuration example of a developer stirring tank containing the toner liquid level detector pertaining to another embodiment. In this embodiment, the method for measuring the electrostatic capacitance using a stirring shaft is realized by a different configuration from that in FIG. 46.

A developer recycling system in a printing device for a liquid developing type of electronic photography has a toner recycling device for each of the four toners used for YMCK colors. FIG. 52 shows the configuration of the developer stirring tank that is used to perform toner concentration adjustment and is the main component of one of these recycling devices. The configuration is simplified by disposing an electrostatic capacitance sensor at the center of the developer stirring shaft. For example, the diameter of the tank can be reduced from 80 mm to about 50 mm.

The developer stirring motor 1402Y is attached at the upper part of the concentration adjustment tank 400Y, and a developer stirring geared motor shaft 1429Y and the developer stirring blade 1404Y are linked to this. The step-down gearbox 1432Y is attached to the developer stirring motor.

In this drawing, the concentration adjustment tank 400Y is filled with developer 1405Y up to the “MAX.” position indicating the liquid level. A state in which this liquid level has decreased to the “MIN.” position is indicated by a two-dot chain line.

At the upper part of the concentration adjustment tank 400Y, high-concentration developer is introduced as needed from the high-concentration developer tank 510 through the high-concentration developer supply pipe 511Y in order to adjust the level of the developer and the toner concentration of the developer. Similarly, carrier liquid is introduced as needed from the carrier liquid tank 520Y through the carrier liquid supply pipe 521Y in order to adjust the level of the developer and the toner concentration of the developer. Although not depicted in this drawing, used developer recovered from the developer roller or the photoreceptor drum is collected in the buffer tank 530Y, and this used developer is supplied as needed through the recycled developer supply pipe 531Y to the concentration adjustment tank 400Y, as shown in FIGS. 1 and 2.

Although not depicted in this drawing, toner whose concentration has been adjusted in the concentration adjustment tank 400Y goes through the developer supply pipe 370Y and is sent to the supply reservoir 310Y in FIG. 2. The developing toner liquid that was not used is returned from the recovery reservoir 320Y, through the developer recovery pipe 371Y, to the concentration adjustment tank 400Y.

Next, the sensor for detecting the toner liquid level pertaining to the invention forms a capacitor including an internal electrode 1423Y, the liquid-level-measurement-area developer 1435Y, and an external electrode (ground electrode) 1421Y. That is, the internal electrode 1423Y serves as the positive electrode, the liquid-level-measurement-area developer 1435Y serves as the electrolytic solution, and the external electrode (ground electrode) 1421Y serves as the negative electrode. The liquid-level-measurement-area developer 1435Y is such that the developer 1405Y is the developer in the area partitioned off by the external electrode (ground electrode) 1421Y, and the partitioned liquid levels are maintained in equilibrium by a vent hole 1425Y. The external electrode (ground electrode) 1421Y is supported by an external electrode insulated support 1424Y.

An internal electrode insulating layer 1426Y is provided around the outer peripheral part of the axis of the developer stirring geared motor shaft 1429Y, and the internal electrode 1423Y is formed over the outer periphery thereof. An external electrode contact 1422Y maintains contact with the internal electrode 1423Y around the rotating developer stirring geared motor shaft 1429Y, and is part of the wiring path linking the internal electrode 1423Y to the liquid level sensor connector 1413Y. The external electrode (ground electrode) 1421Y, which is the other electrode, is also linked to the liquid level sensor connector 1413Y by electrical wiring (a lead wire). The liquid level sensor connector 1413Y is connected by the liquid level measurement harness 1420Y to the liquid level measurement component 1466Y shown in FIGS. 47 and 48.

The electrode configuration discussed above is not the only possibility. One method for insulating the developer stirring geared motor shaft 1429Y and the shaft of the developer stirring motor 1402Y is to simplify the structure using plastic for the bearings and gears inside the step-down gearbox.

The coaxial cylindrical electrode component shown on the middle left in FIG. 52 is drawn so as to facilitate an understanding of the configuration of the internal electrode 1423Y, the liquid-level-measurement-area toner 1435Y, and the external electrode (ground electrode) 1421Y, which serve as a capacitor that is a liquid level sensor in the concentration adjustment tank 400Y. The electrostatic capacitance between these coaxial cylindrical electrodes is expressed by the following formula (10).

C=2π∈L/log(b/a)[F] (10)

Where:

C is the capacitance within the liquid level measurement area [F],

∈ is the dielectric constant [F/m],

L is the liquid level height [m],

a is the internal radius [m],

b is the external radius [m], and

log is a natural logarithm.

Liquid-passing holes 1440Y in the coaxial cylindrical electrodes in the center left of FIG. 52 are liquid-passing openings that prevent a concentration difference between the developer 1405Y in the concentration adjustment tank 400Y and the liquid-level-measurement-area developer 1435Y surrounded by the external electrode (ground electrode) 1421Y. The layout of the liquid-passing holes 1440Y is determined so that the length of the openings cut out around the periphery will be constant in any cross section perpendicular to the axis of the cylinder, as shown by liquid communicating opening shapes 1 and 2 in FIG. 52.

With the developing device and image forming device of the invention as discussed above, it is possible to ascertain the liquid level by detecting the electrostatic capacitance between the external electrode (first electrode) 1421Y and the internal electrode (second electrode) 1423Y, so there is no need to provide a plurality of sensors, and the device can be more compact and lower in price. Also, with the developing device and image forming device of the invention, since the liquid level can be accurately ascertained by detecting the electrostatic capacitance between the external electrode (first electrode) 1411Y and the internal electrode (second electrode) 1423Y, the concentration of the developer held in the holder can be properly controlled.

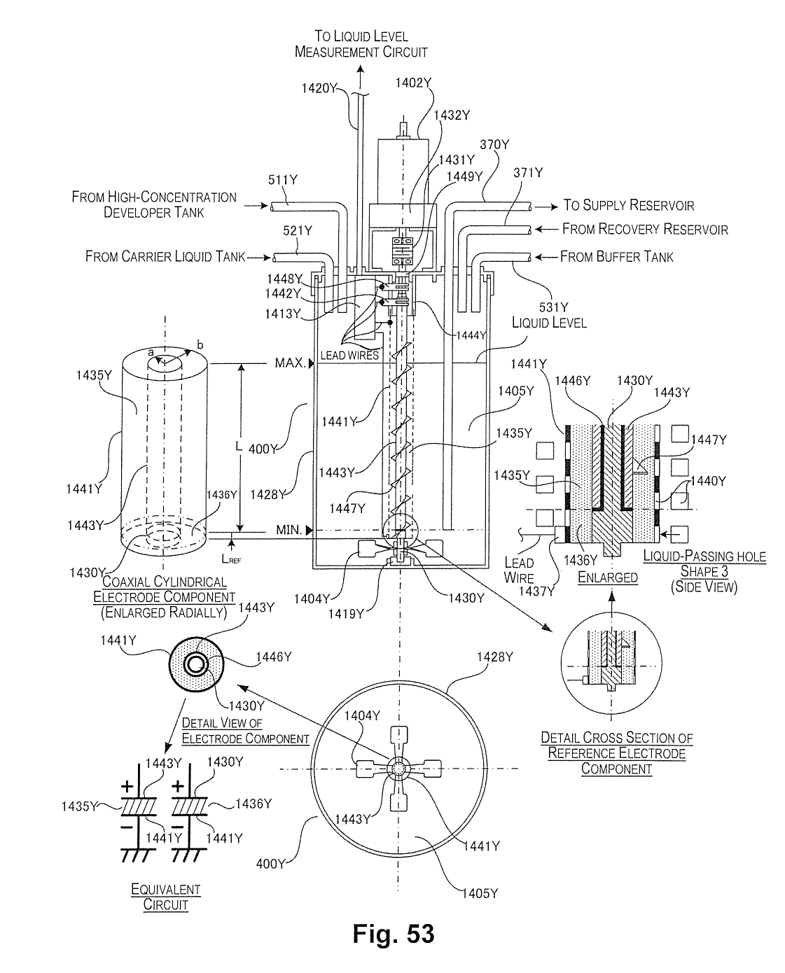

Next, another embodiment of the invention will be described. This other embodiment differs from the embodiments described up to now only in the configuration of the concentration adjustment tank 400Y, so just this point will be described below. FIG. 53 shows the simplified configuration of the concentration adjusting tank 400Y in the developing device pertaining to another embodiment.

FIG. 53 shows a configuration example of a developer stirring tank containing the toner concentration/liquid level detector pertaining to another embodiment. In this example, a measurement method that is not affected by the concentration or temperature of the developer is realized by measuring the electrostatic capacitance of a fixed region predetermined as a reference in the detection of the liquid level by electrostatic capacitance method.

A developer recycling system in a printing device for a liquid developing type of electronic photography has a toner recycling device for each of the four toners used for YMCK colors. FIG. 53 shows the configuration of the developer stirring tank that is used to perform toner concentration adjustment and is the main component of one of these recycling devices. The configuration is simplified by disposing an electrostatic capacitance sensor at the center of the developer stirring shaft. For example, the diameter of the tank can be reduced from 80 mm to about 50 mm.

The developer stirring motor 1402Y is attached at the upper part of the concentration adjustment tank 400Y, and a developer stirring shaft/reference electrode 1430Y and the developer stirring blade 1404Y are linked to this. The step-down gearbox 1432Y is attached to the developer stirring motor.

In this drawing, the concentration adjustment tank 400Y is filled with developer 1405Y up to the “MAX.” position indicating the liquid level. A state in which this liquid level has decreased to the “MIN.” position is indicated by a two-dot chain line.

At the upper part of the concentration adjustment tank 400Y, high-concentration developer is introduced as needed from the high-concentration developer tank 510 through the high-concentration developer supply pipe 511Y in order to adjust the level of the developer and the toner concentration of the developer. Similarly, carrier liquid is introduced as needed from the carrier liquid tank 520Y through the carrier liquid supply pipe 521Y in order to adjust the level of the developer and the toner concentration of the developer. Although not depicted in this drawing, used developer recovered from the developer roller or the photoreceptor drum is collected in the buffer tank 530Y, and this used developer is supplied as needed through the recycled developer supply pipe 531Y to the concentration adjustment tank 400Y, as shown in FIGS. 1 and 2.

Although not depicted in this drawing, toner whose concentration has been adjusted in the concentration adjustment tank 400Y goes through the developer supply pipe 370Y and is sent to the supply reservoir 310Y in FIG. 2. The developing toner liquid that was not used is returned from the recovery reservoir 320Y, through the developer recovery pipe 371Y, to the concentration adjustment tank 400Y.

Next, the sensor for detecting the toner concentration and toner liquid level pertaining to the invention forms a capacitor including an internal electrode 1443Y, the liquid-level-measurement-area developer 1435Y, and an external electrode (ground electrode) 1441Y. That is, the internal electrode 1443Y serves as the positive electrode, the liquid-level-measurement-area developer 1435Y serves as the electrolytic solution, and the external electrode (ground electrode) 1441Y serves as the negative electrode. The liquid-level-measurement-area developer 1435Y is such that the developer 1405Y is the developer in the area partitioned off by the external electrode (ground electrode) 1441Y, and the partitioned liquid levels are maintained in equilibrium by a vent hole 1445Y. The external electrode (ground electrode) 1441Y is supported by an external electrode insulated support 1444Y.

A universal joint 1431Y serves to electrically insulate the stirring shaft from the motor shaft, and is made from plastic or another such insulating material. A developer stirring shaft upper bearing 1449Y and the developer stirring shaft lower bearing 1419Y are rotary bearings for the internal electrode 1443Y.

An external electrode contact 1442Y maintains electrical conduction with the rotating internal electrode 1443Y, and is part of the wiring path that links the internal electrode 1443Y to the liquid level sensor connector 1413Y. The external electrode (ground electrode) 1441Y, which is the other electrode, is also linked to the liquid level sensor connector 1413Y by electrical wiring (a lead wire). The liquid level sensor connector 1413Y is connected to a liquid level measurement component (not shown) by the liquid level measurement harness 1420Y.

A developer stirring shaft/reference electrode contact 1448Y maintains electrical conduction with the rotating developer stirring shaft/reference electrode 1430Y, and is part of the wiring path that links the developer stirring shaft/reference electrode 1430Y to the liquid level sensor connector 1413Y. The external electrode (ground electrode) 1441Y, which is the other electrode, is also linked to the liquid level sensor connector 1413Y by electrical wiring (a lead wire).

The liquid-passing holes 1440Y of the liquid communicating opening shape 3 in the detail diagram of the lower part of the electrode in FIG. 53 provide liquid-passing openings that prevent a concentration difference between the developer 1405Y in the concentration adjustment tank 400Y and the liquid-level-measurement-area developer 1435Y surrounded by the external electrode (ground electrode) 1421Y. The layout of the liquid-passing holes 1440Y is determined so that the length of the openings cut out around the periphery will be constant in any cross section perpendicular to the axis of the cylinder, as shown in this drawing.

Further, measurement component developer stirring blades 1447Y are stirring blades for providing a uniform concentration of the liquid-level-measurement-area developer 1435Y flowing between the internal electrode 1443Y and the external electrode (ground electrode) 1441Y. The developer 1405Y in the concentration adjustment tank 400Y and the liquid-level-measurement-area toner 1435Y are stirred by the measurement component developer stirring blades 1447Y, and are mixed via liquid communicating holes 440Y.

The coaxial cylindrical electrode component shown on the middle left in FIG. 53 is drawn so as to facilitate an understanding of the configuration of the internal electrode 1443Y, the liquid-level-measurement-area toner 1435Y, and the external electrode (ground electrode) 1441Y, which serve as a capacitor that is a liquid level sensor in the concentration adjustment tank 400Y. The electrostatic capacitance between these coaxial cylindrical electrodes is expressed by the following formula (11).

C=2π∈L/log(b/a)[F] (11)

Where:

C is the capacitance within the liquid level measurement area [F],

∈ is the dielectric constant [F/m],

L is the liquid level height [m],

a is the internal radius [m],

b is the external radius [m], and

log is a natural logarithm.

The lower part of the coaxial cylindrical electrode component shown on the middle left in FIG. 53 shows the configuration of the developer stirring shaft/reference electrode 1430Y, a liquid-developer-measurement-area 1436Y, and the external electrode (ground electrode) 1441Y, which serve as a reference capacitor during liquid level measurement. The electrostatic capacitance between these coaxial cylindrical lower electrodes is expressed by the following formula.

C_{REF}=2π∈L_{REF}/log(b/a)[F]

C_{REF}: capacitance within the reference measurement area [F]

L_{REF}: height of reference part [m]

In view of this, if C_{REF} has an accuracy of 10±0.1 mm, the liquid level that is found will be as in the following formula (12).

L=C/C_{REF[}±0.1 mm] (12)

In the above, a measurement method that is not affected by the concentration or temperature of the developer is realized by measuring the electrostatic capacitance of a fixed region predetermined as a reference in the detection of the liquid level by electrostatic capacitance method, but it is also possible to actually measure the relation between dielectric constant and concentration ahead of time and make a table of calibration curve data, and measure the electrostatic capacitance in the reference capacitance measurement area.

With the developing device and image forming device of the invention as described above, since the liquid level can be ascertained by detecting the electrostatic capacitance between the external electrode (first electrode) 1441Y and the internal electrode (second electrode) 1443Y, there is no need to provide a plurality of sensors, and the device can be more compact and lower in price. Also, with the developing device and image forming device of the invention, since the liquid level can be accurately ascertained by detecting the electrostatic capacitance between the external electrode (first electrode) 1441Y and the internal electrode (second electrode) 1443Y, the concentration of the developer held in the holder can be properly controlled.

Next, another embodiment of the invention will be described. This other embodiment differs from the embodiments described up to now only in the configuration of the concentration adjustment tank 400Y, so just this point will be described below. FIG. 54 shows the simplified configuration of the concentration adjusting tank 400Y in the developing device pertaining to another embodiment.

FIG. 54 shows a configuration example of a developer stirring tank containing the toner liquid level detector pertaining to another embodiment. In this other embodiment, the method for measuring the electrostatic capacitance using a developer stirring tank lower case 434Y as an external electrode is realized by further simplifying the developer stirring tank with a different configuration from that in FIG. 52.

A developer recycling system in a printing device for a liquid developing type of electronic photography has a toner recycling device for each of the four toners used for YMCK colors. FIG. 54 shows the configuration of the developer stirring tank that is used to perform toner concentration adjustment and is the main component of one of these recycling devices. The configuration is simplified by disposing an electrostatic capacitance sensor at the center of the developer stirring shaft. For example, the diameter of the tank can be reduced from 80 mm to about 50 mm. The developer stirring motor 1402Y is attached at the upper part of the concentration adjustment tank 400Y, and a developer stirring geared motor shaft 1429Y and the developer stirring blade 1404Y are linked to this. The step-down gearbox 1432Y is attached to the developer stirring motor.

In this drawing, the concentration adjustment tank 400Y is filled with developer 1405Y up to the “MAX.” position indicating the liquid level. A state in which this liquid level has decreased to the “MIN.” position is indicated by a two-dot chain line.

At the upper part of the concentration adjustment tank 400Y, high-concentration developer is introduced as needed from the high-concentration developer tank 510 through the high-concentration developer supply pipe 511Y in order to adjust the level of the developer and the toner concentration of the developer. Similarly, carrier liquid is introduced as needed from the carrier liquid tank 520Y through the carrier liquid supply pipe 521Y in order to adjust the level of the developer and the toner concentration of the developer. Although not depicted in this drawing, used developer recovered from the developer roller or the photoreceptor drum is collected in the buffer tank 530Y, and this used developer is supplied as needed through the recycled developer supply pipe 531Y to the concentration adjustment tank 400Y, as shown in FIGS. 1 and 2.

Although not depicted in this drawing, toner whose concentration has been adjusted in the concentration adjustment tank 400Y goes through the developer supply pipe 370Y and is sent to the supply reservoir 310Y in FIG. 2. The developing toner liquid that was not used is returned from the recovery reservoir 320Y, through the developer recovery pipe 371Y, to the concentration adjustment tank 400Y.

Next, the sensor for detecting the toner liquid level pertaining to the invention forms a capacitor including an internal electrode 1423Y, the liquid-level-measurement-area developer 1435Y, and a developer stirring tank lower case/external electrode (ground electrode) 1434Y. That is, the internal electrode 1423Y serves as the positive electrode, the liquid-level-measurement-area developer 1435Y serves as the electrolytic solution, and the developer stirring tank lower case/external electrode (ground electrode) 1434Y serves as the negative electrode. The external electrode contact 1422Y is supported by an external electrode insulated support 1438Y.

The internal electrode insulating layer 1426Y is provided around the outer peripheral part of the axis of the developer stirring geared motor shaft 1429Y, and the internal electrode 1423Y is formed over the outer periphery thereof. The external electrode contact 1422Y maintains contact with the internal electrode 1423Y around the rotating developer stirring geared motor shaft 1429Y, and is part of the wiring path linking the internal electrode 1423Y to the liquid level sensor connector 1413Y. The developer stirring tank lower case/external electrode (ground electrode) 1434Y, which is the other electrode, is also linked to the liquid level sensor connector 1413Y by electrical wiring (a lead wire). The liquid level sensor connector 1413Y is connected by the liquid level measurement harness 1420Y to the liquid level measurement component 1466Y shown in FIGS. 47 and 48.

The electrode configuration discussed above is not the only possibility. One method for insulating the developer stirring geared motor shaft 1429Y and the shaft of the developer stirring motor 1402Y is to simplify the structure using plastic for the bearings and gears inside the step-down gearbox.

The coaxial cylindrical electrode component shown on the middle left in FIG. 54 is drawn so as to facilitate an understanding of the configuration of the internal electrode 1423Y, the liquid-level-measurement-area toner 1435Y, and the developer stirring tank lower case/external electrode (ground electrode) 1434Y, which serve as a capacitor that is a liquid level sensor in the concentration adjustment tank 400Y. The electrostatic capacitance between these coaxial cylindrical electrodes is expressed by the following formula (13).

C=2π∈L/log(b/a)[F] (13)

Where:

C is the capacitance within the liquid level measurement area [F],

∈ is the dielectric constant [F/m],

L is the liquid level height [m],

a is the internal radius [m],

b is the external radius [m], and

log is a natural logarithm.

With the developing device and image forming device of the invention as discussed above, it is possible to ascertain the liquid level by detecting the electrostatic capacitance between the developer stirring tank lower case/external electrode (first electrode) 1434Y and the internal electrode (second electrode) 1423Y, so there is no need to provide a plurality of sensors, and the device can be more compact and lower in price. Also, with the developing device and image forming device of the invention, since the liquid level can be accurately ascertained by detecting the electrostatic capacitance between the developer stirring tank lower case/external electrode (first electrode) 1434Y and the internal electrode (second electrode) 1423Y, the concentration of the developer held in the holder can be properly controlled.

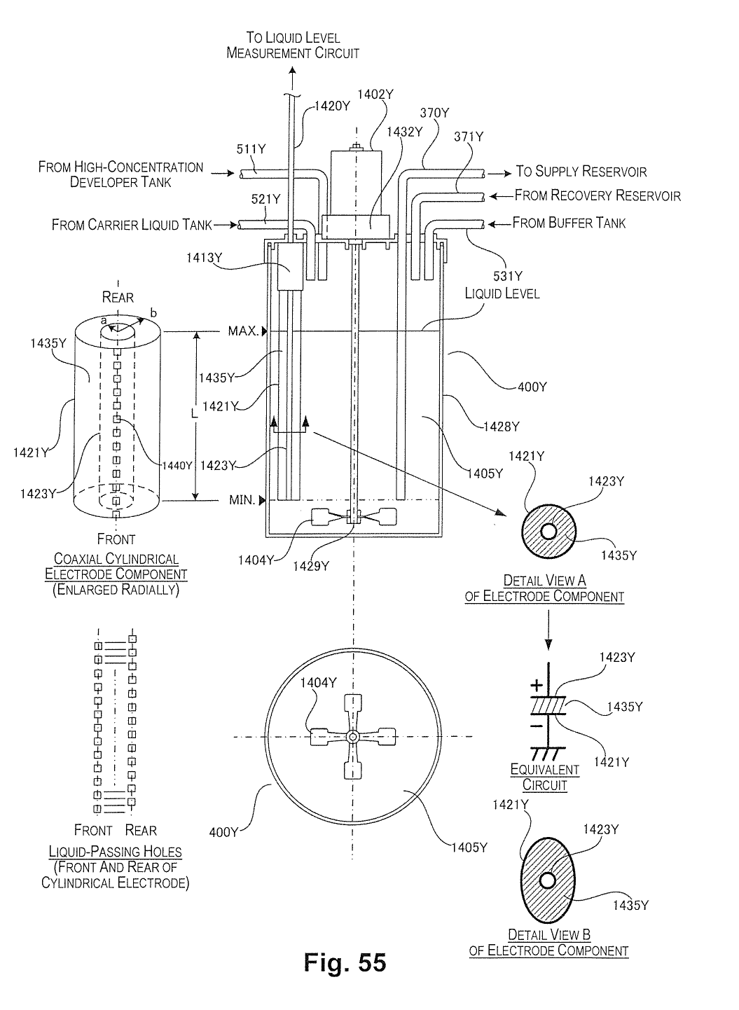

Next, another embodiment of the invention will be described. This other embodiment differs from the embodiments described up to now only in the configuration of the concentration adjustment tank 400Y, so just this point will be described below. FIG. 55 shows the simplified configuration of the concentration adjusting tank 400Y in the developing device pertaining to another embodiment.

FIG. 55 shows a configuration example of a developer stirring tank containing the toner liquid level detector pertaining to another embodiment. In this other embodiment, as a configuration that does not make use of a developer stirring geared motor shaft at the center of a cylindrical electrode, a different configuration from that in FIG. 52 is used in method in which a cylindrical electrode is disposed at another place in the developer stirring tank, and the electrostatic capacitance is measured.

A toner recycling system in a printing device for a developing type of electronic photography has a toner recycling device for each of the four toners used for YMCK colors. FIG. 54 shows the configuration of the developer stirring tank that is used to perform toner concentration adjustment and is the main component of one of these recycling devices. The developer stirring motor 1402Y is attached at the upper part of the concentration adjustment tank 400Y, and the developer stirring geared motor shaft 1429Y and the developer stirring blade 1404Y are linked to this. The step-down gearbox 1432Y is attached to the developer stirring motor.

In this drawing, the concentration adjustment tank 400Y is filled with developer 1405Y up to the “MAX.” position indicating the liquid level. A state in which this liquid level has decreased to the “MIN.” position is indicated by a two-dot chain line.

At the upper part of the concentration adjustment tank 400Y, high-concentration developer is introduced as needed from the high-concentration developer tank 510 through the high-concentration developer supply pipe 511Y in order to adjust the level of the developer and the toner concentration of the developer. Furthermore, although not shown in this drawing, used developer recovered from the developer roller or the photoreceptor drum is collected in the buffer tank 530Y, and this used developer is supplied as needed through the recycled developer supply pipe 531Y to the concentration adjustment tank 400Y, as shown in FIGS. 1 and 2.

Although not depicted in this drawing, toner whose concentration has been adjusted in the concentration adjustment tank 400Y goes through the developer supply pipe 370Y and is sent to the supply reservoir 310Y in FIG. 2. The developing toner liquid that was not used is returned from the recovery reservoir 320Y, through the developer recovery pipe 371Y, to the concentration adjustment tank 400Y.

Next, the sensor for detecting the toner liquid level pertaining to the invention forms a capacitor including the internal electrode 1423Y, the liquid-level-measurement-area developer 1435Y, and the external electrode (ground electrode) 1421Y. That is, the internal electrode 1423Y serves as the positive electrode, the liquid-level-measurement-area developer 1435Y serves as the electrolytic solution, and the external electrode (ground electrode) 1421Y serves as the negative electrode. The liquid-level-measurement-area developer 1435Y is such that the developer 1405Y is the developer in the area partitioned off by the external electrode (ground electrode) 1421Y, and the partitioned liquid levels are maintained in equilibrium by the liquid-passing holes 1440Y. The internal electrode 1423Y and the external electrode (ground electrode) 1421Y are supported by the liquid level sensor connector 1413Y. The liquid level sensor connector 1413Y is connected to the liquid level measurement harness 1420Y to the liquid level measurement component 1466Y shown in FIGS. 47 and 48.

The electrode configuration discussed above is not the only possibility. One method for insulating the developer stirring geared motor shaft 1429Y and the shaft of the developer stirring motor 1402Y is to simplify the structure using plastic for the bearings and gears inside the step-down gearbox.

The coaxial cylindrical electrode component shown on the middle left in FIG. 54 is drawn so as to facilitate an understanding of the configuration of the internal electrode 1423Y, the liquid-level-measurement-area toner 1435Y, and the external electrode (ground electrode) 1421Y, which serve as a capacitor that is a liquid level sensor in the concentration adjustment tank 400Y. The electrostatic capacitance between these coaxial cylindrical electrodes is expressed by the following formula (14).

C=2π∈L/log(b/a)[F] (14)

Where:

C is the capacitance within the liquid level measurement area [F],

∈ is the dielectric constant [F/m],

L is the liquid level height [m],

a is the internal radius [m],

b is the external radius [m], and

log is a natural logarithm.

Liquid-passing holes 1440Y in the coaxial cylindrical electrodes in the center left of FIG. 55 are liquid-passing openings that prevent a concentration difference between the developer 1405Y in the concentration adjustment tank 400Y and the liquid-level-measurement-area developer 1435Y surrounded by the external electrode (ground electrode) 1421Y. As shown by the liquid-passing holes and the coaxial cylindrical electrode component in FIG. 52, the layout of the liquid-passing holes 1440Y is determined so that the up and down direction is mutually different and there is a square shape on the front and rear faces of the cylindrical external electrode (ground electrode) 1421Y, and so that the length of the openings cut out around the periphery will be constant in any cross section perpendicular to the axis of the cylinder. The reason for disposing the liquid-passing holes on the front and rear of the external electrode (ground electrode) 1421Y is to take into account the fact that the flow of the developer produced by stirring can be brought into the interior of the external electrode (ground electrode) 1421Y as much as possible.

The shape of the external electrode need not be cylindrical as in the electrode enlargement A, and may instead be elliptical as in the electrode enlargement B, or diamond-shaped.

With the developing device and image forming device of the invention as described above, it is possible to ascertain the liquid level by detecting the electrostatic capacitance between the external electrode (first electrode) 1421Y and the internal electrode (second electrode) 1423Y, so there is no need to provide a plurality of sensors, and the device can be more compact and lower in price. Also, with the developing device and image forming device of the invention, since the liquid level can be accurately ascertained by detecting the electrostatic capacitance between the external electrode (first electrode) 1421Y and the internal electrode (second electrode) 1423Y, the concentration of the developer held in the holder can be properly controlled.

1. An image forming device, comprising:
a latent image carrier on which a latent image is formed;
an exposure component that exposes the latent image carrier to form the latent image on the latent image carrier;
a developer reservoir, which has a holder for holding a developer containing toner and a carrier, and an electrostatic capacitance detector for detecting electrostatic capacitance and having a first electrode provided to the holder and a second electrode that is opposite the first electrode with the developer in between;
a developing component for developing the latent image and having a developer carrier that supports the developer contained in the developer reservoir, and a supply member that supplies developer to the developer carrier; and
a calculator for calculating the level of the developer held in the holder on the basis of the electrostatic capacitance detected by the electrostatic capacitance detector.

2. The image forming device according to claim 1, further comprising a limiting member that comes into contact with the first electrode and the second electrode and limits the distance between the first electrode and the second electrode.

3. The image forming device according to claim 2, wherein a processing circuit that performs data processing on the basis of the electrostatic capacitance detected by the electrostatic capacitance detector is provided above the limiting member in the vertical direction.

4. The image forming device according to claim 3, further comprising a temperature detector that detects the temperature of the developer held in the holder,
wherein the processing circuit performs data processing on the basis of the temperature detected by the temperature detector.

5. The image forming device according to claim 3, further comprising a concentration detector that detects the toner concentration of the developer held in the holder,
wherein the processing circuit performs data processing on the basis of the concentration detected by the concentration detector.

6. The image forming device according to claim 1, further comprising a concentration adjuster that is disposed below the first electrode of the electrostatic capacitance detector inside the holder in the vertical direction, has a concentration detector that detects the toner concentration of the developer, and adjusts the toner concentration of the developer.

7. The image forming device according to claim 6, further comprising a stirrer that stirs the developer held in the holder and is disposed below the first electrode of the electrostatic capacitance detector in the vertical direction and above the concentration detector in the vertical direction.

8. The image forming device according to claim 6, further comprising a developer supply pipe that has an intake opening disposed above the concentration adjuster inside the holder in the vertical direction and for drawing in developer, and sends developer from the holder to a developing vessel.

9. An image forming device, comprising:
a latent image carrier on which a latent image is formed;
an exposure component that exposes the latent image carrier to form the latent image;
a developing component for developing the latent image formed on the latent image carrier and having a developer vessel that stores developer containing toner and a carrier liquid, and a developer carrier that supports the developer stored in the developer vessel;
a developer supply pipe that sends developer to the developer vessel of the developing component; and
a concentration adjuster that adjusts the toner concentration of the developer and has a holder for holding a developer, an electrostatic capacitance detector for detecting electrostatic capacitance and having a first electrode provided inside the holder and a second electrode provided inside the holder and opposite the first electrode with the developer in between, an intake opening of the developer supply pipe for drawing developer into the developer supply pipe, and a toner concentration detector that is disposed below the intake opening in the vertical direction and detects the toner concentration of the developer.

10. The image forming device according to claim 9, further comprising a stirrer that stirs the developer and is disposed inside the holder and below the intake opening in the vertical direction.

11. The image forming device according to claim 9, further comprising a calculator for calculating the level of the developer held in the holder on the basis of the electrostatic capacitance detected by the electrostatic capacitance detector and the toner concentration of the developer detected by the toner concentration detector.

12. The image forming device according to claim 11, further comprising a temperature detector that is disposed inside the holder and below the intake opening in the vertical direction, and detects the temperature of the developer held in the holder.

13. The image forming device according to claim 12, wherein the level of the developer calculated by the calculator is corrected on the basis of the temperature detected by the temperature detector.

14. An image forming device, comprising:
a latent image carrier on which a latent image is formed;
an exposure component that exposes the latent image carrier to form the latent image;
a developer reservoir for storing developer, which has a holding vessel for holding a developer containing toner and a carrier, an electrostatic capacitance detector for detecting electrostatic capacitance and having a first electrode provided inside the holder and a second electrode that is opposite the first electrode with the developer in between, and a concentration detector that is disposed inside the holder and detects the toner concentration of the developer;
a developing component for developing the latent image formed on the latent image carrier and having a developer carrier that supports the developer supplied from the developer reservoir, and a supply member that supplies developer to the developer carrier; and
a level calculator for calculating the level of the developer held in the holder on the basis of the electrostatic capacitance detected by the electrostatic capacitance detector and the toner concentration detected by the concentration detector.

15. The image forming device according to claim 14, further comprising a temperature detector that detects the temperature of the developer held in the holder,
wherein the level calculator calculates the level of the developer held in the holder on the basis of the temperature detected by the temperature detector.

16. The image forming device according to claim 15, wherein the level calculator corrects the toner concentration detected by the concentration detector on the basis of the temperature detected by the temperature detector.

17. The image forming device according to claim 14, further comprising:
a developer storage tank for storing developer of a first toner concentration;
a carrier liquid storage tank for storing a carrier liquid; and
a controller for supplying carrier liquid or developer of the first toner concentration stored in the developer storage tank so that the toner concentration of the developer held in the holder of the developer reservoir is controlled to a second toner concentration that is lower than the first toner concentration.

18. The image forming device according to claim 1, wherein a hollow part is provided to the first electrode, and the second electrode is provided in the hollow part of the first electrode.

19. The image forming device according to claim 18, further comprising a stirrer that rotates to stir the developer held in the holder,
wherein the second electrode is a shaft that supports and rotates the stirrer.

20. The image forming device according to claim 18, wherein the first electrode has a liquid-passing hole that allows the developer to flow into the hollow part.
